(19) United States
(12) Patent Application Publication
(10) Pub. No.: US 2026/0193398 A1
(43) Pub. Date: Jul. 9, 2026

(54) BIODEGRADABLE GRAFT POLYMERS, THEIR PRODUCTION, AND THEIR USE IN AGROCHEMICAL FORMULATIONS

(71) Applicant: BASF SE, Ludwigshafen am Rhein (DE)

(72) Inventors: Jan Ole MUELLER, Ludwigshafen am Rhein (DE); Ouidad BENLAHMAR, Ludwigshafen am Rhein (DE); Sophia EBERT, Ludwigshafen am Rhein (DE); Florian SCHOEN, Ludwigshafen am Rhein (DE); Kian MOLAWI, Ludwigshafen am Rhein (DE); Adam BLANAZS, Ludwigshafen am Rhein (DE); Rosa CORBERAN ROC, Ludwigshafen am Rhein (DE); Doris KREMZOW-GRAW, Ludwigshafen am Rhein (DE); Janine RUDE, Ludwigshafen am Rhein (DE); Joachim BENTELE, Ludwigshafen am Rhein (DE)

(21) Appl. No.: 19/132,002

(22) PCT Filed: Dec. 8, 2023
(86) PCT No.: PCT/EP2023/084835

§ 371 Date: May 22, 2025

(30) Foreign Application Priority Data
Dec. 12, 2022 (EP) 22212920.7

(51) Int. Cl. C08F 283/06; A01N 33/08; A01P 3/00; A01P 7/04; A01P 13/00

(52) U.S. Cl. CPC C08F 283/06; A01N 33/08; A01P 3/00; A01P 7/04; A01P 13/00

(57) ABSTRACT

Disclosed herein is an agrochemical composition including an agrochemical active ingredient and a cleaning composition including cleaning additives, each further including at least one novel graft polymer including a polymer backbone (A) as a graft base having polymeric sidechains (B) grafted thereon. The polymeric sidechains (B) are obtained by polymerization of at least one vinyl ester monomer (B1), and optionally further monomers. The polymer backbone (A) includes polyalkylene-oxide-derived moieties and moieties derived from lactone(s) and/or hydroxy acid(s), those moieties being mixed such that the polymer backbone contains ester-functions within the polymer chains.

Also disclosed herein are the graft polymer and its production.

The present invention relates to novel graft polymers comprising a polymer backbone (A) as a graft base having polymeric sidechains (B) grafted thereon. The polymeric sidechains (B) are obtainable by (co-)polymerization of at least one vinyl ester monomer (B1), optionally a nitrogen-containing monomer (B2), and optionally further monomer(s) (B3), and optionally further monomers. The polymer backbone (A) is made from at least two sub-units (a1) and (a2), wherein (a1) is derived from at least one alkylene oxide monomer, and (a2) is a unit derived from at least one lactone and/or at least one hydroxy acid.

The present invention further relates to a process for obtaining such a graft polymer, the process is preferably carried out by polycondensation. Furthermore, the present invention relates to the use of such a graft polymer within, for example, use in agrochemical formulations. Another subject-matter of the present invention are compositions comprising at least one graft polymer, such as use in agrochemical formulations.

### BACKGROUND

Agrochemicals (agriculture chemicals) such as pesticides (pesticidal active ingredients) are materials that provide control of agricultural pests including insects, pathogens, rodents, and weeds. Pesticidal active ingredients are typically applied to a plant or its seeds by spraying with a liquid composition comprising the active ingredient.

Pesticides are often solid particles, crystal-like particles or oily liquids, which must be dispersed in the liquid composition to allow for homogeneous application. Compositions comprising finely dispersed pesticidal active ingredients are typically obtained by the inclusion of dispersants. Examples of conventional dispersants include salts of naphthalene sulfonate formaldehyde condensates, salts of lignosulfonates, salts of maleic anhydride copolymers and salts of condensed phenol sulfonic acid.

Unfortunately, many dispersants used in agrochemical compositions do not significantly decompose and remain present on both the plant or seed and the surrounding area, causing an undesired accumulation on the plant or seed, as well as in the soil in which the plant or seed is planted. This problem is predominant for dispersants produced by radical polymerization based on carbon-only backbones (a backbone not containing heteroatoms such as oxygen), since a carbon-only backbone is particularly difficult to degrade for microorganisms. Even radically produced graft polymers of industrial importance with a polyethylene glycol backbone show only limited biodegradation in waste water.

It is desirable to provide dispersants useful for agrochemical compositions, in particular biodegradable dispersants.

Various states have already introduced initiatives to ban microplastics especially in cosmetic products. Beyond this ban of insoluble microplastic there is an intense dialog on future requirements for soluble polymers used in consumer products. It is therefore highly desirable to identify new better biodegradable ingredients for such applications. This problem is predominantly serious for polymers produced by radical polymerization based on carbon-only backbones (a backbone not containing heteroatoms such as oxygen), since a carbon-only backbone is particularly difficult to degrade for microorganisms. Even radically produced graft polymers of industrial importance with a polyethylene glycol backbone show only limited biodegradation in wastewater. However, the polymers described by the current Invention are preferably produced by radical graft polymerization and provide enhanced biodegradation properties compared to the state-of-the-art.

Polyalkylene oxides are important polymers with a wide range of applications. They have been extensively used as basis to produce graft polymers which are widely employed in all kind of formulations, including the use in agrochemical formulations.

Similarly, graft polymers of a vinylester being grafted onto polyalkylene oxide-polymers such as vinylacetate-graft-polyethylene glycol are known polymers. Their application in the area of agrochemical formulations as well as many other application areas are known as well. Those polymers however lack biodegradability or at least suffer from very limited biodegradability.

However, a certain amount—if not all—of such agrochemical formulations are brought into the environment during their application and thus, if not biodegraded or otherwise permanently absorbed, end up in the rivers or sea or may be taken up by plants, animals and ultimately the human being, from where they also might end up in a sewage plant.

Thus, biodegradability is one of the upcoming very important features not only in the area of agrochemical formulations, as a biodegradable polymer can avoid the issue of such build-up, as this might no longer be acceptable in certain countries.

On the other hand, the functionalities imparted by such polymers is of utmost importance as well, as they allow for high formulation efficiencies and thus among other advantages also for a low use of agrochemical additives per treatment, and thus allow for saving material used and hence avoid also the pollution of the environment. Hence, they are needed for more environment-friendly agricultural activities.

Hence, providing bio-degradable polymers for the area of agrochemical formulations is of utmost importance to solve the problem of pollution of the environment without compromising treatment efficiency, as such lower efficiency would also pollute the environment more than unavoidable.

The poor biodegradability of polyalkylene oxides decreases in the range from a few hundred g/mol molecular weight up to a few thousand g/mol molecular weight. Even more so, graft polymers based on such polyalkylene oxides are usually even poorer in their biodegradation likely due to the grafting.

### Prior Art Graft Polymers

U.S. Pat. No. 5,318,719 A relates to biodegradable water-soluble graft copolymers having building, anti-filming, dispersing and threshold crystal inhibiting properties comprising an acid functional monomer and optionally other water-soluble, monoethylenically unsaturated monomers copolymerizable with the acid functional monomer, grafted to a biodegradable substrate comprising polyalkylene oxides and/or polyalkoxylated materials. The graft polymers are considered suitable as detergent additives.

CN 102 030 871 A relates to relates to a polyethylene glycol block biodegradable polyester comb-type graft copolymer. The comb-type graft copolymer is a homo- or copolymer, wherein degradable polyester of the polyethylene glycol block is utilized as the hydrophobic main chain. It is described that the polymer self-assembles in water to form nanoparticles useful for preparing hydrophobic drug nanoparticles.

U.S. Pat. No. 31,816,566 discloses graft polymers of so-called “lactone polyesters” and blends thereof with PVC. The lactone polyesters are either homo-polymers of epsilon-caprolactone or copolesters thereof with epsilon-alkyl-epsilon-caprolactones. No polymers are disclosed being made from lactones and alkyleneoxides as in the present invention used as graft bases. The lactone polyesters of U.S. Pat. No. 31,816,566 were grafted with ethylenically unsaturated monomers, among a long list also “vinyl esters of aliphatic acids” are mentioned, with vinyl formate, vinyl acetate and vinyl propionate being exemplified in this list. The 22 examples show graft polymerization using acrylic acid, butylacrylate, dimethylaminomethacrylate, styrene, acrylonitrile, and methylmethacrylate as the only monomers actually being employed, all only as single monomer and no monomer mixtures being employed. Only one example (example 12) uses vinyl acetate as monomer and poly-epsilon-caprolactone as graft base (i.e. a graft base not comprising any alkylene oxide), employing 200 gram of backbone and 30 gram of vinyl acetate, i.e. and amount by weight of 15 wt. % vinyl acetate based on graft base equal to 13 wt. % of vinyl acetate based on total polymer weight. U.S. Pat. No. 31,816,566 does not disclose anything on the biodegradation of such polymer; the only use discloses is as plasticizer in PVC-polymer. Graft polymers of the types shown in this invention are not disclosed nor pointed at.

WO2022/136409 of BASF discloses amphiphilic alkoxylated polyalkylene imines or amines; no graft polymers are discloses comprising a polymer as graft backbone made from lactones and alkylene oxides being grafted in a radical polymerization with olefinically unsaturated monomers comprising at least a vinyl ester. Hence, his publication is completely unrelated to the present invention except to the fact that it also targets polymeric structures for use in areas similar to those of the present invention, and in that those products comprise lactone and alkylene oxides. The lactones and alkylene oxides are polymerized to produce lactone-alkylene oxide-copolymers which are attached to the amine groups of the starting compound polyethylene imine or polyamine. No graft polymerization is performed after the formation of those side chains. Thus, the structures and their preparation are completely different as well as the properties and thus the function in the application of such compounds. Graft polymers of the types shown in this invention are not disclosed nor pointed at.

US2022/0056380 discloses cleaning compositions focusing on specific enzymes, thus there is no focus on a specific polymer as such, it structure or preparation or properties. Among the many ingredients of such compositions also graft polymers are mentioned as an ingredient. The graft polymers however are the typically, known graft polymers (such as the preferred mentioned “Sokalan® HP22 of BASF”—all of which do not contain a lactone in the backbone of the polymer, thus such backbone being made only of alkylene oxides. Those alkylene oxides—and especially the preferred polymers of molecular weight of the backbones of around 6000 g/mol are not very much biodegradable at all, with the graft polymers being made with the use of such polyalkylene oxide-backbones having an even poorer biodegradation as shown in this present invention. Graft polymers of the types shown in this invention are not disclosed nor pointed at.

The task of improving the biodegradation of graft polymers based on backbones with polyalkylene oxide-units in the backbone was tackled already in—at the time of filing this present invention—un-published patent application PCT/EP2022/065983, (now published as WO2022/263354), which discloses graft polymers based on backbones comprising as functional units ester-functions and polyalkylene oxide-units. The backbones are prepared by oxidizing polyalkylene oxides in a first reaction, and then esterifying the oxidized PEG-mixtures either with itself or with additionally added polyalkylene oxides. The backbones are then grafted with vinyl acetate.

The polymers in this disclosure suffer from the two-step-synthesis for the backbone: the oxidation as first reaction step is expensive and lengthy, and the composition obtained from the oxidation is difficult to control, as—depending on the time taken for the reaction—the content of the mixture changes. Typically, the mixture obtained contains non-oxidized starting material, polyalkylene oxides with one hydroxy-group being oxidized to carboxyl-function and polyalkylene oxides with both ends being oxidized. Hence, the flexibility of designing the backbone is highly limited.

The patent application does also not disclose the use of nitrogen-containing monomers for preparing the graft polymers.

The patent application discloses the use of such polymers within agrochemical formulations.

### Prior Art on Backbones

This present invention discloses the uses of three main types of polymeric backbones comprising (oligo-/poly-)alkylene oxide-moieties and (oligo-/poly-) lactone/hydroxy acid-derived moieties.

Such backbones are named (A1), (A2) and (A3) (see definitions below), and are in principle known so far:

(A1)

WO2002046268 (Cognis, now BASF) discloses biodegradable polymers as surfactants, emulsifier etc., obtained by reacting an organic initiator with 1. alkylene oxides, 2. mixture of alkylene oxides and lactones. “Organic initiator” is defined on page 4 as mono- or polyfunctional alcohol or amine.

To obtain copolymers from alkylene oxides and caprolactone, suitable starters are reacted with a premixed combination of alkylene oxides and caprolactone.

To obtain (A1)-backbone-type copolymers from alkylene oxides and lactones such as caprolactone, suitable starters are reacted with a premixed combination of alkylene oxides and caprolactone.

Alcohols with 2 hydroxy groups (diols) are used as starters. Examples for such diols are: ethylene glycol, polyethylene glycol, propylene glycol, polypropylene glycol, ethylene oxide and propylene oxide block copolymers, 1,3-propylene diol, 1,4-butane diol, 1,6-hexane diol, neopentyl glycol, and the like.

Used alkylene oxides in combination with caprolactone are: ethylene oxide, 1,2-propylene oxide or 1,2-butylene oxide, 2,3-butylene oxide, 1,2-pentylene oxide, preferred ethylene oxide and propylene oxide.

The copolymerization of alkylene oxides and caprolactone is carried out under typical conditions for alkoxylation reactions. Basic catalysts are used like potassium hydroxide, sodium hydroxide, sodium methoxide, potassium methoxide.

(A2)-backbone-type polymers can be obtained in principle by alkoxylation of polylactones. Polylactones are for example accessible by polymerization of lactones such as caprolactone onto starters having 2 hydroxy-groups such as diols like ethylene glycol, polyethylene glycol, propylene glycol, polypropylene glycol, ethylene oxide and propylene oxide block copolymers, 1,3-propylene diol, 1,4-butane diol, 1,6-hexane diol, neopentyl glycol, and the like.

Polymerization of caprolactone is carried out with various catalysts like transesterification catalysts tin(II)alkanoates.

The alkoxylation of such polycaprolactones is done under typical alkoxylation conditions. Due to basic reaction conditions for the alkoxylation, transesterification reaction at ester bonds from polycaprolactone can occur.

U.S. Pat. No. 4,281,172 describes acrylic acid esters from polyester-polyether copolymers. To obtain these structures, a polylactone ester from mono-, di-, tri-, or tetraols, is reacted with alkylene oxides.

The polylactone esters are synthesized according to U.S. Pat. No. 3,169,945 from a hydroxy group-containing component with various catalysts, including Ti or Sn catalysts or alkali metal hydroxides.

The alkoxylation reaction is catalyzed with BF3-etherate or potassium hydroxide etc.

JP07149883 describes the process to obtain polyester-polyols from a compound with at least two active hydrogen, reacted with a lactone, followed by reaction with alkylene oxide. Both reactions are carried out with the same catalyst. Catalysts are alkali metal hydroxides or alkali metal alcoholates.

WO9636656 claims biodegradable alkylene oxide-lactone copolymers. The polymers are synthesized from a di- or polyfunctional starter, that are reacted with alkylene oxide and lactones in a copolymerization reaction, followed by an end-cap with an alkylene oxide block. Catalysts are alkali metal hydroxide or earth alkali metal hydroxide or Lewis acid. The patent application describes improved biodegradability of claimed polymers over polyalkylene oxides, and use as surfactants, emulsifiers etc. but not as backbones for graft polymers.

(A3)-backbone-type polymers can be obtained in principle by poly-esterification of polyalkylene glycols with lactones yielding—simplified—tri-block-polymers.

Triblock copolymers from caprolactone and alkylene oxides with a middle polyalkylene oxide block are synthesized by 1. formation of a polyalkoxylate from a diol or water by reaction with alkylene oxides, and 2. polymerization of caprolactone onto the polyalkoxylate.

Both reactions can be carried out under typical reaction conditions for alkoxylation reactions (polyalkoxylate) and for caprolactone polymerization (polycaprolactone block).

Such triblock copolymers with a middle polyethylene oxide block are known since about the 1990s. These polymers are used for drug release and solubilization purposes (Z. Zhu et al., Journal of Polymer Science, Part A: Polymer Chemistry 1997, 35 (4), 709-714; M. Boffito et al., Journal of Biomedical Materials Research, Part A 2015, 103A (3), 1276-1290).

(A4)-Type Backbones are Known as Well:

WO96/36656 discloses biodegradable oxide-lactone copolymers and copolyesters as already described for (A3) above.

WO2002046268 (Cognis, now BASF) discloses alkylene oxide-lactone copolymers as already described for (A1).

Not known however are the use of such polymers as backbones for graft polymers, introducing via the backbone an improved biodegradation into such graft polymers.

### OBJECT OF INVENTION

It was recognized that the graft polymers based on conventional polyalkylene oxides (without ester-groups in the backbone) show a surprisingly low biodegradation, which is often very much lower than the expected biodegradation percentage, which is calculated on the biodegradation of the pure polyalkylene oxides.

The graft polymers being based on such conventional polyalkylene oxides commonly show a decrease in biodegradation compared to the unmodified polyakylene oxides and unmodified polyalkylene glycols, as the degree of modification of polyalkylene oxides (often polyalkylene oxides with two hydroxy-end groups are employed, thus such polyakylene oxides with hydroxy-groups being named commonly “polyalkylene glycols”) with polymerizable monomers by radical grafting onto such backbones increases (i.e. the number of side chains on the backbone increases). This is sometimes attributed to the blocking of the biodegradation mechanism, as it seems that the polyalkylene oxides/glycols are degraded starting from their respective end group then following the polymer chain along. Thus, any additional branching on a carbon-atom of the backbone—which occurs when a polymeric side chain is grafted onto such backbone—impedes and possibly completely stops degradation. As a result, it is suggested that the higher the degree of grafting (i.e. the more side chains are attached to the backbone) the lower is the biodegradation percentage of such graft polymer. Unfortunately it is also commonly observed that with higher degree of branching the performance increases in the desired applications, as only with a higher amount of side chains the chemical structure of the backbone is changed enough that the new graft polymer exerts its specific properties compared to the separated properties of the unmodified backbone in simple mixture with the (unattached/ungrafted) homopolymer which would make up the side chain of the graft polymer.

Hence, the difficulty of combining the conflicting properties of a suitable graft polymer with superior application performance with the biodegradation percentage of the unmodified backbone (i.e. an unmodified polyalkylene oxide/glycol) has not been met up to date when polyalkylene oxides are used as backbones.

Although the unpublished patent application PCT/EP2022/065983 has provided a first solution to the problem of lacking biodegradation of the polyalkylene oxide-backbones, the practical aspects of the solution found is still not satisfactory, as the two-step-reaction is lengthy and costly, as two completely different types of chemical reactions are employed (oxidation and polymerization) and the structural variations are not easily controlled as the oxidation leads to mixtures of compounds being diols (i.e. the starting material polyalkylene glycols), mono-ol-mono-carbonic acid (i.e. partially oxidized polyalkylene glycol) and di-carboxyl-polylakylene oxide (i.e. fully oxidized polyalkylene glycol). Structures as the ones used here are not obtainable by the method disclosed in that document. Similarly, nitrogen-containing monomers are not disclosed.

Hence, there was a need to improve the biodegradation of conventional graft polymers based on polyalkylene oxides by improving the biodegradability of the graft base and keeping the general structure of the graft polymer and thus maintaining the application performance or even improve it, and to improve the cost and efficiency of the unpublished patent application PCT/EP2022/065983 by reducing the production process to just one reaction step employing only one reaction type and improving the variability of the chemical structure at the same time.

Even though polymers of the type (A1), (A2) and (A3) as defined herein are known, the use of such polymers as backbones to prepare graft polymers is not yet known.

Thus, the object of the present invention is to provide novel graft polymers based on polyalkylene-oxide-type graft backbones which impart ester-functions.

Furthermore, these novel graft polymers should have beneficial properties in respect of biodegradability and/or their performance within agrochemical formulations.

### Graft Polymers

The graft polymers of the invention comprise a polymer backbone as graft base as a first structural unit and polymeric side chains as a second structural unit.

### First Structural Unit (Backbone)

The first structural unit of the graft polymer is a polymer backbone used as a graft base for the inventive graft polymer, wherein said polymer backbone (A) is obtainable by polymerization of at least one sub-unit (a1) and at least one sub-unit (a2).

The sub-unit (a1) is made from least one alkylene oxide monomer and/or at least one polyalkylene oxide-polymer having two hydroxy-end-groups, the alkylene oxide monomer selected from the group of C2- to C10-alkylene oxides, preferably C2 to C5-alkylene oxides, such as ethylene oxide, 1,2 propylene oxide, 1,2 butylene oxide, 2,3 butylene oxide, 1,2-pentene oxide or 2,3 pentene oxide; from 1,4-diols or their cyclic or oligomeric analogs, or being based on polymeric ethers of such 1,4-diols; from 1,6-diols or their cyclic or oligomeric analogs, or being based on polymeric ethers of such 1,6-diols; or any of their mixtures in any ratio, either as blocks of certain polymeric units, or as statistical polymeric structures, or a polymers comprising one or more homo-block(s) of a certain monomer and one or more statistical block(s) comprising more than one such monomer, and any combination thereof such as polymers having several different blocks of two or more different monomers, or blocks of two or more different monomers, blocks of statistical mixtures of two or more monomers etc.

The term “block (co)polymer” as used herein means that the respective polymer comprises at least two (i.e. two, three, four, five or more) homo- or co-polymer subunits (“blocks”) linked by covalent bonds. “Two-block” copolymers have two distinct blocks (homo- and/or co-polymer subunits), whereas “triblock” copolymers have, by consequence, three distinct blocks (homo- and/or co-polymer subunits) and so on. The number of individual blocks within such block copolymers is not limited; by consequence, a “n-block copolymer” comprises n distinct blocks (homo- and/or co-polymer subunits). Within the individual blocks the size/length of such a block may vary independently from the other blocks. The smallest length/size of a block is based on two individual monomers (as a minimum), but may be as large as 50 or even 100 or 200, and any number in between 2 and 200. The respective monomers to be employed for preparing the individual blocks of a block copolymer backbone (a1) may be added in sequence. However, it is also possible that there is a transition of the feed from one monomer to the other to produce so called “dirty structures” wherein at the edge/border of the respective block a small number of monomers of the respective neighboring block may be contained within the individual block to be considered (so called “dirty structures” or “dirty passages”). However, it is preferred that the block copolymer sub-units (a1) according to the present invention do not contain any dirty structures at the respective border of the blocks, although for commercial reasons (i.e. mainly cost for efficient use of reactors etc.) small amounts of dirty structures may still be contained although not deliberately being made.

Preferably at least one monomer in the polymer stems from the use of ethylene oxide.

In another embodiment, more than one alkylene oxide monomer is comprised in the structure of the polymer-subunit (A1); in such case the polymer backbone is a random copolymer, a block copolymer or a copolymer comprising mixed structures of block units (with each block being a homo-block or a random block itself) and statistical/random parts comprised of two or more alkylene oxides, with one of the monomers being ethylene oxide. Preferably the further monomer beside ethylene oxide is propylene oxide (PO) and/or 1,2-butylene oxide (BO), preferably only 1,2-propylene oxide.

The sub-unit (a2) is made from at least one lactone and/or at least one hydroxy acid. The at least one lactone and/or hydroxy acid is/are selected from the groups i) and/or ii), with
i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
and
ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
preferably lactic acid or caprolactone, more preferably caprolactone.

The sub-units (a1) and (a2) may be combined in any order depending on how the starting material are employed and depending on the relative amounts.

As a result, the polymer backbone (A) obtained from the reaction of (a1) and (a2) can be defined in a very broad range by selecting the desired sub-units (a1) and (a2), and—within sub-unit (a1) by selecting the number of different alkylene oxides, their relative amounts, their reaction order etc, and of course also for (a2) by selecting the compounds, their relative amounts etc., in such way
1) to obtain first defined (a1)-subunits which are then reacted with (a2)-sub units,
2) to directly react monomeric alkylene oxides from sub-unit (a1) with monomeric sub-units (a2); or
3) to combine approach 1) and 2) before.

Hence, three principal backbone-structures can be defined and obtained:

(A1):

sub-units (a2) can be added during alkylene oxide polymerization (a1-units) yielding random copolymers; in a variation thereof, polyalkylene oxides having two hydroxy-groups can be added to such polymerisation thus introducing specific (a1)-sub-unit-blocks; this variation is useful if the alkylene oxides employed are at least partially different to the alkylene oxides employed for preparing the polyalkylene oxide also employed or if the structure of the polyalkylene oxide (i.e. the order of the alkylene oxide-units therein) is different to what is obtained by reacting the at least one alkylene oxide employed for the co-polymerisation with (a2)-sub-unit and the polyalkylene oxide.

In a simplifying approach this (A1)-backbone can be described as a randomly arranged order of (a1)-sub-units and (a2)-sub-units. Depending on the relative amount of (a1) to (a2) and their reactivity the block length of the (a1) and the (a2) is varied.

Structures like the one shown below can be obtained by this approach:
Poly [random-{lactone}-{alkylene oxide}]
   (“oligo/poly lactone” depicts the (a2)-sub-unit, thus made from lactone(s)/hydroxy acid(s); “PAG”=polyalkylene glycol is used here to depict the (a1)-sub-unit)

Hence, in one preferred embodiment, the polymer backbone is selected from (A1) to (A4):

(A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present.

(A2):

sub-units (a2) can be oligomerized/polymerized first and the co-polymerized with at least one alkylene oxide yielding mixed random/block structures; depending on the degree of oligomerization of the lactone/hydroxy-acid and if still monomeric lactone/hydroxy acid is present when the alkylene oxide(s) is/are added, the structure can be further varied by tuning the amount and length of (a2)-sub-unit-chains within the (A2)-backbone.

As with (A1), in a further variation thereof, also polyalkylene oxides having two hydroxy-groups can be added to such polymerisation thus also introducing specific (a1)-sub-unit-blocks; this variation is useful if the alkylene oxides employed are at least partially different to the alkylene oxides employed for preparing the polyalkylene oxide also employed or if the structure of the polyalkylene oxide (i.e. the order of the alkylene oxide-units therein) is different to what is obtained by reacting the at least one alkylene oxide employed for the co-polymerisation with (a2)-sub-unit and the polyalkylene oxide.

In a simplifying approach, this (A2)-backbone can be described as a tri-block-polymer with an inner (a2)-block and two outer (a1)-blocks.

(Switching the order to the opposite leads to structure (A3); see below.)

Structures like the one shown below (in its most simple version) can be obtained by this approach:
[PAG]-[oligo/poly lactone]-[PAG]
   (“lactone” is used here to denote the (a2)-sub-units, thus made from lactone(s)/hydroxy acid(s) and can be single monomeric units or oligo- or polymeric units made from monomers in a first reaction step; “PAG”=polyalkylene glycol is used here to depict the (a1)-sub-unit)

In case the (a2)-sub-unit-starting material has not completely reacted, the structure will not be anymore a true tri-block structure, but will in addition contain further, shorter (a2)-units in the chains and thus consist of a multi-block-structure or even shift towards a mixture of block and random-structural arrangement.

Hence, the in one preferred embodiment the polymer backbone is selected from (A2) a backbone consisting of oligo- or polymerized sub-units (a2) as an inner block and two outer blocks of oligomeric and/or polymeric (a1)-sub-units, defined as “-[block of (a1)]-[block of (a2)]-[block of (a1)]-”, and also possibly comprising higher block-polymers such as 5-, 7- and 9- etc. blocks where at the outside of the tri-block structure further blocks of (a1) and (a2) are connected, such as a penta-block “[block of (a1)]-[block of (a2)]-[block of (a1)]-[block of (a2)]-[block of (a1)]-[block of (a2)]-[block of (a1)]” and so on.

(A3):

sub-units (a2) can be added after alkylene oxide oligomerization or (almost complete) polymerization yielding block structures containing larger (a2)-chains and larger (a1)-chains; in case of complete polymerization of (a1) before addition of (a2) the structure resulting can be described as “(a2)-polyalkylene oxide-(a2)”; such structures can be also obtained by directly reacting polyalkylene oxides with (a2). By only oligomerizing the alkylene oxide(s) first and then reacting the mixtures containing alkylene-oxide(s)-oligomers and monomeric alkylene oxides with (a2) or by polymerizing (a2) with alkylene oxide(s) and with polyalkylene oxide(s) more complex structures can be obtained.

In a simplifying approach, this (A3)-backbone can be described as a tri-block-polymer with an inner (a1)-block and two outer (a2)-blocks:

(Switching the order to the opposite leads to structure (A2); see above.)
[oligo/poly lactone]-[PAG]-[oligo/poly lactone]
   (“oligo/poly lactone” depicts the (a2)-sub-unit, thus made from lactone(s)/hydroxy acid(s); “PAG”=polyalkylene glycol is used here to depict the (a1)-sub-unit)

Hence, in one preferred embodiment, the polymer backbone is selected from (A3) a backbone consisting of and inner block of oligomeric and/or polymeric (a1)-sub-units and two outer blocks of oligo- or polymeric sub-units (a2), in the form of at least an tri-block-polymer defined as “-[block of (a2)]-[block of (a1)]-[block of (a2)]-”.

Similarly as for case of (A2), in case the (a2)-sub-unit-starting material has not completely reacted, the structure will not be anymore a true tri-block structure, but will in addition contain further, shorter (a1)-units in the chains and thus consist of a multi-block-structure or even shift towards a mixture of block and random-structural arrangement.

### Similarities of (A1), (A2) and (A3)

The more unreacted species of (a2) (in case of (A2)-backbone) or the more unreacted species of (a1) (in case of (A3)-backbone) are present when the respective other sub-unit-species are added, the difference between (A2) and (A3) diminishes.

To the extreme, the result of that would be a true co-polymerization of sub-units (a1) and (a2) and thus would be similar or even identical also to (A1).

Hence, (A1), (A2) and (A3) are “just” extreme ends of the overall principle of co-polymerizing alkylene oxides, polyalkylene glycols and lactones/hydroxy acids in every thinkable order, ratio and variation of reaction times before adding the other starting materials.

Hence, in one preferred embodiment, the polymer backbone is selected from a backbone obtained by such overall principle of co-polymerizing alkylene oxides, polyalkylene glycols and lactones/hydroxy acids in every thinkable order, ratio and variation of reaction times before adding the other starting materials.

(A4):

(A4) is a structure which starts from an oligo- or polymeric sub-unit (a1) which is end-capped on one side, preferably etherified with alcohols, more preferably short-chain alcohols C1 to C4. This one-sided end-capped oligo-/polymer of sub-unit (a1) is then thereafter reacted with at least one sub-unit (a2) and optionally at least one sub-unit (a1)—wherein the sub-unit (a1) may be different to that/those in the starter block or may be arranged in a different order compared to those in the starter block—to attach to the non-endcapped side of the starter block a new block comprising moieties from the sub-units employed for the (co-) polymerization, thereby obtaining a di-block-structure of [end-cap]-[sub-unit(s) (a1)]-[sub-unit(s) (a2)], or [end-cap]-[sub-unit(s) (a1)]-[random-{sub-unit(s) (a2)-sub unit(s) (a1)}].

In a preferred embodiment, the polymer backbone as a graft base comprises at least one sub-unit (a1) and at least one sub-unit (a2), wherein
(a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C2- to C10-alkylene oxides, preferably C2 to C5-alkylene oxides,
(a2) is a unit comprising, preferably consisting of, at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
wherein preferably the at least one lactone and/or hydroxy acid is/are selected from the groups i) and/or ii), with
i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
and
ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
preferably lactic acid or caprolactone, more preferably caprolactone,
wherein the polymer backbone is obtained
(A1) by co-polymerization of at least one sub-unit (a1) and at least one sub-unit (a2), wherein optionally at least one oligomer or polymer made from at least one sub-unit (a1) or at least one sub-unit (a2) can be employed within the copolymerization of at least one sub-unit (a1) and at least one sub-unit (a2) as well;
(A2) by first oligo-/polymerizing sub-unit(s) (a2) and then polymerizing the product with sub-unit(s) (a1);
(A3) By first oligo-/polymerizing sub-unit(s) (a1) and then co-polymerizing the product with sub-unit(s) (a2); or
(A4) by first providing an oligo- or polymeric sub-unit (a1) which is bears an end-cap on one side, preferably is etherified with alcohols, more preferably short-chain alcohols C1 to C4, which—as starter—block—is thereafter reacted with at least one sub-unit (a2) and optionally at least one sub-unit (a1)—wherein the sub-unit (a1) may be different to that/those in the starter block or may be arranged in a different order compared to those in the starter block—to attach to the non-end capped side of the starter block a new block comprising moieties from the sub-units employed for the (co-)polymerization, thereby obtaining a di-block-structure of [end-cap]-[sub-unit(s) (a1)]-[sub-unit(s) (a2)], or [end-cap]-[sub-unit(s) (a1)]-[random-{sub-unit(s) (a2)-sub unit(s) (a1)}];
wherein in case more than one sub-unit (a1) and/or more than one sub-unit (a2) are present already in an employed oligomer or polymer, those sub-units can be arranged in any order within such employed oligomer or polymer, and
wherein in case more than one sub-unit (a1) and/or more than one sub-unit (a2) are present for the polymerization, those sub-units (and the optional oligomer/polymers if employed) can be arranged in any order within the obtained backbone.

The polymer backbone (A) and specifically (A1), (A2) and (A3), may be optionally capped at the end groups, the capping is done by C1 C25 alkyl groups using known techniques, preferably C1 to C4-groups. Such capping will be done after the production of the backbones and may be done preferably prior to the grafting.

In case of (A4), the capping on one end-group is either to be done prior to the condensation polymerization with sub-unit(s) (a1) and/or sub-unit(s) (a2), as only then a structure (A4) can be obtained. In another, more preferred approach, the production of the (A4) starts with a mono-alcohol, which is then reacted with alkylene oxide(s) to obtain the “mono-end-capped” oligo/polymer of sub-unit (a1) (bearing one hydroxy-group at the oligo/poly alkylene oxide-chain end), which is then reacted with sub-unit(s) (a2) to obtain (A4).

When preparing the oligo-/poly-alkylene oxide as a starting block, a diol may be used as a starter molecule for preparing this oligo/poly alkylene oxide, thus such oligo-/polymer of sub unit (a1) may contain in its structure a moiety derived from such diol. Diols for such use and methods to prepare such oligo/poly alkylene oxide comprising diols in their structure are known. Typical diols are ethylene glycol, propylene glycol etc. All of the commonly known diols can in principle be used for such purpose.

In another preferred embodiment, the polymer backbone as a graft base comprises at least one sub-unit (a1) and at least one sub-unit (a2), wherein
(a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C2- to C10-alkylene oxides, preferably C2 to C5-alkylene oxides,
(a2) is a unit comprising, preferably consisting of, at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
wherein preferably the at least one lactone and/or hydroxy acid is/are selected from the groups i) and/or ii), with
i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
and
ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
preferably lactic acid or caprolactone, more preferably caprolactone,
wherein the polymer backbone as a graft base (A) is selected from
(A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present;
(A2) a backbone consisting of oligo- or polymerized sub-units (a2) as an inner block and two outer blocks of oligomeric and/or polymeric (a1)-sub-units, defined as “-[block of (a1)]-[block of (a2)]-[block of (a1)]-”, and also possibly comprising higher block-polymers such as 5-, 7- and 9- etc. blocks where at the outside of the tri-block structure further blocks of (a1) and (a2) are connected, such as a penta-block “[block of (a1)]-[block of (a2)]-[block of (a1)]-[block of (a2)]-[block of (a1)]-[block of (a2)]-[block of (a1)]” and so on;
(A3) a backbone consisting of and inner block of oligomeric and/or polymeric (a1)-sub-units and two outer blocks of oligo- or polymeric sub-units (a2), in the form of at least an tri-block-polymer defined as “-[block of (a2)]-[block of (a1)]-[block of (a2)]-”, and (A4) a backbone consisting of a first block with
   (i) on one end an end-cap-such end-cap being a C1 to C18-, preferably C1-C4-alkyl-group attached to said first block via an ether-function; and
   (ii) an oligo- or polymeric sub-unit (a1); and
a second block which is attached to said first block at the opposite end of said first block (“opposite” in relation to the end-cap on said first block) via an ether or ester-function, said second block being composed of at least one sub-unit (a2) and optionally at least one sub-unit (a1),
wherein the optional sub-unit(s) (a1) in said second block may be different to that/those in the first block or may be arranged in a different order compared to those in the first block, and the order of the sub-unit(s) (A1) and (a2) may be also in any order, including random structure,
such di-block-structure having as an idealized structure in case of using only sub-unit(s) (a2) for the second block: [end-cap]-[sub-unit(s) (a1)]-[sub-unit(s) (a2)]
or in case of using sub-unit(s) (a1) and (a2) for the second block:
   [end-cap]-[sub-unit(s) (a1)]-[random-{sub-unit(s) (a2)-sub unit(s) (a1)}.

In a preferred embodiment the polymer backbones (A), and specifically (A1), (A2) and (A3), are not capped but bear hydroxy-groups at the chain ends.

Preferably, the polyalkoxylate-ester backbone comprises moieties derived from
(i) alkylene oxides (AO) comprising at least one of ethylene oxide (EO), propylene oxide (PO), and butylene oxide (BO), preferably at least one of EO and PO, with the AO in an amount of from 40 to 95, preferably up to 90, and preferably from 50, more preferably from 60, and even more preferably from 70 wt %, and any number and range in between, each based on the total weight of the backbone, the amount of EO being of from 0 to 100 wt. %, preferably from 10, more preferably from 20, even more preferably from 30, even more preferably from 40, such as from 50, 60, 70, 80 or even from 90 wt %, based on total AO,
   the PO and/or BO, in an total amount of each from 0 to 100 wt. %, preferably up to 90, more preferably up to 80, even more preferably up to 70, even more preferably up to 60, and most preferably up to 50, and any number in between such as up to 5, 10, 15, 25, 30, 35, 40, 45, 55, 65, 75, 85 or up to 95, and more preferably from 10, even more preferably from 20, even further more preferably from 30, such as from 40, 50, 60, 70, 80 or even from 90 wt %, each based on the total weight of AO, with the total amount of PO and BO adding up to 100 wt. % for the sum of PO and BO,
   with the total amount of AO adding up to 100 wt. %;
(ii) lactone/hydroxy acid monomer in an amount of from 1 and up to 60, preferably up to 50, more preferably up to 40, most preferably up to 30 wt. %, and preferably from 2, more preferably from 3, even more preferably from 4 and most preferably from 5 wt. %, each based on the total weight of the backbone, preferably only caprolactone;
   with the total weight of the sum of sub-units (a1) and sub-units (a2) in the backbone (A) adding up to 100 wt %.

More preferably, the amount of EO is at least 80 wt %, preferably at least about 85, more preferably at least about 90, even more preferably at least about 95%, and most preferably about 100 wt. % based on total AO; the amount of PO and/or BO is each from about 0 to 50 wt. % based on the total weight of AO, more preferably at most about 30, even more preferably at most about 20%, even more preferably about 10, and most preferably about 0 wt. %, each based on total AO; in a more preferred embodiment, the amounts for PO and BO given in this paragraph before are the total amounts for the sum of PO and BO. In an even more preferred embodiment, the backbone-unit (a1) is made from ethylene oxide only.

In an alternative but preferred embodiment, at least two different alkylene oxides are employed for the preparation of the backbone/are present in the backbone.

Hence, in one more preferred embodiment, the polymer backbone consists of
(i) alkylene oxides (AO) being selected from ethylene oxide (EO), propylene oxide (PO), and butylene oxide (BO), preferably only EO and PO,
   the amount of EO being of from 10 to 90, preferably 20 to 80, more preferably 30 to 70, and most preferably 40 to 60 wt %, based on total AO,
   the total amount of PO and BO being from 10 to 90, preferably 20 to 80, more preferably 30 to 70, and most preferably 40 to 60 wt %, each based on the total weight of AO, with the total amount of PO and BO adding up to 100 wt. % for the sum of PO and BO, and
   with the total amount of AO adding up to 100 wt. %;

(ii) lactone/hydroxy acid monomer in an amount of from 1 and up to 60, preferably up to 40, more preferably up to 30, even more preferably up to 25, even further more preferably up to 20, and most preferably up to 15 wt. %, and preferably from 2, more preferably from 3, even more preferably from 4 and most preferably from 5 wt. %, each based on the total weight of the backbone, preferably only caprolactone;

with the total weight of the sum of sub-units (a1) and sub-units (a2) in the backbone (A) adding up to 100 wt %.

Hence, in one more preferred, alternative embodiment, the polymer backbone consists of
(i) alkylene oxides (AO) is selected from ethylene oxide (EO), propylene oxide (PO), and butylene oxide (BO), preferably only EO and PO, more preferably only EO
   the amount of EO being of from 20 to 100 wt %, based on total AO,
   the total amount of PO and BO being from 0 to 80 wt. %, preferably up to 50, more preferably up to 30, even more preferably up to 20, and even further preferably up to 10, and most preferably zero, such as 45, 45, 45, 25, 15, 7 and 5, and any number in between, each based on the total weight of AO, with the total amount of PO and BO adding up to 100 wt. % for the sum of PO and BO,
   with the total amount of AO adding up to 100 wt. %;
(ii) lactone/hydroxy acid monomer in an amount of from 5 and up to 50, preferably up to 40, more preferably up to 35, and even more preferably up to 30, and as lower limit preferably from 7, more preferably from 10, even more preferably from 12 wt %, and most preferably from 15, such as 6, 8, 9, 11, 12, 13, 14 and 15 and any number in between as lower limit and such as 30, 33, 37, 45 and any number in between as upper limit, based on the total weight of the backbone, preferably only caprolactone;
   with the total weight of the sum of sub-units (a1) and sub-units (a2) in the backbone (A) adding up to 100 wt %.

In an even more preferred embodiment, the backbone for any of the embodiments of the inventive graft polymer as defined herein is a structure chosen from the structures (A1), (A2), (A3) and/or (A4).

### Second Structural Unit (Grafted Side Chains)

The second structural unit of the graft polymer are polymeric side chains (B), which are grafted onto the polymer backbone (A), wherein said polymeric sidechains (B) are obtainable by (co-)polymerization of at least one vinyl ester monomer (B1), optionally a nitrogen-containing monomer (B2), optionally further monomer(s) (B3), and optionally further monomers besides (B1), (B2) and (B3).

As vinyl ester monomer (B1), at least one of vinyl acetate, vinyl propionate and/or vinyl laurate is selected. Besides those, further vinyl ester monomers (B1) may be employed which are known to a person skilled in the art, such as vinyl valerate, vinyl pivalate, vinyl neodecanoate, vinyl decanoate and/or vinyl benzoate.

As optional monomer (B2) at least one nitrogen-containing monomer being selected from the group consisting of vinyllactames, vinyl imidazoles, 1-vinyltriazole, 4-vinylpyridine, 4-vinylpyridine-N-oxide, 2-vinylpyridine, 1-vinyloxazolidinone, N-vinylformamide, N-vinylacetamide, N-vinyl-N-methylacetamide, and acrylamides such as acrylamide, methacrylamide, N-alkyl-substituted acrylamides, N,N′-di alkyl (meth)acrylamide; mono- and dialkylamino-alkyl-(meth)acrylates, being preferably a vinyllactame-monomer and/or a vinylimidazole-monomer, the vinyllactam being more preferably selected from N-vinyllactams, such as N-vinylpyrrolidone, N-vinylpiperidone, N-vinylcaprolactam, even more preferably N-vinylpyrrolidone, N-vinylcaprolactam, and most preferably N-vinylpyrrolidone, and the vinylimidazole being preferably N-vinyl imidazole, 2-methyl-1-imidazole, more preferably N-vinyl imidazole, may be employed.

Further monomers (B3) may be employed as optional monomers, such monomers being different to (B1) and (B2) and being present only in an amount of preferably less than 10% of the total amount of monomers employed for obtaining the polymeric sidechains (B), and are more preferably present only as impurities but not deliberately added for polymerization. (B3) monomers may be any monomer chosen from 1-vinyl oxazolidinone and other vinyl oxazolidinones, 4-vinyl pyridine-N-oxide, N-vinyl formamide and its amine if hydrolyzed after polymerization, N-vinyl acetamide, N-vinyl-N-methyl acetamide, alkyl esters of (meth)acrylic acid, and their derivatives.

Besides monomers (B1), (B2) and (B3) at least one further monomer, being different from those before, may be present for the co-polymerization to yield the side chains (B), wherein such further monomer is present only in an amount of less than 2% of the total amount of monomers employed for obtaining the polymeric sidechains (B), and is preferably present only as impurities but not deliberately added for polymerization.

In case monomer (B2) is present, the amounts of monomers are as follows, based on the total WEIGHT OF THE GRAFT POLYMER:
(B) is from 10 to 60%, preferably up to 50%, more preferably up to 40%, and preferably from 20%;
(B1) (vinylester) in weight percent being based on the total WEIGHT OF THE GRAFT POLYMER is from 9 to 55%, preferably up to 50, more preferably up to 40, even more preferably up to 35, and even more preferably up to 30%;
(B2) (nitrogen-containing monomer) in weight percent being based on the total WEIGHT OF THE GRAFT POLYMER is from 1 to 41%, preferably up to 30, more preferably up to 25 such as 1 to 25 and more preferably 5 to 25, even more preferably up to 15 such as 1 to 15 and more preferably 5 to 15, and further such as up to 10 up to 40, 35, 20, 10, and every number in between 1 and 41, wherein preferably the amount of (B2) is not higher than the amount of (B1);
(B3) (further monomer) is from 0 to 10, preferably at most 2, more preferably at most 1, even more preferably about 0, but in all cases at most 10% of the amount of (B1), and not more than the amount of (B2).

The amount of further monomer(s) besides (B1), (B2) and (B3) is as detailed before.

In case monomer (B2) is not present, the amounts of monomers are as follows, based on the total WEIGHT OF THE GRAFT POLYMER:
(B) is from 5 to 60%, preferably up to 50%, and preferably from 20%;
(B1) (vinylester) in weight percent being based on the total WEIGHT OF THE GRAFT POLYMER is the total amount of (B) minus the total amount of (B3);
(B2) (nitrogen-containing monomer) is 0%;
(B3) (further monomer) is from 0 to 10, preferably at most 2, more preferably at most 1, even more preferably about 0.

The amount of further monomer(s) besides (B1), (B2) and (B3) is as detailed before.

In a preferred embodiment, the amount of vinyl ester monomer (B1) is usually not smaller than 10% by weight (in relation to the sum of (B1) and (B2)).

Preferably, optional further monomers (B3) are present only as impurities but not deliberately added for polymerization. More preferably, the amount is less than 1, more preferably less than 0.5%, even more preferably less than 0.01% by weight based on total weight of monomers (B1), most preferably there is essentially no such monomers (B3), and most preferably even a total absence of any other monomer besides the monomers (B1) and optional monomers (B2). The same applies for the further monomers besides (B1), (B2) and (B3).

In a preferred embodiment, the graft polymer of the invention comprises polymeric sidechains (B) which are obtained or obtainable by radical polymerization of the at least one vinyl ester monomer (B1) and optionally at least one other monomer (B2) and optionally at least one further monomer (B3) in the presence of the polymer backbone (A),
wherein at least 10 weight percent of the total amount of vinyl ester monomer (B1) is selected from vinyl acetate, vinyl propionate and vinyl laurate, more preferably from vinyl acetate and vinyl laurate, and most preferably vinyl acetate, and wherein the remaining amount of vinyl ester may be any other known vinyl ester, wherein preferably at least 80, more preferably at least 90 weight percent, and most preferably essentially only vinyl acetate is employed as vinyl ester (weight percent being based on the total weight of vinyl ester monomers B1 being employed).

In an even more preferred embodiment of the previous embodiment, essentially no other monomer (B3) is employed.

In an even more preferred embodiment of the previous embodiment, essentially no other monomers (B2) nor (B3) are employed.

In a preferred embodiment, the inventive graft polymer consists of monomers, wherein
(B) the monomers are:
   (B1) at least one vinyl ester, selected from vinyl acetate, vinyl propionate and/or vinyl laurate, in amounts of from 70 to 100% by weight of the total weight of monomers that are grafted onto the backbone (A), preferably only vinyl acetate, and
   (B2) optionally at least one nitrogen-containing monomer in amounts of from 0 to 30% by weight of the total amount of monomers that are grafted onto the backbone (A), being preferably a N-vinyllactam, such as N-vinylpyrrolidone, N-vinylpiperidone, N-vinylcaprolactam, even more preferably N-vinylpyrrolidone and/or N-vinylcaprolactam, and most preferably N-vinylpyrrolidone,
with the vinyl ester monomer(s) (B1) optionally being partially or fully hydrolyzed after polymerization.

In a preferred embodiment thereof, the vinyl ester is not hydrolyzed.

In an alternative embodiment, at least one vinyllactame, preferably vinylpyrrolidone and/or vinylcaprolactame, more preferably only vinylpyrrolidone, as monomer (B2) is present besides at least one monomer (B1), with monomer (B1) being preferably comprising vinyl acetate, and even more preferably being only vinyl acetate. Even more preferably, vinyl acetate is the only monomer (B1) and vinylyprrolidone is the only monomer (B2).

In an alternative embodiment of the embodiments in the paragraph immediately before, the monomer (B1) may be partially or fully hydrolyzed after the polymerization reaction. In a preferred embodiment thereof, monomer (B1) is partially hydrolyzed, and is even more preferably hydrolyzed to up to 80, 70 or 60, 50, 40, 30, 20 or 10 mole percent based on the total amount of monomer(s) (B1).

Preferably the monomer (B1) is partially hydrolyzed of from 20%, and is hydrolyzed up to 50%. In a most preferred embodiment of the embodiments before, vinyl acetate is employed as monomer (B1) and vinylpyrrolidone as monomer (B2), and the polymer moiety stemming from vinyl acetate is partially hydrolyzed after polymerisation, preferably in an amount of about 20 to 50, more preferably about 30 to 45, such as about 40 mole %, based on total amount of vinyl acetate.

In an alternative, even more preferred embodiment of two paragraphs immediately before, the vinyl esters are not hydrolyzed at all.

It is to be understood that the amounts for (A), (B), (B1), (B2), (B3) and further monomers besides the ones before may be selected from the various detailed ranges given independently, i.e. lower and upper borders may be combined also from two different ranges given for one aspect to result in a numerical range not specified explicitly in numbers, such combined range for e.g. (A), (B), (B1), (B2) and (B3) however being explicitly intended to be encompassed by this present intention.

Also, broad ranges and very particularly preferred narrow ranges may be combined in one embodiment of this invention, with the selection of the ranges for one component being chosen independently of that for the other component, in as far as the overall numbers add up to a “100%-polymer”: e.g. the most preferred range for (A) and (B) may be chosen and combined with the broadest possible ranges given for (B1)/(B2)/(B3), and any other possible combination.

Preferably, for all selections possible to be made for (A)/(B) and (B1)/(B2)/(B3)), the same selections are to be made, e.g. all “preferred” ranges are chosen, or—more preferably—all “more preferred” ranges are chosen, or—most preferably—all “most preferable” ranges are chosen.

The inventive graft polymer as detailed before has a polydispersity (PDI) Mw/Mn of at most 10, preferably at most 5, more preferably at most 3, and most preferably in the range from 1.0 to 2.6, and any number a as upper or lower limit and any range in between such as 1.3 to 2.6, 1 to 3 etc. (with Mw=weight average molecular weight in g/mol, and Mn=number average molecular weight in g/mol; with the PDI being unitless), with lower numbers being preferred, but depending on the Mn of the polymer backbone employed (the higher the Mn of (A) also typically the higher the PDI) and also on the amount of (B) (the higher the amount of (B) relative to the amount of (A) typically the higher the PDI).

The respective values of Mw and Mn can be determined using GPC standard methods, such as the one referenced in the experimental section. However, the molecular weights of the backbones used in this invention can also be calculated, as those reactions proceed basically to completeness. Hence, the calculation of the molecular weights based on the total molar amounts of ingredients employed for the preparation reaction is a viable way as well.

The graft polymers of the invention may contain a certain amount of ungrafted polymers (“ungrafted side chains”) made of monomers not being reacted with (i.e. grafted (on-) to) the polymer backbone.

The amount of such ungrafted polymers may be high or low, depending on the reaction conditions, but is preferably to be lowered and thus is more preferably low. By this lowering, the amount of grafted side chains is preferably increased. Such lowering can be achieved by suitable reaction conditions, such as dosing of monomers and radical initiator and their relative amounts and also in relation to the amount of backbone being present. Such adjustment is in principle known to a person of skill in the present field, and detailed hereinafter for this present invention within the description of a process to obtain the inventive graft polymers.

It has been found that the inventive graft polymers as detailed herein before exhibit an improved bio-degradability which is at least 35, more preferably at least 40, even more preferably at least 50, such as 41, 42, 43, 44, 45 etc., 51, 52, 53 etc, 55, 60, 65, etc. and any number in between and up to 100%, within 28 days when tested under OECD 301F.

The ratios of (A) to (B) for the embodiments herein are:
(A) 20 to 95%, preferably 30 to 90%, more preferably 40 to 85%, most preferably 50 to 80% of a polymer backbone as a graft base, and
(B) 5 to 80%, preferably 10 to 70%, more preferably 15 to 60%, most preferably 20 to 50%, of polymeric sidechains (B) grafted onto the polymer backbone (A),

With each percentage being on the total weight of the graft polymer, and the total of (a) plus (B) being 100 wt. %.

Any and each of the sub-units (a1), (a2), the polymer backbones as graft bases (A), (A1), (A2), (A3) and (A4) as defined by their structure or their preparation, and the monomers (B), (B1), (B2), (B3), and further monomers besides (B1), (B2), (B3) are the ones as defined herein and specifically those defined before in all of their embodiments, preferred embodiment etc, and in the examples; any such embodiment for the sub-units (a1), (a2), the polymer backbones as graft bases (A), (A1), (A2), (A3) and (A4) as defined by their structure or their preparation, and the monomers (B), (B1), (B2), (B3), and further monomers besides (B1), (B2), (B3) may be chosen individually and combined, provided that such selection is possible and not ruled out herein, i.e. the totals need to add up as required and the embodiments are compatible (i.e. an embodiment requiring (B2) obviously not be combined with an embodiment requiring the absence of (B).

In a more preferred embodiment, the graft polymer of the invention and/or as detailed before consists of:
(A) at least on polymer backbone as graft base, such graft bases being any of the previously defined polymer backbones in any of the embodiments, preferably any of (a1), (A2), (A3) and (A4) as previously defined,
   in the amounts defined in any of the embodiments herein,
   including the description, the examples, and the claims,
and
(B) polymeric sidechains (B) grafted onto the polymer backbone (A), wherein said polymeric sidechains (B) are obtainable by (co-)polymerization of at least one vinyl ester monomer (B1), optionally a nitrogen-containing monomer (B2), and optionally further monomer(s) (B3), and optionally further monomers,
   all such monomers being any of the monomers as defined in any of the embodiments herein,
   in the amounts defined in any of the embodiments herein,
   including the description, the examples, and the claims.

In one embodiment of the previous embodiment, the vinyl ester monomer is vinyl acetate as the only monomer (B1), and more preferably vinylpyrrolidone is the only monomer (B2), and most preferably no other monomers (B3) and further monomers besides the previous ones are present.

In a preferred embodiment of the previous embodiment, the vinyl ester is hydrolyzed to about 20 to 50 mole percent, preferably about 30 to 45 mole %, most preferably about 40 mole %.

In a specific embodiment, the graft polymer of the invention consists of:
(A) 20 to 95%, preferably 30 to 90%, more preferably 40 to 85%, most preferably 50 to 80% of a polymer backbone as a graft base, with the percentages as weight percent in relation to the total weight of the graft polymer;
   which comprises at least one sub-unit (a1) and at least one sub-unit (a2), wherein
   (a1) is a unit comprising, preferably essentially consisting of, moieties derived from at least one alkylene oxide monomer and/or at least one polyalkylene oxide-polymer having two hydroxy-end-groups, the alkylene oxide monomer selected from the group of C2- to C10-alkylene oxides, preferably C2 to C5-alkylene oxides,
   (a2) is a unit comprising, preferably consisting of, at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
   wherein preferably the at least one lactone and/or hydroxy acid is/are selected from the groups i) and/or ii), with
      i) lactone(s), i.e. cyclic esters, starting with α-lactone (three ring atoms) followed by β-lactone (four ring atoms), γ-lactone (five ring atoms) and so on; such lactones preferably being β-propiolactone, g-butyrolactone, δ-valerolactone, g-valerolactone, e-caprolactone, d-decalactone, g-decalactone, e-decalactone; preferably caprolactone;
      and
      ii) hydroxy acid(s), which may be derived from any lactone by hydrolyzation, specifically from any lactone within group i) before, specifically an α-, β- or γ-hydroxy acid derived from the corresponding lactone by hydrolyzation, and lactic acid, glycolic acid, 4-hydroxybutanoic acid, 6-hydroxy hexanoic acid, 12-hydroxy stearic acid, citric acid;
      preferably lactic acid or caprolactone, more preferably caprolactone,
         wherein the polymer backbone is
         either obtained
(A1) by co-polymerization of at least one sub-unit (a1) and at least one sub-unit (a2), wherein optionally at least one oligomer or polymer made from at least one sub-unit (a1) or at least one sub-unit (a2) can be employed within the copolymerization of at least one sub-unit (a1) and at least one sub-unit (a2) as well;
(A2) by first oligo-/polymerizing sub-unit(s) (a2) and then polymerizing the product with sub-unit(s) (a1);
(A3) By first oligo-/polymerizing sub-unit(s) (a1) and then co-polymerizing the product with sub-unit(s) (a2); or
(A4) by first providing an oligo- or polymeric sub-unit (a1) which is bears an end-cap on one side, preferably is etherified with alcohols, more preferably short-chain alcohols C1 to C4, which—as starter-block—is thereafter reacted with at least one sub-unit (a2) and optionally at least one sub-unit (a1)—wherein the sub-unit (a1) may be different to that/those in the starter block or may be arranged in a different order compared to those in the starter block—to attach to the non-end capped side of the starter block a new block comprising moieties from the sub-units employed for the (co-)polymerization, thereby obtaining a di-block-structure of [end-cap]-[sub-unit(s) (a1)]-[sub-unit(s) (a2)], or [end-cap]-[sub-unit(s) (a1)]-[random-{sub-unit(s) (a2)-sub unit(s) (a1)}];
   wherein in case more than one sub-unit (a1) and/or more than one sub-unit (a2) are present already in an employed oligomer or polymer, those sub-units can be arranged in any order within such employed oligomer or polymer, and
   wherein in case more than one sub-unit (a1) and/or more than one sub-unit (a2) are present for the polymerization, those sub-units (and the optional oligomer/polymers if employed) can be arranged in any order within the obtained backbone;
      or selected from
(A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present;
(A2) a backbone consisting of oligo- or polymerized sub-units (a2) as an inner block and two outer blocks of oligomeric and/or polymeric (a1)-sub-units, defined as “-[block of (a1)]-[block of (a2)]-[block of (a1)]-”, and also possibly comprising higher block-polymers such as 5-, 7- and 9- etc. blocks where at the outside of the tri-block structure further blocks of (a1) and (a2) are connected, such as a penta-block “[block of (a1)]-[block of (a2)]-[block of (a1)]-[block of (a2)]-[block of (a1)]-[block of (a2)]-[block of (a1)]” and so on;
(A3) a backbone consisting of and inner block of oligomeric and/or polymeric (a1)-sub-units and two outer blocks of oligo- or polymeric sub-units (a2), in the form of at least an tri-block-polymer defined as “-[block of (a2)]-[block of (a1)]-[block of (a2)]-”; and
(A4) a backbone consisting of
   a first block with
   (i) on one end an end-cap-such end-cap being a C1 to C18-, preferably C1-C4-alkyl-group attached to said first block via an ether-function; and
   (ii) an oligo- or polymeric sub-unit (a1); and
   a second block which is attached to said first block at the opposite end of said first block (“opposite” in relation to the end-cap on said first block) via an ether or ester-function, said second block being composed of at least one sub-unit (a2) and optionally at least one sub-unit (a1), wherein the optional sub-unit(s) (a1) in said second block may be different to that/those in the first block or may be arranged in a different order compared to those in the first block, and the order of the sub-unit(s) (A1) and (a2) may be also in any order, including random structure,
   such di-block-structure having as an idealized structure in case of using only sub-unit(s) (a2) for the second block:
      [end-cap]-[sub-unit(s) (a1)]-[sub-unit(s) (a2)]
   or in case of using sub-unit(s) (a1) and (a2) for the second block:
      [end-cap]-[sub-unit(s) (a1)]-[random-{sub-unit(s) (a2)-sub unit(s) (a1)}];

With the amounts for sub-units (a1) and (a2) being those as herein defined before; and
(B) 5 to 80%, preferably 10 to 70%, more preferably 15 to 60%, most preferably 20 to 50%, of polymeric sidechains (B) grafted onto the polymer backbone (A), wherein said polymeric sidechains (B) are obtainable by (co-)polymerization of at least one vinyl ester monomer (B1), optionally a nitrogen-containing monomer (B2), and optionally further monomer(s) (B3), and optionally further monomers,
   with the percentages as weight percent in relation to the total weight of the graft polymer;
   wherein the monomers are:
   (B1) at least one vinyl ester, selected from vinyl acetate, vinyl propionate and/or vinyl laurate and any further vinylester known to a person skilled in the art, such as vinyl valerate, vinyl pivalate, vinyl neodecanoate, vinyl decanoate and/or vinyl benzoate; optionally
   (B2) at least one nitrogen-containing monomer being selected from the group consisting of vinyllactames, vinyl imidazoles, 1-vinyltriazole, 4-vinylpyridine, 4-vinylpyridine-N-oxide, 2-vinylpyridine, 1-vinyloxazolidinone, N-vinylformamide, N-vinylacetamide, N-vinyl-N-methylacetamide, and acrylamides such as acrylamide, methacrylamide, N-alkyl-substituted acrylamides, N,N′-di alkyl (meth)acrylamide; mono- and dialkylamino-alkyl-(meth)acrylates, being preferably a vinyllactame-monomer and/or a vinylimidazole-monomer, the vinyllactam being more preferably selected from N-vinyllactams, such as N-vinylpyrrolidone, N-vinylpiperidone, N-vinylcaprolactam, even more preferably N-vinylpyrrolidone, N-vinylcaprolactam, and most preferably N-vinylpyrrolidone, and the vinylimidazole being preferably N-vinyl imidazole, 2-methyl-1-imidazole, more preferably N-vinyl imidazole;
   optionally
   (B3) at least one further monomer, such as any one or more of 1-vinyl oxazolidinone and other vinyl oxazolidinones, 4-vinyl pyridine-N-oxide, N-vinyl formamide and its amine if hydrolyzed after polymerization, N-vinyl acetamide, N-vinyl-N-methyl acetamide, alkyl esters of (meth)acrylic acid; and
   optionally
   at least one further monomer, being different from those before, such other monomer being present only in an amount of less than 2% of the total amount of monomers employed for obtaining the polymeric sidechains (B), and are preferably present only as impurities but not deliberately added for polymerization;
   with the amount(s) preferably as follows:
      if (B2) is present—
         (B) is from 10 to 60%, preferably up to 50%, more preferably up to 40%, and preferably from 20%;
         (B1) (vinylester) in weight percent being based on the total WEIGHT OF THE GRAFT POLYMER is
         from 9 to 55%, preferably up to 50, more preferably up to 40, even more preferably up to 35, and even more preferably up to 30%;
         (B2) (nitrogen-containing monomer) in weight percent being based on the total WEIGHT OF THE GRAFT POLYMER is from 1 to 41%, preferably up to 30, more preferably up to 25 such as 1 to 25 and more preferably 5 to 25, even more preferably up to 15 such as 1 to 15 and more preferably 5 to 15, and further such as up to 10 up to 40, 35, 20, 10, and every number in between 1 and 41, wherein preferably the amount of (B2) is not higher than the amount of (B1)
   and
      if (B2) is not present—
         (B) is from 5 to 60%, preferably up to 50%, and preferably from 20%;
         (B1) (vinylester) in weight percent being based on the total WEIGHT OF THE GRAFT POLYMER is the total amount of (B) minus the total amount of (B3),
         (B2) (nitrogen-containing monomer) is 0%, And further provided that in all cases before
         (B3) (further monomer) is from 0 to 10, preferably at most 2, more preferably at most 1, even more preferably about 0, but in all cases at most 10% of the amount of (B1), and not more than the amount of (B2);
            wherein preferably at least 10 weight percent of the total amount of vinyl ester monomer (B1) is selected from vinyl acetate, vinyl propionate and vinyl laurate, more preferably from vinyl acetate and vinyl laurate, and most preferably vinyl acetate, and wherein the remaining amount of vinyl ester may be any other known vinyl ester, wherein preferably at least 80, more preferably at least 90 weight percent, and most preferably essentially only vinyl acetate is employed as vinyl ester (weight percent being based on the total weight of vinyl ester monomers B1 being employed),
            and optionally the vinyl ester is hydrolyzed after polymerization.

In one embodiment of the previous embodiment, the vinyl ester monomer is vinyl acetate as the only monomer (B1), and more preferably vinylpyrrolidone is the only monomer (B2), and most preferably no other monomers (B3) and further monomers besides the previous ones are present.

In a preferred embodiment of the previous embodiment, the vinyl ester is hydrolyzed to about 20 to 50 mole percent, preferably about 30 to 45 mole %, most preferably about 40 mole %.

Inventive polymers have preferably at least one of the following additional properties, preferably two or more, to be more successfully employed in the various fields of applications targeted with this present invention:
i) the polymer backbone (A) may bear as the end-groups two hydroxy-groups or may be capped on both ends with C1 to C22-alkyl groups, preferably C1 to C4 alkyl groups;
ii) the graft polymer has a polydispersity (PDI) Mw/Mn of at most 10, preferably at most 5, more preferably at most 3, and most preferably in the range from 1.0 to 2.6, and any number a as upper or lower limit and any range in between such as 1.3 to 2.6, 1 to 3 etc. (with Mw=weight average molecular weight and Mn=number average molecular weight [g/mol/g/mol]);
iii) the biodegradability of the graft polymer is at least 40, more preferably at least 45, such as 46, 47, 48, 49, 50, 55, 60, 65, 70, 75 etc. and any number in between and up to 100%, within 28 days, when tested under OECD 301F.

Further, the graft polymer is preferably water-soluble to a certain extent, to be able to employ the polymers within the aqueous environment typically present in the fields of applications as generally targeted with this present invention. Preferably inventive polymers should exhibit a medium to good, more preferably a good solubility in the environment of an aqueous formulation as typically employed in such fields for the various kinds of formulations, e.g. dish washing, automatic dish-washing, hard surface cleaning, fabric cleaning, fabric care, cosmetic formulations etc.

Further, the graft polymer solution preferably has a viscosity that at reasonably high solid concentrations of the polymer as to be handled in and after production and to be provided to the user, which could be e.g. as a “pure” (then typically liquid) product, dissolved in a solvent, typically an aqueous solution containing water and organic solvents, only water or only organic solvents, the viscosity of such polymer or polymer solution being in a range that allows typical technical process steps such as pouring, pumping, dosing etc. Hence, the viscosities should be preferably in a range of about up to less than 4000 mPas, more preferably up to 3500 mPas, even more preferably up to 3000 mPas, such as up to 4500, 3750, 3250, 2750 or even 2600 or below such as 2500, 2000, 1750, 1500, 1250, 1000, 750, 500, 250, 200, 150, or 100 mPas, at concentrations of the polymer (based on the total solid content of the polymer in solution, as defined by weight percent of the dry polymer within the total weight of the polymer solution) of preferably at least 10 wt. %, more preferably at least 20, and even more preferably at least 40 wt. %, and most preferably at least 50 wt. %, such as at least 60, 70, 80 or even 90 wt. %. The viscosity may be measured at either 25° C. or at elevated temperature, e.g. temperatures of 50 or even 60° C. By this a suitable handling of the polymer solutions in commercial scales is possible. It is of course evident that depending on the amount of solvent being added the viscosity is lower when the amount of solvent increases and vice versa, thus allowing for adjustment in case desired. It is also evident that the viscosity being measured depends on the temperature at which it is being measured, e.g. the viscosity of a given polymer with a given solid content of e.g. 80 wt. % will be higher when measured at lower temperature and lower when measured at a higher temperature. In a preferred embodiment the solid content is in between 70 and 99 wt. %, more preferably in between 75 and 85 wt. %, with no additional solvent being added but the polymer as prepared. In a more preferred embodiment, the solid content is in between 70 and 99 wt. %, more preferably in between 75 and 95 wt. %, with no additional solvent being added but the polymer as prepared, and the viscosity is lower than 3000 mPas, more preferably 3250, or even below 2750, 2600, 2500, 2000, 1750, 1500, 1250, 1000, 750, 500 or even 250 mPas, when measured at 60° C. The viscosity may be determined as generally known for such polymers, preferably as described below in the experimental part.

As further criteria, of course, the individual performance of a specific polymer needs to be evaluated and thus ranked for each individual formulation in a specific field of application. Due to the broad usefulness of the inventive polymers an exhaustive overview or detailed guidance for each area is not possible, but the present specification and examples give a guidance on how to prepare and select useful polymers of desired properties and how to tune the properties to the desired needs. One such criteria for the area of home care and especially fabric care of course it he performance upon washing, e.g. subjecting a certain material exhibiting stains of certain materials to a defined washing procedure.

The examples give some guidance for the application for washing of fabrics, i.e. the general area of fabric care.

Depending on the individual needs for a polymer exhibiting a defined degree of biodegradation, water solubility and viscosity (i.e. handling properties) the general and specific teachings herein—without being intended to be limited to the specific examples being given—will guide on how to obtain such polymer.

### Process

The invention also encompasses a process for obtaining a graft polymer according to any of the previous embodiments as defined herein and specifically any embodiment in the previous section, but also in any of the examples disclosed herein, wherein at least one vinyl ester monomer (B1), optionally at least one nitrogen-containing monomer (B2), optionally further monomer(s) (B3) and optional further monomers (besides (B1), (B2) and (B3)) is/are polymerized in the presence of at least one polymer backbone (A) as defined herein, preferably selected from backbones (A1), (A2), (A3) and (A4) as defined herein, wherein the polymeric sidechains (B) are obtained by radical polymerization, preferably using radical forming compounds to initiate the radical polymerization,
wherein each B1, B2 and B3 (and further monomers besides (B1), (B2) and (B3)) and (A), (A1), (A2), (A3) and (A4) are as defined herein before, in any of the embodiments including the claims and including as exemplified in the examples below, with each of it preferably being selected from any of its grades of preferences, in as far as each can be selected individually form its preferences, but always confirming to the general requirements of compatibility of preferences, such as total sums not exceeding 100% etc.

It has to be noted that the “grafting process” as such, wherein a polymeric backbone, such as the polymer backbone (A) described herein above, is grafted with polymeric sidechains, is known to a person skilled in the art. Any process known to the skilled person in this respect can in principle be employed within the present invention.

The radical polymerization as such is also known to a skilled person. That person also knows that the inventive process can be carried out in the presence of a radical-forming initiator (C) and/or at least one solvent (D).

The skilled person knows the respective components suitable as such.

The term “radical polymerization” as used within the context of the present invention comprises besides the free radical polymerization also variants thereof, such as controlled radical polymerization. Suitable control mechanisms are RAFT, NMP or ATRP, which are each known to the skilled person, including suitable control agents.

In a preferred embodiment, the process to produce a graft polymer of the invention and/or as detailed before comprises the polymerization of at least one vinyl ester monomer (B1) and optionally at least one nitrogen-containing monomer (B2), optionally at least one further monomer (B3) and optionally further monomer(s)—the latter being preferably present only as impurities, and more preferably are essentially not present—in the presence of at least one polymer backbone (A), preferably selected from the backbones (A1), (A2), (A3) and (A4) as defined herein before, a free radical-forming initiator (C) and, if desired, up to 50% by weight, based on the sum of components (A), (B), and (C), of at least one solvent (D), at a mean polymerization temperature at which the initiator (C) has a decomposition half-life of from 40 to 500 min, in such a way that the fraction of unconverted graft monomers (B1), optional (B2) and optional (B3) (the further monomers typically not being monitored as present only as impurity in low, thus neglectable amounts) and initiator (C) in the reaction mixture is constantly kept in a quantitative deficiency relative to the copolymer backbone (A). In a preferred embodiment no monomer (B2) is employed. In a more preferred embodiment, no monomer (B2) nor monomer (B3) are employed. In an even more preferred embodiment only monomer(s) (B1) are employed. Generally, the amount of further monomer(s) besides (B1), (B2) and (B39 is minimized, preferably they are not present at all.

In a preferred embodiment of any of the embodiments of the process as detailed in the previous paragraph, at least 10 weight percent of the total amount of vinyl ester monomer (B1) is selected from vinyl acetate, vinyl propionate and vinyl laurate, more preferably from vinyl acetate and vinyl laurate, and most preferably vinyl acetate, and wherein the remaining amount of vinyl ester may be any other known vinyl ester, wherein preferably at least 60, more preferably at least 70, even more preferably at least 80, even more preferably at least 90 weight percent, and most preferably essentially only (i.e. about 100 wt. % or even 100 wt. %) vinyl acetate is employed as vinyl ester (weight percent being based on the total weight of vinyl ester monomers B1 being employed).

Generally, besides monomers (B1), (B2) and (B3), at least one further monomer, being different from those before, may be employed for the co-polymerization to yield the side chains (B), wherein such further monomer is present only in an amount of less than 2% of the total amount of monomers employed for obtaining the polymeric sidechains (B), and is preferably employed only as—in practical aspects non-avoidable—impurities but not deliberately added for polymerization, and most preferably is not present at all.

In a more preferred embodiment of the previous two paragraphs, the following additional provisions 1) (presence of (B2)) and 2) (absence of (B2)) apply for the amounts and ratios of monomers:

In case monomer (B2) is employed, the amounts of monomers are as follows, based on the total WEIGHT OF THE GRAFT POLYMER:
(B) is from 10 to 60%, preferably up to 50%, more preferably up to 40%, and preferably from 20%;
(B1) (vinylester) in weight percent being based on the total WEIGHT OF THE GRAFT POLYMER is
from 9 to 55%, preferably up to 50, more preferably up to 40, even more preferably up to 35, and even more preferably up to 30%;
(B2) (nitrogen-containing monomer) in weight percent being based on the total WEIGHT OF THE GRAFT POLYMER is from 1 to 41%, preferably up to 30, more preferably up to 25 such as 1 to 25 and more preferably 5 to 25, even more preferably up to 15 such as 1 to 15 and more preferably 5 to 15, and further such as up to 10 up to 40, 35, 20, 10, and every number in between 1 and 41, wherein preferably the amount of (B2) is not higher than the amount of (B1);
(B3) (further monomer) is from 0 to 10, preferably at most 2, more preferably at most 1, even more preferably about 0, but in all cases at most 10% of the amount of (B1), and not more than the amount of (B2).

The amount of further monomer(s) besides (B1), (B2) and (B3) is as detailed before, and the monomers (B1), (B2) and (B3) are those as detailed herein before in any of the embodiments disclosed.

In case monomer (B2) is not employed, the amounts of monomers are as follows, based on the total WEIGHT OF THE GRAFT POLYMER:
B) is from 5 to 60%, preferably up to 50%, and preferably from 20%;
(B1) (vinylester) in weight percent being based on the total WEIGHT OF THE GRAFT POLYMER is the total amount of (B) minus the total amount of (B3),
(B2) (nitrogen-containing monomer) is 0%;
(B3) (further monomer) is from 0 to 10, preferably at most 2, more preferably at most 1, even more preferably about 0.

The amount of further monomer(s) besides (B1), (B2) and (B3) is as detailed before, and the monomers (B1), (B2) and (B3) are those as detailed herein before in any of the embodiments disclosed.

In a preferred embodiment, the amount of vinyl ester monomer (B1) employed is usually not smaller than 10% by weight (in relation to the sum of (B1) and (B2)).

Preferably, optional further monomers (B3) are present also only as impurities but not deliberately added for polymerization. More preferably, the amount is less than 1, more preferably less than 0.5%, even more preferably less than 0.01% by weight based on total weight of monomers (B1), most preferably there is essentially no such monomers (B3), and most preferably even a total absence of any other monomer besides the monomers (B1) and optional monomers (B2). The same applies for the further monomers besides (B1), (B2) and (B3).

In specifically preferred embodiments, the amounts of monomers employed are as follows, based on the total WEIGHT OF THE GRAFT POLYMER:
(A) is from 40 to 90%, preferably from 50%, more preferably from 60%, and preferably at most 80%, of a polymer backbone as defined herein before, preferably at least one of (A1), (A2) and (A3), as a graft base,
(B) is from 10 to 60%, preferably up to 50%, more preferably up to 40%, and preferably from 20%;
(B1) (vinylester) is from 9 to 55%, preferably up to 50, more preferably up to 40, even more preferably up to 35, and even more preferably up to 30%;
(B2) (at least one vinyllactam, preferably vinylpyrrolidone and/or vinylcaprolactam, more preferably vinylpyrrolidone) is from 1 to 25%, preferably up to 20, more preferably up to 15, even more preferably up to 10, such as even only up to 5, wherein at most the amount of (B2) is not higher than the amount of (B1);
(B3) (further monomer(s)) is from 0 to 2, preferably at most 1, more preferably 0, but in all cases at most 10% of the amount of (B1), and not more than the amount of (B2);
More preferably the optional further monomers (B3) and the further monomers besides (B1), (B2) and (B3) are preferably present only as impurities but not deliberately added for polymerization; more preferably, the amount is less than 1, more preferably less than 0.5%, even more preferably less than 0.01% by weight based on total weight of monomers (B1), most preferably there is essentially no such monomers (B3) nor further monomers, and most preferably even a total absence of any other monomer besides the monomers (B1) and (B2). The amount of vinyl ester monomer (B1) is usually not smaller than 10% by weight (in relation to the sum of (B1) and (B2)).

In alternatively specifically preferred embodiments, the amounts of monomers employed are as follows, based on the total WEIGHT OF THE GRAFT POLYMER:
(A) is from 40 to 90%, preferably from 50%, more preferably from 80%, of a polymer backbone as defined herein before, preferably at least one of (A1), (A2) and (A3), as a graft base;
(B) is from 10 to 60%, preferably up to 50%, and preferably from 20%;
(B1) (vinylester) is the total amount of (B) minus the total amount of (B3);
(B2) is 0%;
(B3) (further monomer(s)) is from 0 to 2, preferably at most 1, more preferably 0, but in all cases at most 10% of the amount of (B1), and not more than the amount of (B2);
the amount of vinyl ester monomer (B1) is usually not smaller than 10% by weight (in relation to the sum of (B1) and (B2));
the optional further monomers (B3) and the further monomers beside (B1), (B2) and (B3) are preferably present only as impurities but not deliberately added for polymerization. More preferably, the amount is less than 1, more preferably less than 0.5%, even more preferably less than 0.01% by weight based on total weight of monomers (B1), most preferably there is essentially no such monomers (B3) nor further monomers, and most preferably even a total absence of any other monomer besides the monomers (B1).

The amount of ((free) radical-forming) initiator (C) is preferably from 0.1 to 5% by weight, in particular from 0.3 to 3.5% by weight, based in each case on the polymeric sidechains (B).

For the process according to the invention, it is preferred that the steady-state concentration of radicals present at the mean polymerization temperature is substantially constant and the graft monomers (B), and especially (B1), more preferably (B1) and (B2), even more preferably (B1), (B2) and (B3), are present in the reaction mixture constantly only in low concentration (for example of not more than 5% by weight in total). This allows the reaction to be controlled, and graft polymers can be prepared in a controlled manner with the desired low polydispersity.

To assure a safe temperature control although—especially when a polymerization is started at high solid concentrations or in bulk and/or with a large amount of monomers being present from the start on it is advisable, and thus preferred, to use an additional and efficient measure to control the temperature. This can be done by external and/or internal cooling; such cooling can be done by internal and/or external coolers such as heat exchangers, or using reflux condensers when working at the boiling temperature of the solvent or the solvent mixture at a given temperature/pressure-combination.

The same measure could of course be used for the preferred embodiment mentioned before wherein the monomers are added over a prolonged period of time, and thus the monomer concentration in the reaction volume being constantly low over time.

However, under such conditions, temperature control is usually not a crucial point, as the temperature is at least partially controlled also by the propagation of the polymerization reaction by controlling the radical concentration and the available amount of polymerizable monomers. Of course, depending on the scale of the polymerisation reaction, such additional cooling as described before may become necessary for both variants-batch reaction or bulk reactions with large amounts of monomer present from the start or semi-continuous or continuous polymerization reactions with typically constantly low monomer concentrations-when the scale gets large enough that the ratio from volume to surface of the polymerization mixture becomes very large.

This however is generally known to a person of skill in the art of commercial scale polymerisations, and thus can be adapted to the needs.

According to the invention, the initiator (C) and the graft monomers (B), and especially (B1) and/or (B2) and/or (B3), preferably twice “and”, are advantageously added in such a way that a low and substantially constant concentration of undecomposed initiator and graft monomers (B), and especially a constant but low amount of (B1) and especially even more (B2) (especially in case when vinylpyrrolidone is selected as (B2)), are present in the reaction mixture. The proportion of undecomposed initiator in the overall reaction mixture is preferably ≤15% by weight, in particular ≤10% by weight, based on the total amount of initiator metered in during the monomer addition.

In a more preferred embodiment, the process comprises the polymerization of at least one vinyl ester monomer (B1) and optionally at least one nitrogen-containing monomer (B2), optionally at least one other monomer (B3) and optionally at least one further monomer(s), more preferably only monomers (B1) and (B2), in the presence of at least one polymer backbone (A) as defined herein, preferably selected from (A1), (A2) and (A3), a free radical-forming initiator (C) and, if desired, up to 50% by weight, based on the sum of components (A), (B) and (C), of at least one solvent (D), at a mean polymerization temperature at which the initiator (C) has a decomposition half-life of from 40 to 500 min, in such a way that the fraction of unconverted graft monomers (B) and initiator (C) in the reaction mixture is constantly kept in a quantitative deficiency relative to the polymer backbone (A), wherein preferably at least 10 weight percent of the total amount of vinyl ester monomer (B1) is selected from vinyl acetate, vinyl propionate and vinyl laurate, more preferably from vinyl acetate and vinyl laurate, and most preferably vinyl acetate, and wherein the remaining amount of vinyl ester may be any other known vinyl ester, wherein preferably at least 60, more preferably at least 70, even more preferably at least 80, even more preferably at least 90 weight percent, and most preferably essentially only (i.e. about 100 wt. % or even 100 wt. %) vinyl acetate is employed as vinyl ester (weight percent being based on the total weight of vinyl ester monomers B1 being employed).

In an even more preferred embodiment of the preceding embodiment before, besides the monomer(s) (B1) essentially no monomer (B2) is employed, preferably (B1) comprises vinyl acetate, more preferably comprises essentially only vinyl acetate, all in the ranges and preferred ranges given in the section on the “graft polymers of this invention”. In an alternative embodiment to the one before, besides the monomer(s) (B1) essentially only monomer (B2) is employed, preferably (B1) comprises vinyl acetate, more preferably comprises essentially only vinyl acetate, and preferably (B2) comprises a vinyllactam, more preferably comprises vinylpyrrolidone, and even more preferably comprises essentially vinylpyrrolidone, all in the ranges and preferred ranges given in the section on the “graft polymers of this invention”.

The mean polymerization temperature for the main polymerization and the post-polymerization is appropriately in the range from 50 to 140° C., preferably from 60 to 120° C. and more preferably from 65 to 110° C. Typically, the temperature for the post-polymerization is higher by 5 to 40° C. compared to the polymerization.

The term “mean polymerization temperature” is intended to mean here that, although the process is substantially isothermal, there may, owing to the exothermicity of the reaction, be temperature variations which are preferably kept within the range of +/−10° C., more preferably in the range of +/−5° C.

According to the invention, the (radical-forming) initiator (C) at the mean polymerization temperature should have a decomposition half-life of from 40 to 500 min, preferably from 50 to 400 min and more preferably from 60 to 300 min.

Examples of suitable initiators (C) whose decomposition half-life in the temperature range from 50 to 140° C. is from 20 to 500 min are:
O—C₂-C₁₂-acylated derivatives of tert-C₄-C₁₂-alkyl hydroperoxides and tert-(C₉-C₁₂-aralkyl) hydroperoxides, such as tert-butyl peroxyacetate, tert-butyl monoperoxymaleate, tert-butyl peroxyisobutyrate, tert-butyl peroxypivalate, tert-butyl peroxyneoheptanoate, tert-butyl peroxy-2-ethylhexanoate, tert-butyl peroxy-3,5,5-trimethylhexanoate, tert-butyl peroxyneodecanoate, tert-amyl peroxypivalate, tert-amyl peroxy-2-ethylhexanoate, tert-amyl peroxyneodecanoate, 1,1,3,3-tetramethylbutyl peroxyneodecanoate, cumyl peroxyneodecanoate, tert-butyl peroxybenzoate, tert-amyl peroxybenzoate and di-tert-butyl diperoxyphthalate;
di-O—C₄-C₁₂-acylated derivatives of tert-C₈-C₁₄-alkylene bisperoxides, such as 2,5-dimethyl-2,5-di(2-ethylhexanoylperoxy)hexane, 2,5-dimethyl-2,5-di(benzoyl-peroxy)hexane and 1,3-di(2-neodecanoylperoxyisopropyl)benzene;
di(C₂-C₁₂-alkanoyl) and dibenzoyl peroxides, such as diacetyl peroxide, dipropionyl peroxide, disuccinyl peroxide, dicapryloyl peroxide, di(3,5,5-trimethylhexanoyl) peroxide, didecanoyl peroxide, dilauroyl peroxide, dibenzoyl peroxide, di(4-methylbenzoyl) peroxide, di(4-chlorobenzoyl) peroxide and di(2,4-dichlorobenzoyl) peroxide;
tert-C₄-C₅-alkyl peroxy (C₄-C₁₂-alkyl) carbonates, such as tert-amyl peroxy (2-ethyl-hexyl)carbonate;
di(C₂-C₁₂-alkyl) peroxydicarbonates, such as di(n-butyl) peroxydicarbonate and di(2-ethylhexyl) peroxydicarbonate.

Depending on the mean polymerization temperature, examples of particularly suitable initiators (C) are:
at a mean polymerization temperature of from 50 to 60° C.:
tert-butyl peroxyneoheptanoate, tert-butyl peroxyneodecanoate, tert-amyl peroxypivalate, tert-amyl peroxyneodecanoate, 1,1,3,3-tetramethylbutyl peroxyneodecanoate, cumyl peroxyneodecanoate, 1,3-di(2-neodecanoyl peroxyisopropyl)benzene, di(n-butyl) peroxydicarbonate and di(2-ethylhexyl) peroxydicarbonate;
at a mean polymerization temperature of from 60 to 70° C.:
tert-butyl peroxypivalate, tert-butyl peroxyneoheptanoate, tert-butyl peroxyneodecanoate, tert-amyl peroxypivalate and di(2,4-dichlorobenzoyl) peroxide;
at a mean polymerization temperature of from 70 to 80° C.:
tert-butyl peroxypivalate, tert-butyl peroxyneoheptanoate, tert-amyl peroxypivalate, dipropionyl peroxide, dicapryloyl peroxide, didecanoyl peroxide, dilauroyl peroxide, di(2,4-dichlorobenzoyl) 2,5-dimethyl-2,5-peroxide and di(2-ethylhexanoylperoxy)hexane;
at a mean polymerization temperature of from 80 to 90° C.:
tert-butyl peroxyisobutyrate, tert-butyl peroxy-2-ethylhexanoate, tert-amyl peroxy-2-ethylhexanoate, dipropionyl peroxide, dicapryloyl peroxide, didecanoyl peroxide, dilauroyl peroxide, di(3,5,5-trimethylhexanoyl) peroxide, dibenzoyl peroxide and di(4-methylbenzoyl) peroxide;
at a mean polymerization temperature of from 90 to 100° C.:
tert-butyl peroxyisobutyrate, tert-butyl peroxy-2-ethylhexanoate, tert-butyl monoperoxymaleate, tert-amyl peroxy-2-ethylhexanoate, dibenzoyl peroxide and di(4-methylbenzoyl) peroxide;
at a mean polymerization temperature of from 100 to 110° C.:
tert-butyl monoperoxymaleate, tert-butyl peroxyisobutyrate and tert-amyl peroxy (2-ethylhexyl)carbonate;
at a mean polymerization temperature of from 110 to 120° C.:
tert-butyl monoperoxymaleate, tert-butyl peroxy-3,5,5-trimethylhexanoate and tert-amyl peroxy (2-ethylhexyl)carbonate.

Preferred initiators (C) are O—C₄-C₁₂-acylated derivatives of tert-C₄-C₅-alkyl hydroperoxides, particular preference being given to tert-butyl peroxypivalate and tert-butyl peroxy-2-ethylhexanoate.

Particularly advantageous polymerization conditions can be established effortlessly by precise adjustment of initiator (C) and polymerization temperature. For instance, the preferred mean polymerization temperature in the case of use of tert-butyl peroxypivalate is from 60 to 80° C., and, in the case of tert-butyl peroxy-2-ethylhexanoate, from 80 to 100° C.

The inventive polymerization reaction can be carried out in the presence of, preferably small amounts of, a solvent (D). It is of course also possible to use mixtures of different solvents (D). Preference is given to using water-soluble or water-miscible organic solvents. However, water as only solvent is in principle also possible but not preferred.

When a solvent (D) is used as a diluent, generally from 1 to 40% by weight, preferably from 1 to 35% by weight, more preferably from 1.5 to 30% by weight, most preferably from 2 to 25% by weight, based in each case on the sum of the components (A), (B1), optionally (B2), optionally (B3) and optional further monomers, and (C), are used.

Examples of suitable solvents (D) include:
monohydric alcohols, preferably aliphatic C₁-C₁₆-alcohols, more preferably aliphatic C₂-C₁₂-alcohols, most preferably C₂-C₄-alcohols, such as ethanol, propanol, isopropanol, butanol, sec-butanol and tert-butanol;
polyhydric alcohols, preferably C₂-C₁₀-diols, more preferably C₂-C₆-diols, most preferably C₂-C₄-alkylene glycols, such as ethylene glycol, 1,2-propylene glycol and 1,3-propylene glycol;
alkylene glycol ethers, preferably alkylene glycol mono(C₁-C₁₂-alkyl) ethers and alkylene glycol di(C₁-C₆-alkyl) ethers, more preferably alkylene glycol mono- and di(C₁-C₂-alkyl) ethers, most preferably alkylene glycol mono(C₁-C₂-alkyl) ethers, such as ethylene glycol monomethyl and -ethyl ether and propylene glycol monomethyl and -ethyl ether;
polyalkylene glycols, preferably poly(C₂-C₄-alkylene) glycols having 2-20 C₂-C₄-alkylene glycol units, more preferably polyethylene glycols having 2-20 ethylene glycol units and polypropylene glycols having 2-10 propylene glycol units, most preferably polyethylene glycols having 2-15 ethylene glycol units and polypropylene glycols having 2-4 propylene glycol units, such as diethylene glycol, triethylene glycol, dipropylene glycol and tripropylene glycol;
polyalkylene glycol monoethers, preferably poly(C₂-C₄-alkylene) glycol mono(C₁-C₂₅-alkyl) ethers having 2-20 alkylene glycol units, more preferably poly(C₂-C₄-alkylene) glycol mono(C₁-C₂₀-alkyl) ethers having 2-20 alkylene glycol units, most preferably poly(C₂-C₃-alkylene) glycol mono(C₁-C₁₆-alkyl) ethers having 3-20 alkylene glycol units;
carboxylic esters, preferably C₁-C₈-alkyl esters of C₁-C₆-carboxylic acids, more preferably C₁-C₄-alkyl esters of C₁-C₃-carboxylic acids, most preferably C₂-C₄-alkyl esters of C₂-C₃-carboxylic acids, such as ethyl acetate and ethyl propionate;
aliphatic ketones which preferably have from 3 to 10 carbon atoms, such as acetone, methyl ethyl ketone, diethyl ketone and cyclohexanone;
cyclic ethers, in particular tetrahydrofuran.

The solvents (D) are advantageously those solvents, which are also used to formulate the inventive graft polymers for use (for example in washing and cleaning compositions) and can therefore remain in the polymerization product.

Preferred examples of these solvents are polyethylene glycols having 2-15 ethylene glycol units, polypropylene glycols having 2-6 propylene glycol units and in particular alkoxylation products of C₆-C₈-alcohols (alkylene glycol monoalkyl ethers and polyalkylene glycol monoalkyl ethers).

Particular preference is given here to alkoxylation products of C₈-C₁₆-alcohols with a high degree of branching, which allow the formulation of polymer mixtures which are free-flowing at 40-70° C. and have a very low polymer content at comparatively low viscosity. The branching may be present in the alkyl chain of the alcohol and/or in the polyalkoxylate moiety (copolymerization of at least one propylene oxide, butylene oxide or isobutylene oxide unit). Particularly suitable examples of these alkoxylation products are 2-ethylhexanol or 2-propylheptanol alkoxylated with 1-15 mol of ethylene oxide, C₁₃/C₁₅ oxo alcohol or C₁₂/C₁₄ or C₁₆/C₁₈ fatty alcohol alkoxylated with 1-15 mol of ethylene oxide and 1-3 mol of propylene oxide, preference being given to 2-propylheptanol alkoxylated with 1-15 mol of ethylene oxide and 1-3 mol of propylene oxide.

In an alternative embodiment the polymerization is performed using a mixture of at least one organic solvent and water.

In a preferred embodiment, the amount of water during the polymerization is low, preferably at most 10 wt. %, more preferably at most 5 wt % based on total solvent, more preferably at most 1%.

In a further alternative embodiment the polymerization is performed using water as solvent (D). However, water as only solvent is not preferred.

The radical initiator (C) is preferably employed in the form of a concentrated solution in one of the solvents mentioned before. The concentration of course depends on the solubility of the radical initiator. It is preferred, that the concentration is as high as possible to allow to introduce as little as possible of the organic solvent into the polymerization reaction. In case the initiator is soluble in water, and thus water is used as solvent for introducing the initiator, the concentration is not critical from the viewpoint of residual levels of water.

Preferably, the amount of water during the polymerisation is at most 10 wt. %, preferably at most 5 wt. %, more preferably at most 1 wt. %, based on total weight of graft polymer (at the end of the polymerization) or based on total weight of (A) and (B) (at the start of the polymerization).

In the process according to the invention, polymer backbone (A), graft monomer(s) (B), initiator (C) and, if appropriate, solvent (D) are usually heated to the selected mean polymerization temperature in a reactor.

According to the invention, the polymerization is carried out in such a way that an excess of polymer (polymer backbone (A) and formed graft polymer) is constantly present in the reactor. The quantitative ratio of polymer to ungrafted monomer and initiator is generally ≥10:1, preferably ≥15:1 and more preferably ≥20:1.

The polymerization process according to the invention can in principle be carried out in various reactor types. Such reactor types are generally known, and includes any stirred-type reactor such as vessels, but also includes tube reactors, reactor cascades from vessels or various tubes etc.

The reactor used is preferably a stirred tank in which the polymer backbone (A), if appropriate together with portions, of generally up to 15% by weight of the particular total amount, of graft monomers (B), initiator (C) and solvent (D), are initially charged fully or partly and heated to the polymerization temperature, and the remaining amounts of (B), (C) and, if appropriate, (D) are metered in, preferably separately. The remaining amounts of (B), (C) and, if appropriate, (D) are metered in preferably over a period of ≥2 h, more preferably of ≥4 h and most preferably of ≥5 h.

In the case of a particularly preferred, substantially solvent-free process variant, the entire amount of polymer backbone (A) is initially charged as a melt and the graft monomers (B1) and, if appropriate, (B2) and/or (B3), and also the initiator (C) present preferably in the form of a from 10 to 50% by weight solution in one of the solvents (D), are metered in, the temperature being controlled such that the selected polymerization temperature, on average during the polymerization, is maintained with a range of especially +/−10° C., in particular +/−5° C.

In a further particularly preferred, low-solvent process variant, the procedure is as described above, except that solvent (D) is metered in during the polymerization in order to limit the viscosity of the reaction mixture. It is also possible to commence with the metered addition of the solvent only at a later time with advanced polymerization, or to add it in portions.

The polymerization can be affected under standard pressure or at reduced or elevated pressure. When the boiling point of the monomers (B1) and/or (B2) (and if employed also monomer (B3)) and/or of any solvent (D) used is exceeded at the selected pressure, the polymerization is carried out with reflux cooling.

A post-polymerization process step may be added after the main polymerization reaction. For that a further amount of initiator (dissolved in the solvent(s)) can be added over a period of 0.5 hour and typically up to 3 hours, preferably about 1 to 2 hours, more preferably about 1 hour, (such duration however also depending on the scale of the reactor) with the radical initiator and the solvent(s) for the initiator typically—and preferred—being the same as the ones for the main polymerization reaction. Of course, a different radical initiator and/or different solvent(s) may be employed as well.

The temperature of the post-polymerisation process step may be the same as in the main polymerization reaction (which is preferred in this invention) or may be increased. In case increased, it may be typically higher by about 5 to 40° C., preferably 10 to 20° C.

In between the post-polymerisation and the main polymerization a certain period of time may be waited, where the main polymerization reaction is left to proceed, before the post-polymerisation reaction is started by starting the addition of further radical initiator.

For solvents having a boiling point of approximately less than 110-120° C. at atmospheric pressure, such solvents may—as a purification step—be removed partially or essentially complete by thermal or vacuum distillation or stripping with a gas such as steam or nitrogen, such as stripping with steam made from water, all at ambient or reduced pressure, preferably vacuum distillation, whereas higher boiling solvents will usually stay in the polymer products obtained.

When mercaptoethanol is employed as chain transfer regulator, steam distillation is the preferred step of purification. Hence, higher boiling solvents like 1-methoxy-2-propanol, 1,2-propandiol and tripropylene glycol will stay in the polymer product, and thus their amounts should be minimized as far as possible by using as high as possible concentrations of the radical initiator when such solvents are used only for introducing the initiator, unless such solvents form also part of the formulation the graft polymer will be used within.

The graft polymers of the invention prepared using the process as defined herein may contain a certain amount of ungrafted polymers (“ungrafted side chains”) made of vinyl ester(s), e.g. poly vinyl acetate in case only vinyl acetate is employed, and/or when further monomers are employed—homo—and copolymers of vinyl ester(s) with the other monomers. The amount of such ungrafted vinyl ester-homo- and copolymers may be high or low, depending on the reaction conditions, but is preferably to be lowered and thus low. By this lowering, the amount of grafted side chains is preferably increased. Such lowering can be achieved by suitable reaction conditions, such as dosing of vinyl ester and radical initiator and their relative amounts and also in relation to the amount of backbone being present. Such reaction controlling and the necessary process steps is generally known to a person of skill in the present field, specific guidance being given herein.

This adjustment of the degree of grafting and this amount of ungrafted polymers can be used to optimize the performance in areas of specific interest, e.g. certain (e.g. detergent-) formulations, application areas or desired cleaning etc. performance.

It is believed that the conditions considered favorable herein promote a—suspected—higher degree of grafting; such higher degree of grafting is associated with a better performance. This suspected higher degree of grafting however does not compromise the biodegradation—which is attributed to the ester linkage in the backbone, which can “compensate” the lower biodegradation of a graft polymer having a higher degree of grafting—which is seen in the “conventional graft polymers” based on polyalkylene oxides as backbone.

A drawback is that it is extremely difficult if not even impossible to actually verify such degree of grafting on a polymer, especially with increasing molecular weights of the polymers, as the total amount of grafting sites in a polymer is generally very low compared to the molecular weight; thus, the signal-to-noise-ratio is unfavorable for polymers in view of current analytical tools.

In another—alternative—embodiment of the present invention, the polymeric sidechains (B) of the graft polymer according to the present invention are fully or partially hydrolyzed, preferably partially hydrolyzed, more preferably up to 50 mole %, and preferably from 20 mole %, more preferably 20 to 50, even more preferably 30 to 45, such as about 40 mole %, based on the total moles of (B1) employed, after the polymerization reaction and thus after the graft polymer as such is obtained. This means that the full or at least partial hydrolyzation of the polymeric sidechains (B) of the graft polymer is carried out in a further process step after the polymerization process (including after the optional post-polymerisation step if employed) of the polymeric sidechains (B) is finished.

In another alternative embodiment, no hydrolysis is performed on the graft polymer after the polymerization process of the polymeric sidechains (B) is finished.

Due to this full or at least partial hydrolyzation of the polymeric sidechains (B) of the graft polymers according to the present invention, the respective sidechain units originating from the at least one vinyl ester monomer (B1) are changed from the respective ester function into the alcohol function within the polymeric sidechain (B). It has to be noted that the corresponding vinyl alcohol is not suitable to be employed as monomer within the polymerization process of the polymeric sidechains (B) due to stability aspects of the “vinylalcohol”-monomer. In order to obtain an alcohol function (hydroxy substituent) within the polymeric sidechains (B) of the graft polymers according to the present invention, the alcohol function is typically introduced by hydrolyzing the ester function of the sidechains. From a theoretical point of view, each ester function of the polymeric sidechain (B) may be partially or completely replaced by an alcohol function (hydroxy group). In such a case, the polymeric sidechain is fully hydrolyzed (“saponified”).

The hydrolysis can be carried out by any method known to a person skilled in the art. For example, the hydrolysis can be induced by addition of a suitable base, such as sodium hydroxide or potassium hydroxide. Such hydrolysis processes are known from prior art.

In a preferred embodiment of the embodiments before, vinyl acetate is employed as monomer (B1) and vinylpyrrolidone as monomer (B2) and no other monomers are employed besides (B1) and (B2), and the polymer moiety stemming from vinyl acetate is partially hydrolyzed after polymerisation, preferably in an amount of from 20 to 50 mole, more preferably 30 to 45, such as—most preferably—about 40 mole % based on the total moles of (B1) employed.

The graft polymer of this invention, i.e. the polymer solution obtained from the process, may be also subjected to a means of concentration and/or drying.

The graft polymer solution obtained may be concentrated by subjecting the polymer solutions to means for removing part of the volatiles and especially solvent(s) to increase the solid polymer concentration. This may be achieved by distillation processes such as thermal or vacuum distillation, or by stripping using gases such as steam or inert gases such as nitrogen or argon, which is performed until the desired solid content is achieved. Such process can be combined with the purification step as disclosed before wherein the graft polymer solution obtained is purified by removing part or all of the volatile components such as volatile solvents and/or unreacted, volatile monomers, by removing the desired amount of solvent.

The graft polymer solution may be also after the main and/or the optional post-polymerization step and the optional purification step further concentrated or dried by subjecting the graft polymer solution to means of removing the volatiles partially or fully, such as—for concentration—distillation processes such as thermal or vacuum distillation, or by stripping using gases such as steam or inert gases such as nitrogen or argon, which is performed until the desired solid content is achieved, and/or drying such as roller-drum drying, spray-drying, vacuum drying or freeze-drying, preferably—mainly for cost-reasons—spray-drying. Such drying process may be also combined with an agglomeration or granulation process such as spray-agglomeration, granulation or drying in a fluidized-bed dryer.

Hence, the process of the invention encompasses preferably at least one further process step selected from i) to iv), with i) post-polymerisation; ii) purification; iii) concentration; and iv) drying.

More preferably, the process as detailed herein in any of the embodiments defined, comprises at least one further process step selected from:
i) a post-polymerization process step that is performed after the main polymerization reaction, wherein preferably a further amount of initiator (optionally dissolved in the solvent(s)) is added over a period of 0.5 hour and up to 3 hours, preferably about 1 to 2 hours, more preferably about 1 hour, with the radical initiator and the solvent(s) for the initiator typically—and preferred—being the same as the ones for the main polymerization reaction; and wherein after the polymerization reaction and before the post-polymerisation reaction preferably a period is waited when the main polymerization reaction is left to proceed, before the post-polymerisation reaction is started by starting the addition of further radical initiator, such period being preferably from 10 minutes and up to 4 hours, preferably up to 2 hours, even more preferably up to 1 hour, and most preferably up to 30 minutes; and wherein the temperature of the post-polymerisation process step is—preferably—the same as in the main polymerization reaction, or is increased, such increase being preferably higher by about 5 to 40° C., preferably 10 to 20° C. compared to the temperature of the main polymerisation reaction;
ii) a step of subjecting the graft polymer as obtained from the main polymerization or—if performed, the post-polymerisation process—to a means of purification, concentration and/or drying to remove part of or almost all of the remaining solvent(s) (as far as they are removable due to their boiling points) and/or volatiles such as residual monomers, wherein
   a. the concentration is performed by removing part of the solvent(s) and optionally also volatiles—by this this step additionally serves as means for purification—to increase the solid polymer concentration—and optionally as well for purification—by preferably applying a distillation process such as thermal or vacuum distillation, preferably vacuum distillation, and/or applying stripping with gas such as steam or an inert gas such as nitrogen, preferably using steam from water, which is performed until the desired solid content and optionally also purity is achieved, preferably is performed until the desired part or all of the volatile components such as volatile solvents and/or unreacted, volatile monomers, are removed;
   b. the drying is performed by subjecting the graft polymer containing at least residual amounts of volatiles such as remaining solvent and/or unreacted monomers etc. to a means of removing the volatiles, such as drying using a roller-drum, a spray-dryer, vacuum drying or freeze-drying, preferably-mainly for cost-reasons-spray-drying; and optionally combining such drying process step with a means of agglomeration or granulation to obtain agglomerated or granulated graft polymer particles, such process being preferably selected from spray-agglomeration, granulation or drying in a fluidized-bed dryer, spray-granulation device and the like.

### Uses

In principle the graft polymers of this invention can be employed in any application to replace conventional graft polymers of the same or very similar composition (in terms of relative amounts of polymer backbone and grafted monomers especially when the type and amounts of grafted monomers is similar or comparable.

Such applications are for example: redeposition of soils and removing of stains, avoiding or reducing re-soiling or greying or depositioning of solids, dispersion of actives in formulations of agrochemicals, pigments, colours, inorganic salts etc., inhibiting crystal growth including for inhibiting gas hydrate formation and/or reducing sedimentation and/or agglomeration, improve pigment dispersion stability, hydrophobisation of surfaces, reduction of growth of microbes on surfaces, and/or odor control etc., all compared to corresponding polymers or graft polymers according to the prior art.

### Typical Applications are:

Technical applications: Such compositions and formulations include glues of any kind, non-water and—preferably—water-based liquid formulations or solid formulations, the use as dispersant in dispersions of any kind, such as in oilfield applications, automotive applications, typically where a solid or a liquid is to be dispersed within another liquid or solid. Lacquer, paints and colorants formulations: Such compositions and formulations include non-water—and—preferably-water-based lacquer and colourants, paints, finishings. Agricultural Formulations: Such compositions and formulations include formulations and compositions containing agrochemical actives within a liquid, semi-solid, mixed-liquid-solid or solid environment.

Aroma Chemical-formulations: Such compositions and formulations include formulations which dissolve or disperse aroma chemicals in liquid or solid compositions, to evenly disperse and/or retain their stability, so as to retain their aroma profile over extended periods of time; encompassed are also compositions that show a release of aroma chemicals over time, such as extended release or retarded release formulations.

Fabric and Home Care applications, industrial and institutional cleaning: such compositions and formulations include leaning compositions for fabric and for solid surfaces, such as dish ware, cutlery, but also leather, metals and so on.

The inventive graft polymers as defined herein, obtainable by a process as defined herein or obtained by the process as defined herein, can improve the overall bio-degradation ratio of such formulation, compositions and products by replacing non-biodegradable polymers of similar structures or properties. They may thus be advantageously used—partly also depending on the monomer(s) B employed for grafting and thus adjusted in their performance to the specific needs of the specific applications; such monomer substitution pattern as possibly also derivable from the prior art of analogous graft polymers based on simple PEGs and polyalkylene glycols.

Specifically, and beyond the performance in a certain type of application, the graft polymers according to the present invention lead to an improved biodegradability when being employed within such compositions or products, compared to the previously known graft polymers.

Hence, another subject matter of the present invention is the use of the graft polymers of the invention and/or obtained by or obtainable by a process of the invention and/or as detailed before, in agrochemical formulations, as e.g. dispersants, crystal growth inhibitor and/or solubilizer. Another subject-matter of the present invention is, therefore, also an agrochemical composition or agrochemical product, or any other formulation or product in the field of agrochemicals and their formulations and products, each comprising at least one graft polymer as defined above or obtained by or obtainable by a process of the invention and/or as detailed herein.

Another subject matter of the present invention is the use of the graft polymers of the invention and/or obtained by or obtainable by a process of the invention and/or as detailed before in any of in this chapter before-mentioned applications, such as fabric care and home care products, in cosmetic and personal care formulations, as crude oil emulsion breaker, in technical applications including in pigment dispersions for ink jet inks, in formulations for electro plating, in cementitious compositions, in lacquer and colorants formulations, textile and leather treatment products for use during or after production, formulations containing inorganic salts such as especially silver salts, mining, metal production and treatment including metal refining and metal quenching, purification of liquids such as waste water from industry, production or consumers, preferably in agrochemical compositions and cleaning compositions and in fabric and home care products.

Hence, a preferred subject matter of this invention is also the use of at least one inventive graft polymer and/or at least one graft polymer obtained or obtainable by the inventive process in fabric care and home care products, industrial and institutional cleaning product, agrochemical formulations, or a formulation or product for any of the previously mentioned applications and application fields, preferably in agrochemical compositions. In particular, the inventive graft polymer is employed in such composition/product/formulation for improved dispersion.

Such inventive uses and inventive compositions/products encompass the use of the graft polymer as detailed herein and/or as obtainable from or obtained from the inventive process, such graft polymer resembling that as detailed above describing the polymer structure in any of its embodiments disclosed herein before, including any variations mentioned, and more specifically any of the preferred, more preferred etc. embodiments.

### Agrochemical Compositions in Detail

The agrochemical composition of the invention comprises, besides the graft polymer, an agrochemical active ingredient. It was found that the graft polymer of the inventive composition is suitable as a dispersant for a broad range of agrochemical active ingredients. The term “agrochemical active ingredient” refers to a substance that confers a desirable biological activity to the agrochemical composition.

Agrochemical active ingredients include pesticides, safeners, nitrification inhibitors, urease inhibitors, micronutrients, and/or plant growth regulators. Typically, the agrochemical active ingredient is a pesticide. Pesticides include insecticides, herbicides, fungicides, algaecides, rodenticides, molluscicides and nematicides. The skilled person is familiar with safeners, nitrification inhibitors, urease inhibitors, plant growth regulators, micronutrients, biopesticides and/or growth regulators. In one embodiment, the agrochemical active is an insecticide. In another embodiment, the agrochemical active is a herbicide. In a further embodiment, the agrochemical active is a fungicide. The skilled person is familiar with such pesticides, which can be found, for example, in the Pesticide Manual, 16th Ed. (2013), The British Crop Protection Council, London.

Preferably, the agrochemical active ingredient is selected from insecticides, fungicides, and herbicides.

Suitable insecticides are insecticides from the classes of carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, afidopyropene, amidrazones, dimpropyridaz, fipronil or their derivatives.

Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides such as fluxapyroxad and diflufenican, carboxylic acid diamides, chloronitriles such as chlorothalonil, cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates such as azoxystrobin, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles such as fludioxonil, phenylureas, phosphonates, phosphorothiolates, phthalamic acids, phthalimides, piperazines, piperidines, propionamides, pyridazinones, pyridines, pyridinylmethylbenzamides, pyrimidinamines, s, pyrimidinonehydrazones, pyrroloquinolinones, quinazolinones, quinolines, quinones, sulfamides, sulfamoyltriazoles, tetrazolinones such as metyltetraprole, thiazolecarboxamides, thiocarbamates, thiophanates, thiophenecarboxamides, toluamides, triphenyltin compounds, triazines, and conazole fungicides, in particular triazoles such as mefentrifluconazole, triticonazole, prothioconazole and tebuconazol. Azoxystrobin, fluxapyroxad, fludioxonil, prothioconazole, chlorothalonil, diflufenican, metyltetraprole, mefentrifluconazole and tebuconazol, in particular azoxystrobin, fluxapyroxad and chlorothalonil and diflufenican, especially azoxystrobin, are especially preferred fungicides.

Suitable herbicides are herbicides from the classes of the acetamides, amides, aryloxyphenoxypropionates, benzamides, benzofuran, benzoic acids, benzothiadiazinones, bipyridylium, carbamates, cinmethylin, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids such as glufosinate, phosphoroamidates, phosphorodithioates, phthalamates, pyrazoles such as pyroxasulfone, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines such as atrazine, indaziflam and terbuthylazine, triazinones such as metribuzin, triazoles, triazolinones, triazolocarboxamides, triazolopyrimidines, triketones, uracils including aryl uracils such as saflufenacil, and ureas. Atrazine, indaziflam, saflufenacil, pyroxasulfone, glufosinate, cinmethylin, terbuthylazine and metribuzine, in particular atrazine, are especially preferred herbicides.

A pesticide is generally a chemical or biological agent (such as pesticidal active ingredient, compound, composition, virus, bacterium, antimicrobial, or disinfectant) that through its effect deters, incapacitates, kills or otherwise discourages pests. Target pests can include insects, plant pathogens, weeds, mollusks, birds, mammals, fish, nematodes (roundworms), and microbes that destroy property, cause nuisance, spread disease or are vectors for disease. The term “pesticide” includes also plant growth regulators that alter the expected growth, flowering, or reproduction rate of plants; defoliants that cause leaves or other foliage to drop from a plant, usually to facilitate harvest; desiccants that promote drying of living tissues, such as unwanted plant tops; plant activators that activate plant physiology for defense of against certain pests; safeners that reduce unwanted herbicidal action of pesticides on crop plants; and plant growth promoters that affect plant physiology e.g. to increase plant growth, biomass, yield or any other quality parameter of the harvestable goods of a crop plant.

The following lists of pesticides that are suitable for use in compositions of the invention, is intended to illustrate the possible combinations but does not limit them:
A) Respiration inhibitors
   inhibitors of complex III at Qₒ site: azoxystrobin, coumethoxystrobin, coumoxystrobin, dimoxystrobin, enestroburin, fenaminstrobin, fenoxystrobin/flufenoxystrobin, fluoxastro-bin, kresoxim-methyl, mandestrobin, metominostrobin, orysastrobin, picoxystrobin, pyraclostrobin, pyrametostrobin, pyraoxystrobin, trifloxystrobin, pyribencarb, triclopyricarb/chlorodincarb, famoxadone, fenamidone, pyriminostrobin, bifujunzhi, metyltetraprole;
   inhibitors of complex III at Qᵢ site: cyazofamid, amisulbrom, fenpicoxamid, florylpicoxamid, metarylpicoxamid;
   inhibitors of complex II: benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, pydiflumetofen, pyraziflumid, sedaxane, tecloftalam, thifluzamide, inpyrfluxam, pyrapropoyne, fluindapyr, isoflucypram, cyclobutrifluram;
   other respiration inhibitors: diflumetorim; nitrophenyl derivates: binapacryl, dinobuton, dinocap, fluazinam, meptyldinocap; ferimzone; organometal compounds: fentin salts, e.g. fentin-acetate, fentin chloride or fentin hydroxide; silthiofam;
   quinone outside inhibitor stigmatellin binding type: ametoctradin;
B) Sterol biosynthesis inhibitors (SBI fungicides)
   C14 demethylase inhibitors: triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, fluoxytioconazole, ipfentrifluconazole, mefentrifluconazole; imidazoles: imazalil, pefurazoate, prochloraz, triflumizol; pyrimidines, pyridines, piperazines: fenarimol, pyrifenox, triforine;
   Delta14-reductase inhibitors: aldimorph, dodemorph, dodemorph-acetate, fenpropimorph, tridemorph, fenpropidin, piperalin, spiroxamine;
   Inhibitors of 3-keto reductase: fenhexamid, fenpyrazamine;
   other Sterol biosynthesis inhibitors: chlorphenomizole;
C) Nucleic acid synthesis inhibitors
   RNA polymerase I inhibitors: benalaxyl, benalaxyl-M, kiralaxyl, metalaxyl, metalaxyl-M, ofurace, oxadixyl;
   other nucleic acid synthesis inhibitors: hymexazole, octhilinone, oxolinic acid, bupirimate, 5-fluorocytosine, ipflufenoquin, quinofumelin;
D) Inhibitors of cell division and cytoskeleton
   tubulin polymerization inhibitors: benomyl, carbendazim, fuberidazole, thiabendazole, thiophanate-methyl, pyridachlometyl;
   other cell division inhibitors: diethofencarb, ethaboxam, pencycuron, fluopicolide, zoxamide, metrafenone, pyriofenone, phenamacril, fluopimomide;
E) Inhibitors of amino acid and protein synthesis
   methionine synthesis inhibitors: cyprodinil, mepanipyrim, pyrimethanil;
   protein synthesis inhibitors: blasticidin-S, kasugamycin, kasugamycin hydrochloride-hydrate, mildiomycin, streptomycin, oxytetracyclin;
F) Signal transduction inhibitors
   MAP/histidine kinase inhibitors: fluoroimid, iprodione, procymidone, vinclozolin, fludioxonil;
   mechanism unknown: quinoxyfen, proquinazid;
G) Lipid and membrane synthesis inhibitors
   Phospholipid biosynthesis inhibitors: edifenphos, iprobenfos, pyrazophos, isoprothiolane;
   lipid peroxidation: dicloran, quintozene, tecnazene, tolclofos-methyl, biphenyl, chloroneb, etridiazole;
   compounds affecting cell membrane permeability and fatty acids: propamocarb;
   inhibitors of oxysterol binding protein: oxathiapiprolin, fluoxapiprolin;
H) Inhibitors with Multi Site Action
   inorganic active substances: Bordeaux mixture, copper, copper acetate, copper hydroxide, copper oxychloride, basic copper sulfate, sulfur;
   thio- and dithiocarbamates: ferbam, mancozeb, maneb, metam, metiram, propineb, thiram, zineb, ziram;
   organochlorine compounds: anilazine, chlorothalonil, captafol, captan, folpet, dichlofluanid, dichlorophen, hexachlorobenzene, pentachlorphenole and its salts, phthalide, tolylfluanid;
   guanidines and others: guanidine, dodine, dodine free bas, guazatine, guazatine-acetate, iminoctadine, iminoctadine-triacetate, iminoctadine-tris(albesilate), dithianon, fluoroimide, methasulfocarb, chinomethionat;
I) Cell wall synthesis inhibitors
   inhibitors of glucan synthesis: validamycin, polyoxin B;
   melanin synthesis inhibitors: pyroquilon, tricyclazole, carpropamid, dicyclomet, fenoxanil, tolprocarb;
   cellulose synthase inhibitors: dimethomorph, flumorph, mandipropamid, pyrimorph, benthiavalicarb, iprovalicarb, valifenalate;
J) Plant defence inducers
   acibenzolar-S-methyl, probenazol, isotianil, tiadinil, prohexadione-calcium;
   phosphonates: fosetyl, fosetyl-aluminum, phosphorous acid and its salts, calcium phosphonate, potassium phosphonate, potassium or sodium bicarbonate, dichlobentiazox;
K) Unknown mode of action
   bronopol, cyflufenamid, cymoxanil, dazomet, debacarb, diclocymet, diclomezine, difenzoquat, difenzoquat-methylsulfate, diphenylamin, fenitropan, fenpyrazamine, flumetover, flumetylsulforim, flusulfamide, flutianil, harpin, nitrapyrin, nitrothal-isopropyl, oxin-copper, seboctylamine, tebufloquin, tecloftalam, triazoxide, pyrisoxazole, benziothiazolinone, bromothalonil, aminopyrifen, flufenoxadiazam;
L) Biopesticides
   L1) Microbial pesticides with fungicidal, bactericidal, viricidal and/or plant defense activator activity: Ampelomyces quisqualis, Aspergillus flavus, Aureobasidium pullulans, Bacillus altitudinis, B. amyloliquefaciens, B. amyloliquefaciens ssp. plantarum (also referred to as B. velezensis), B. megaterium, B. mojavensis, B. mycoides, B. pumilus, B. simplex, B. solisalsi, B. subtilis, B. subtilis var. amyloliquefaciens, B. velezensis, Candida oleophila, C. saitoana, Clavibacter michiganensis (bacteriophages), Coniothyrium minitans, Cryphonectria parasitica, Cryptococcus albidus, Dilophosphora alopecuri, Fusarium oxysporum, Clonostachys rosea f. catenulate (also named Gliocladium catenulatum), Gliocladium roseum, Lysobacter antibioticus, L. enzymogenes, Metschnikowia fructicola, Microdochium dimerum, Microsphaeropsis ochracea, Muscodor albus, Paenibacillus alvei, Paenibacillus epiphyticus, P. polymyxa, Pantoea vagans, Penicillium bilaiae, Phlebiopsis gigantea, Pseudomonas sp., Pseudomonas chloraphis, Pseudozyma flocculosa, Pichia anomala, Pythium oligandrum, Sphaerodes mycoparasitica, Streptomyces griseoviridis, S. lydicus, S. violaceusniger, Talaromyces flavus, Tricho-derma asperelloides, T. asperellum, T. atroviride, T. fertile, T. gamsii, T. harmatum, T. harzianum, T. polysporum, T. stromaticum, T. virens, T. viride, Typhula phacorrhiza, Ulocladium oudemansii, Verticillium dahlia, zucchini yellow mosaic virus (avirulent strain);
   L2) Biochemical pesticides with fungicidal, bactericidal, viricidal and/or plant defense activator activity: harpin protein, Reynoutria sachalinensis extract;
   L3) Microbial pesticides with insecticidal, acaricidal, molluscidal and/or nematicidal activity: Agrobacterium radiobacter, Bacillus cereus, B. firmus, B. thuringiensis, B. thuringiensis ssp. aizawai, B. t. ssp. israelensis, B. t. ssp. galleriae, B. t. ssp. kurstaki, B. t. ssp. tenebrionis, Beauveria bassiana, B. brongniartii, Burkholderia spp., Chromobacterium subtsugae, Cydia pomonella granulovirus, Cryptophlebia leucotreta granulovirus, Flavobacterium spp., Helicoverpa armigera nucleopolyhedrovirus, Helicoverpa zea nucleopolyhedrovirus, Helicoverpa zea single capsid nucleopolyhedrovirus, Heterorhabditis bacteriophora, Isaria fumoso-rosea, Lecanicillium longisporum, L. muscarium, Metarhizium anisopliae, M. anisopliae var. anisopliae, M. anisopliae var. acridum, Nomuraea rileyi, Paecilomyces fumosoroseus, P. lilacinus, Paenibacillus popilliae, Pasteuria spp., P. nishizawae, P. penetrans, P. ramosa, P. thornea, P. usgae, Pseudomonas fluorescens, Spodoptera littoralis nucleopolyhedrovirus, Steinernema carpocapsae, S. feltiae, S. kraussei, Streptomyces galbus, S. microflavus;
   L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, cis-jasmone, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, (R)-1-octen-3-ol, pentatermanone, (E,Z,Z)-3,8,11-tetradecatrienyl acetate, (Z,E)-9,12-tetradecadien-1-yl acetate, (Z)-7-tetradecen-2-one, (Z)-9-tetradecen-1-yl acetate, (Z)-11-tetradecenal, (Z)-11-tetradecen-1-ol, extract of Chenopodium ambrosiodes, Neem oil, Quillay extract;
   L5) Microbial pesticides with plant stress reducing, plant growth regulator, plant growth promoting and/or yield enhancing activity: Azospirillum amazonense, A. brasilense, A. lipoferum, A. irakense, A. halopraeferens, Bradyrhizobium spp., B. elkanii, B. japonicum, B. liaoningense, B. lupini, Delftia acidovorans, Glomus intraradices, Mesorhizobium spp., Rhizobium leguminosarum bv. phaseoli, R. I. bv. trifolii, R. I. bv. viciae, R. tropici, Sinorhizobium meliloti;
O) Insecticides from classes O.1 to 0.29
   O.1 Acetylcholine esterase (AChE) inhibitors: aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, triazamate; acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;
   O.2 GABA-gated chloride channel antagonists: endosulfan, chlordane; ethiprole, fipronil, flufiprole, pyrafluprole, pyriprole;
   O.3 Sodium channel modulators: acrinathrin, allethrin, d-cis-trans allethrin, d-trans allethrin, bifenthrin, kappa-bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, heptafluthrin, imiprothrin, meperfluthrin, metofluthrin, momfluorothrin, epsilon-momfluorothrin, permethrin, phenothrin, prallethrin, profluthrin, pyrethrin (pyrethrum), resmethrin, silafluofen, tefluthrin, kappa-tefluthrin, tetramethylfluthrin, tetramethrin, tralomethrin, transfluthrin; DDT, methoxychlor;
   O.4 Nicotinic acetylcholine receptor (nAChR) agonists: acetamiprid, clothianidin, cycloxaprid, dinotefuran, imidacloprid, nitenpyram, thiacloprid, thiamethoxam; nicotine; sulfoxaflor, flupyradifurone, triflumezopyrim, fenmezoditiaz, flupyrimin;
   O.5 Nicotinic acetylcholine receptor allosteric activators: spinosad, spinetoram;
   O.6 Chloride channel activators: abamectin, emamectin benzoate, ivermectin, lepimectin, milbemectin;
   O.7 Juvenile hormone mimics: hydroprene, kinoprene, methoprene; fenoxycarb, pyriproxyfen;
   O.8 miscellaneous non-specific (multi-site) inhibitors: methyl bromide and other alkyl halides; chloropicrin, sulfuryl fluoride, borax, tartar emetic;
   O.9 Chordotonal organ TRPV channel modulators: afidopyropen, pymetrozine, pyrifluquinazon;
   O.10 Mite growth inhibitors: clofentezine, hexythiazox, diflovidazin; etoxazole;
   O.11 Microbial disruptors of insect midgut membranes: Bacillus thuringiensis, B. sphaericus and the insecticdal proteins they produce: Bacillus thuringiensis subsp. israelensis, B. sphaericus, B. thuringiensis subsp. aizawai, B. thuringiensis subsp. kurstaki, B. thuringiensis subsp. tenebrionis, the Bt crop proteins: Cry1Ab, Cry1Ac, Cry1Fa, Cry2Ab, mCry3A, Cry3Ab, Cry3Bb, Cry34/35Ab1;
   O.12 Inhibitors of mitochondrial ATP synthase: diafenthiuron; azocyclotin, cyhexatin, fenbutatin oxide, propargite, tetradifon;
   O.13 Uncouplers of oxidative phosphorylation via disruption of the proton gradient: chlorfenapyr, DNOC, sulfluramid;
   O.14 Nicotinic acetylcholine receptor (nAChR) channel blockers: bensultap, cartap hydrochloride, thiocyclam, thiosultap sodium;
   O.15 Inhibitors of the chitin biosynthesis type 0: bistrifluron, chlorfluazuron, diflubenzuron, flucycloxuron, flufenoxuron, hexaflumuron, lufenuron, novaluron, noviflumuron, teflubenzuron, triflumuron;
   O.16 Inhibitors of the chitin biosynthesis type 1: buprofezin;
   O.17 Moulting disruptors: cyromazine;
   O.18 Ecdyson receptor agonists: methoxyfenozide, tebufenozide, halofenozide, fufenozide, chromafenozide;
   O.19 Octopamin receptor agonists: amitraz;
   O.20 Mitochondrial complex III electron transport inhibitors: hydramethylnon, acequinocyl, fluacrypyrim, bifenazate;
   O.21 Mitochondrial complex I electron transport inhibitors: fenazaquin, fenpyroximate, pyrimidifen, pyridaben, tebufenpyrad, tolfenpyrad; rotenone;
   O.22 Voltage-dependent sodium channel blockers: indoxacarb, metaflumizone;
   O.23 Inhibitors of the of acetyl CoA carboxylase: spirodiclofen, spiromesifen, spirotetramat, spiropidion, spirobudifen, spidoxamat;
   O.24 Mitochondrial complex IV electron transport inhibitors: aluminium phosphide, calcium phosphide, phosphine, zinc phosphide, cyanide;
   O.25 Mitochondrial complex II electron transport inhibitors: cyenopyrafen, cyflumetofen, cyetpyrafen, pyflubumide;
   O.28 Ryanodine receptor-modulators: chlorantraniliprole, cyantraniliprole, cyclaniliprole, flubendiamide, fluchlodiniliprole; tetraniliprole; tiorantraniliprole;
   O.29 Chordotonal organ modulators: flonicamid;
   O.30 GABA-gated chloride channel allosteric modulators: broflanilide, fluxametamide, isocycloseram;
   O.33 Calcium-activated potassium channel modulators: acynonapyr;
   O.34 Mitochondrial complex III electron transport inhibitors at Qi site: flometoquin;
   O.UN Insecticidal compounds of unknown or uncertain mode of action: afoxolaner, azadirachtin, amidoflumet, benzoximate, bromopropylate, chinomethionat, cryolite, cyproflanilid, dicloromezotiaz, dicofol, dimpropyridaz, flufenerim, flometoquin, flu-ensulfone, fluhexafon, fluopyram, fluralaner, metaldehyde, metoxadiazone, piperonyl butoxide, pyridalyl, tioxazafen, trifluenfuronate, umifoxolaner, actives on basis of Bacillus firmus (Votivo); fluazaindolizine; tyclopyrazoflor; sarolaner, lotilaner; benzpyrimoxan; tigolaner; oxazosulfyl; cyproflanilide, nicofluprole; indazapyroxamet.
P) Herbicides from the classes P1 to P15
   P1) lipid biosynthesis inhibitors:
      ACC-herbicides: alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim;
      non ACC herbicides: benfuresate, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate and vernolate;
   P2) ALS inhibitors:
      sulfonylureas: amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, iofensulfuron, iofensulfuron-sodium, mesosulfuron, metazosulfuron, metsulfuron, metsulfuron-methyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl and tritosulfuron;
      imidazolinones: imazamethabenz, imazamethabenz-methyl, imazamox, imazapic, imazapyr, imazaquin and imazethapyr;
      triazolopyrimidine herbicides and sulfonanilides: cloransulam, cloransulam-methyl, diclosulam, flumetsulam, florasulam, metosulam, penoxsulam, pyrimisulfan and pyroxsulam;
      pyrimidinylbenzoates: bispyribac, bispyribac-sodium, pyribenzoxim, pyriftalid, pyriminobac, pyriminobac-methyl, pyrithiobac, pyrithiobac-sodium;
      sulfonylaminocarbonyl-triazolinone herbicides: flucarbazone, flucarbazone-sodium, propoxycarbazone, propoxycarbazone-sodium, thiencarbazone and thiencarbazone-methyl;
      and triafamone;
   P3) photosynthesis inhibitors:
amicarbazone, inhibitors of the photosystem II, triazine herbicides, including of chlorotriazine, triazinones, triazindiones, methylthiotriazines and pyridazinones such as ametryn, atrazine, chloridazone, cyanazine, desmetryn, dimethametryn, hexazinone, metribuzin, prometon, prometryn, propazine, simazine, simetryn, terbumeton, terbuthylazin, terbutryn and trietazin, aryl urea such as chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thiadiazuron, phenyl carbamates such as desmedipham, karbutilat, phenmedipham, phenmedipham-ethyl, nitrile herbicides such as bromofenoxim, bromoxynil and its salts and esters, ioxynil and its salts and esters, uraciles such as bromacil, lenacil and terbacil, and bentazon and bentazon-sodium, pyridate, pyridafol, pentanochlor and propanil and inhibitors of the photosystem I such as diquat, diquat-dibromide, paraquat, paraquat-dichloride and paraquat-dimetilsulfate;
   P4) protoporphyrinogen-IX oxidase inhibitors:
acifluorfen, acifluorfen-sodium, azafenidin, bencarbazone, benzfendizone, bifenox, butafenacil, carfentrazone, carfentrazone-ethyl, chlomethoxyfen, chlorphthalim, cinidon-ethyl, cyclopyranil, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, tiafenacil, trifludimoxazin, epyrifenacil;
   P5) bleacher herbicides:
      PDS inhibitors: beflubutamid, diflufenican, fluridone, flurochloridone, flurtamone, norflurazon, picolinafen, rimisoxafen;
      HPPD inhibitors: benzobicyclon, benzofenap, bicyclopyrone, clomazone, fenquinotrione, isoxaflutole, mesotrione, oxotrione, pyrasulfotole, pyrazolynate, pyrazoxyfen, sulcotrione, tefuryltrione, tembotrione, tolpyralate, topramezone, bipyrazone, fenpyrazone, cypyrafluone, tripyrasulfone, benquitrione, dioxopyritrione;
      bleacher, unknown target: aclonifen, amitrole flumeturon, bixlozone;
   P6) EPSP synthase inhibitors:
glyphosate, glyphosate-isopropylammonium, glyposate-potassium and glyphosate-trimesium (sulfosate);
   P7) glutamine synthase inhibitors: bilanaphos (bialaphos), bilanaphos-sodium, glufosinate, glufosinate-P and glufosinate-ammonium;
   P8) DHP synthase inhibitors: asulam;
   P9) mitosis inhibitors:
      group K1: dinitroanilines: benfluralin, butralin, dinitramine, ethalfluralin, fluchloralin, oryzalin, pendimethalin, prodiamine and trifluralin; phosphoramidates: amiprophos, amiprophos-methyl, and butamiphos; benzoic acid herbicides: chlorthal, chlorthal-dimethyl; pyridines: dithiopyr and thiazopyr; benzamides: propyzamide and tebutam;
      group K2: carbetamide, chlorpropham, flamprop, flamprop-isopropyl, flamprop-methyl, flamprop-M-isopropyl, flamprop-M-methyl and propham;
   P10) VLCFA inhibitors:
      chloroacetamides: acetochlor, alachlor, amidochlor, butachlor, dimethachlor, dimethenamid, dimethenamid-P, metazachlor, metolachlor, metolachlor-S, pethoxamid, pretilachlor, propachlor, propisochlor and thenylchlor,
      oxyacetanilides: flufenacet and mefenacet;
      acetanilides: diphenamid, naproanilide, napropamide and napropamide-M;
      tetrazolinones: fentrazamide;
      other herbicides: anilofos, cafenstrole, fenoxasulfone, ipfencarbazone, piperophos, pyroxasulfone, dimesulfazet and isoxazoline;
   P11) cellulose biosynthesis inhibitors: chlorthiamid, dichlobenil, flupoxam, indaziflam, isoxaben, triaziflam;
   P12) decoupler herbicides: dinoseb, dinoterb and DNOC and its salts;
   P13) auxinic herbicides:
2,4-D and its salts and esters such as clacyfos, 2,4-DB and its salts and esters, aminocyclopyrachlor and its salts and esters, aminopyralid and its salts such as aminopyralid-dimethylammonium, aminopyralid-tris(2-hydroxypropyl) ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, flopyrauxifen, fluroxypyr, fluroxypyr-butometyl, fluroxypyr-meptyl, halauxifen and its salts and esters; MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters, triclopyr and its salts and esters, florpyrauxifen, florpyrauxifen-benzyl and 4-amino-3-chloro-5-fluoro-6-(7-fluoro-1H-indol-6-yl) picolinic acid;
   P14) auxin transport inhibitors: diflufenzopyr, diflufenzopyr-sodium, naptalam and naptalam-sodium;
   P15) other herbicides: bromobutide, chlorflurenol, chlorflurenol-methyl, cinmethylin, cumyluron, cyclopyrimorate and its salts and esters, dalapon, dazomet, difenzoquat, difenzoquat-metilsulfate, dimethipin, DSMA, dymron, endothal and its salts, etobenzanid, flurenol, flurenol-butyl, flurprimidol, fosamine, fosamine-ammonium, indanofan, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine, tetflupyrolimet, tridiphane.
Q) Safeners
(quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally acceptable salts and their agriculturally acceptable derivatives such amides, esters, and thioesters, provided they have an acid group.

In a particularly preferred embodiment, the agrochemical active ingredient is selected from azoxystrobin, fluxapyroxad, d, fludioxonil, chlorothalonil, atrazine, metyltetraprole, mefentrifluconazole, prothioconazole, tebuconazole, terbuthylazine, diflufenican, and metribuzin, preferably from azoxystrobin, fluxapyroxad, fludioxonil, prothioconazole, chlorothalonil, diflufenican, terbuthylazine and atrazine, and is most preferably azoxystrobin.

Suitable safeners include (quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally acceptable salts and their agriculturally acceptable derivatives such amides, esters, and thioesters, provided they have an acid group.

Suitable nitrification inhibitors are linoleic acid, alpha-linolenic acid, methyl p-coumarate, methyl ferulate, methyl 3-(4-hydroxyphenyl) propionate (MHPP), Karanjin, brachialacton, p-benzoquinone sorgoleone, 2-chloro-6-(trichloromethyl)-pyridine (nitrapyrin or N-serve), dicyandiamide (DCD, DIDIN), 3,4-dimethyl pyrazole phosphate (DMPP, ENTEC), 4-amino-1,2,4-triazole hydrochloride (ATC), 1-amido-2-thiourea (ASU), 2-amino-4-chloro-6-methylpyrimidine (AM), 2-mercapto-benzothiazole (MBT), 5-ethoxy-3-trichloromethyl-1,2,4-thiodiazole (terrazole, etridiazole), 2-sulfanilamidothiazole (ST), ammoniumthiosulfate (ATU), 3-methylpyrazol (3-MP), 3,5-dimethylpyrazole (DMP), 1,2,4-triazol thiourea (TU), N-(1H-pyrazolyl-methyl)acetamides such as N-((3 (5)-methyl-1H-pyrazole-1-yl)methyl)acetamide, and N-(1H-pyrazolyl-methyl)formamides such as N-((3 (5)-methyl-1H-pyrazole-1-yl)methyl formamide, N-(4-chloro-3 (5)-methyl-pyrazole-1-ylmethyl)-formamide, N-(3 (5),4-dimethyl-pyrazole-1-ylmethyl)-formamide, neem, products based on ingredients of neem, cyan amide, melamine, zeolite powder, catechol, benzoquinone, sodium terta board, zinc sulfate, 2-(3,4-dimethyl-1H-pyrazol-1-yl) succinic acid (referred to as “DMPSA1” in the following) and/or 2-(4,5-dimethyl-1H-pyrazol-1-yl) succinic acid (referred to as “DMPSA2” in the following), and/or a derivative thereof, and/or a salt thereof; glycolic acid addition salt of 3,4-dimethyl pyrazole (3,4-dimethyl pyrazolium glycolate, referred to as “DMPG” in the following), and/or an isomer thereof, and/or a derivative thereof; citric acid addition salt of 3,4-dimethyl pyrazole (3,4-dimethyl pyrazolium citrate, referred to as “DMPC” in the following), and/or an isomer thereof, and/or a derivative thereof; lactic acid addition salt of 3,4-dimethyl pyrazole (3,4-dimethyl pyrazolium lactate, referred to as “DMPL” in the following), and/or an isomer thereof, and/or a derivative thereof; mandelic acid addition salt of 3,4-dimethyl pyrazole (3,4-dimethyl pyrazolium mandelate, referred to as “DMPM” in the following), and/or an isomer thereof, and/or a derivative thereof; 1,2,4-triazole (referred to as “TZ” in the following), and/or a derivative thereof, and/or a salt thereof; 4-Chloro-3-methylpyrazole (referred to as “CIMP” in the following), and/or an isomer thereof, and/or a derivative thereof, and/or a salt thereof; a reaction adduct of dicyandiamide, urea and formaldehyde, or a triazonyl-formaldehyde-dicyandiamide adduct; 2-cyano-1-((4-oxo-1,3,5-triazinan-1-yl)methyl)guanidine, 1-((2-cyanoguanidino)methyl)urea; 2-cyano-1-((2-cyanoguanidino)methyl)guanidine; 3,4-dimethyl pyrazole phosphate; allylthiourea, and chlorate salts.

Examples of urease inhibitors include N-(n-butyl) thiophosphoric acid triamide (NBPT, Agrotain), N-(n-propyl) thiophosphoric acid triamide (NPPT), 2-nitrophenyl phosphoric triamide (2-NPT), further NXPTs known to the skilled person, phenylphosphorodiamidate (PPD/PPDA), hydroquinone, ammonium thiosulfate, and mixtures of NBPT and NPPT (see e.g., U.S. Pat. No. 8,075,659). Such mixtures of NBPT and NPPT may comprise NBPT in amounts of 40 to 95% wt.-% and preferably of 60 to 80% wt.-% based on the total amount of active substances. Such mixtures are marketed as LIMUS, which is a composition comprising about 16.9 wt.-% NBPT and about 5.6 wt.-% NPPT and about 77.5 wt.-% of other ingredients including solvents and adjuvants.

Suitable plant growth regulators are antiauxins, auxins, cytokinins, defoliants, ethylene modulators, ethylene releasers, gibberellins, growth inhibitors, morphactins, growth retardants, growth stimulators, and further unclassified plant growth regulators.

Suitable micronutrients are compounds comprising boron, zinc, iron, copper, manganese, chlorine, and molybdenum.

The agrochemical composition typically comprises a biologically effective amount, e.g., a pesticidally effective amount of the agrochemical active ingredient. The term “effective amount” denotes an amount of the composition or of the agrochemical active ingredient, which is sufficient for, e.g., controlling harmful fungi on cultivated plants or in the protection of materials and which does not result in a substantial damage to the treated plants. Such an amount can vary in a broad range and is dependent on various factors, such as, e.g., the fungal species to be controlled, the treated cultivated plant or material, the climatic conditions and the specific agrochemical active ingredient used.

The agrochemical composition typically comprises the agrochemical active ingredient in a concentration of 1 to 70% by weight of solids (% w.s.), preferably 1 to 60% w.s., more preferably 10 to 50% w.s., most preferably 20 to 45% w.s., based on the total weight of the agrochemical composition. The agrochemical composition typically contains at least 5% w.s. of the agrochemical active ingredient, preferably at least 15% w.s., more preferably at least 25% w.s., most preferably at least 35% w.s. of the agrochemical active ingredient based on the total weight of the agrochemical composition. The agrochemical composition typically contains up to 95% w.s. of the agrochemical active ingredient, preferably up to 65% w.s., more preferably up to least 45% w.s. of the agrochemical active ingredient based on the total weight of the agrochemical composition. The active substances are employed in a purity of 90% to 100%, preferably 95% to 100%, as determined by nuclear magnetic resonance (NMR) spectroscopy.

The agrochemical composition typically comprises the graft polymer in a concentration of 0.5 to 20% w.s., preferably 0.5 to 10% w.s., more preferably 1 to 8% w.s. based on the total weight of the agrochemical composition. The concentration of the graft polymer is typically up to 15% w.s., more preferably up to 9% w.s., most preferably up to 7% w.s. based on the total weight of the agrochemical composition. The concentration of the graft polymer is usually at least 2% w.s., preferably at least 2.5% w.s. based on the total weight of the agrochemical composition.

The graft polymer according to the invention is typically present in the agrochemical composition in dissolved form, in particular if the agrochemical composition is an aqueous agrochemical composition. Typical solvents include those discussed as auxiliaries below.

The graft polymer may be present as solid particles, such as dispersed particles, especially if the agrochemical composition is a non-aqueous composition, such as a solid composition or an agrochemical composition with a continuous organic phase.

The weight ratio of the active agrochemical ingredient to the graft polymer in the agrochemical composition is typically in the range of 1:1 to 30:1, preferably 5:1 to 30:1, more preferably 7:1 to 20:1.

The agrochemical composition can be any customary type of agrochemical compositions, including solutions, emulsions, suspensions, dusts, powders, pastes, granules, pressings, capsules, and mixtures thereof. Examples for composition types are suspensions (e.g., SC, OD, FS, SE, DC), emulsifiable concentrates (e.g., EC), emulsions (e.g., EW, EO, ES, ME), capsules (e.g., CS, ZC), pastes, pastilles, wettable powders or dusts (e.g., WP, SP, WS, DP, DS), pressings (e.g., BR, TB, DT), granules (e.g., WG, SG, GR, FG, GG, MG), insecticidal articles (e.g., LN), as well as gel compositions for the treatment of plant propagation materials such as seeds (e.g., GF). These and further compositions types are defined in the “Catalogue of pesticide formulation types and international coding system”, Technical Monograph No. 2, 6th Ed. May 2008, CropLife International.

Preferred composition types are suspensions, emulsifiable concentrates (EC), wettable powders or wettable dusts, and granules, in particular suspensions. Preferred suspensions include suspension concentrates (SC), suspo-emulsions (SE) and dispersible concentrates (DC). Most preferred are suspension concentrates (SC).

The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005. The agrochemical composition is typically prepared by contacting the graft polymer and the active agrochemical ingredient. If the agrochemical composition is a suspension, the method typically comprises contacting the active agrochemical ingredient with water to form a mill-base. The premix is then typically submitted to grinding or milling to form the final suspension. The graft polymer may either be added to the mill-base or to the final suspension, in particular to the mill-base.

In case the agrochemical composition is a granule, it is typically obtained by preparing a premix containing the agrochemical active ingredient, the graft polymer, a filler, and typically up to 5 wt.-% of water, and the premix is then extruded. The extrudate is then dried and converted to granules.

Suitable auxiliaries that may be added to the agrochemical composition are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, crystal growth inhibitors, tackifiers and binders.

Suitable solvents and liquid carriers are water and organic solvents, such as mineral oil fractions of medium to high boiling point, e.g., kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g., ethanol, propanol, butanol, benzylalcohol, cyclohexanol; glycols; DMSO; ketones, e.g., cyclohexanone; esters, e.g., lactates, carbonates, fatty acid esters, gamma-butyrolactone; fatty acids; phosphonates; amines; amides, e.g., N-methylpyrrolidone, fatty acid dimethylamides; and mixtures thereof.

Suitable solid carriers or fillers are mineral earths, e.g., silicates, silica gels, talc, kaolins, limestone, lime, chalk, clays, dolomite, diatomaceous earth, bentonite, calcium sulfate, magnesium sulfate, magnesium oxide; polysaccharides, e.g., cellulose, starch; fertilizers, e.g., ammonium sulfate, ammonium phosphate, ammonium nitrate, ureas; products of vegetable origin, e.g., cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in Mccutcheon's, Vol. 1: Emulsifiers & Detergents, Mccutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds which have a neglectable or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g., xanthan gum, carboxymethylcellulose), anorganic clays (organically modified or unmodified), polycarboxylates, and silicates. Suitable bactericides are bronopol and isothiazolinone derivatives such as alkylisothiazolinones and benzisothiazolinones. Suitable anti-freezing agents are ethylene glycol, propylene glycol, urea and glycerin. Suitable anti-foaming agents are silicones, long chain alcohols, and salts of fatty acids. Suitable colorants (e.g., in red, blue, or green) are pigments of low water solubility and water-soluble dyes. Examples are inorganic colorants (e.g., iron oxide, titan oxide, iron hexacyanoferrate) and organic colorants (e.g., alizarin-, azo- and phthalocyanine colorants). Suitable tackifiers or binders are polyvinylpyrrolidons, polyvinylacetates, polyvinyl alcohols, polyacrylates, biological or synthetic waxes, and cellulose ethers.

Examples for composition types and their preparation include:

### i) Water-Soluble Concentrates (SL, LS)

10 to 60 wt.-% of an agrochemical active, 5 to 15 wt.-% wetting agent (e.g., alcohol alkoxylates), and 1 to 15 wt.-% of the graft polymer are dissolved in water and/or in a water-soluble solvent (e.g., alcohols) ad 100 wt.-%. The active substance dissolves upon dilution with water.

### ii) Dispersible Concentrates (DC)

5 to 25 wt.-% of the agrochemical active ingredient, 1 to 10 wt.-% of the graft polymer and optionally further dispersants (e. g. polyvinylpyrrolidone) are dissolved in organic solvent (e.g., cyclohexanone) ad 100 wt.-%. Dilution with water gives a dispersion.

iii) Emulsifiable Concentrates (EC)

15 to 70 wt.-% of an agrochemical active ingredient, 1 to 15 wt.-% of the graft polymer, 5 to 10 wt.-% emulsifiers (e.g., calcium dodecylbenzenesulfonate and castor oil ethoxylate) are dissolved in water-insoluble organic solvent (e.g., aromatic hydrocarbon) ad 100 wt.-%. Dilution with water gives an emulsion.

### iv) Emulsions (EW, EO, ES)

5 to 40 wt.-% of the agrochemical active ingredient, the 1 to 15 wt.-% of the graft polymer and 1 to 10 wt.-% emulsifiers (e.g., calcium dodecylbenzenesulfonate and castor oil ethoxylate) are dissolved in 20 to 40 wt.-% water-insoluble organic solvent (e.g., aromatic hydrocarbon). This mixture may be introduced into water ad 100 wt.-% by means of an emulsifying machine and made into a homogeneous emulsion.

### v) Suspensions (SC, OD, FS)

In an agitated ball mill, 20 to 60 wt.-% of an agrochemical active ingredient are comminuted with addition of 1 to 10 wt.-% the graft polymer and optionally further dispersants, and wetting agents (e.g., sodium lignosulfonate and alcohol ethoxylate), 0.1 to 2 wt.-% thickener (e.g., xanthan gum) and water ad 100 wt.-% to give a fine active substance suspension. Dilution with water gives a stable suspension of the active substance. For FS type composition up to 40 wt.-% binder (e.g., polyvinylalcohol) is added. A suspension emulsion (SE) may be obtained by mixing a suspension with an emulsifiable concentrate or with an emulsion, such as an oil-in-water emulsion (EW).

### vi) Water-Dispersible Granules and Water-Soluble Granules (WG, SG)

50 to 80 wt.-% of the agrochemical active ingredient are ground finely with addition of the graft polymer, optionally further dispersants, and wetting agents (e.g., sodium lignosulfonate and alcohol ethoxylate) ad 100 wt.-% and prepared as water-dispersible or water-soluble granules by means of technical appliances (e. g. extrusion, spray tower, fluidized bed). Dilution with water gives a stable dispersion or solution of the active substance.

vii) Water-Dispersible Powders and Water-Soluble Powders (WP, SP, WS)

50 to 80 wt.-% of an agrochemical active ingredient are ground in a rotor-stator mill with addition of 1 to 5 wt.-% of the graft polymer and optionally further dispersants (e.g., sodium lignosulfonate), 1 to 3 wt.-% wetting agents (e.g., alcohol ethoxylate) and solid carrier (e.g., silica gel) ad 100 wt.-%. Dilution with water gives a stable dispersion or solution of the active substance.

viii) Gel (GW, GF)

In an agitated ball mill, 5 to 25 wt.-% of an agrochemical active ingredient are comminuted with addition of 3 to 10 wt.-% of graft polymer and optionally further dispersants (e.g., sodium lignosulfonate), 1 to 5 wt.-% thickener (e.g., carboxymethylcellulose) and water ad 100 wt.-% to give a fine suspension of the active substance. Dilution with water gives a stable gel of the active substance.

### ix) Microemulsion (ME)

5 to 20 wt.-% of an agrochemical active ingredient are added to 5 to 30 wt.-% organic solvent blend (e.g., fatty acid dimethylamide and cyclohexanone), 10 to 25 wt.-% surfactant blend (e.g., alkohol ethoxylate and arylphenol ethoxylate), 1 to 25 wt.-% of the graft polymer, and water ad 100%. This mixture is stirred for 1 h to produce spontaneously a thermodynamically stable microemulsion.

### x Microcapsules (CS)

An oil phase comprising 5 to 50 wt.-% of an agrochemical active ingredient, 0 to 40 wt.-% water insoluble organic solvent (e.g., aromatic hydrocarbon), 2 to 15 wt.-% acrylic monomers (e.g., methylmethacrylate, methacrylic acid and a di- or triacrylate) are dispersed into an aqueous solution of a protective colloid (e.g., polyvinyl alcohol). Radical polymerization initiated by a radical initiator results in the formation of poly(meth)acrylate microcapsules. Alternatively, an oil phase comprising 5 to 50 wt.-% of an agrochemical active ingredient, 0 to 40 wt.-% water insoluble organic solvent (e.g., aromatic hydrocarbon), and an isocyanate monomer (e.g., diphenylmethene-4,4′-diisocyanatae) are dispersed into an aqueous solution of a protective colloid (e.g., polyvinyl alcohol).

The addition of a polyamine (e.g., hexamethylenediamine) results in the formation of a polyurea microcapsules. The monomers amount to 1 to 10 wt.-%. The wt.-% relate to the total CS composition. The microcapsules may then be dispersed in an aqueous composition. To this end, 1 to 40 wt.-% of the microcapsules are mixed with 2 to 10 wt.-% the graft polymer and optionally further dispersants, and wetting agents (e.g., sodium lignosulfonate and alcohol ethoxylate), 0.1 to 2 wt.-% thickener (e.g., xanthan gum) and water ad 100 wt.-% to yield a CS composition.

### xi) Dustable Powders (DP, DS)

1 to 10 wt.-% of an agrochemical active ingredient are ground finely and mixed intimately with the 1 to 20 wt.-% of the graft polymer, and solid carrier (e.g., finely divided kaolin) ad 100 wt.-%.

xii) Granules (GR, FG)

0.5 to 30 wt.-% of an agrochemical active ingredient is ground finely and associated with 1 to 20 wt.-% of the graft polymer and with solid carrier (e.g., silicate) ad 100 wt.-%. Granulation is achieved by extrusion, spray-drying or the fluidized bed.

xiii) Ultra-Low Volume Liquids (UL)

1 to 50 wt.-% of an agrochemical active ingredient and 1 to 30 wt.-% of the graft polymer are dissolved in organic solvent (e.g., aromatic hydrocarbon) ad 100 wt.-%.

The compositions types i) to xi) may optionally comprise further auxiliaries such as those discussed above, e.g., 0.1 to 1 wt.-% bactericides, 5 to 15 wt.-% anti-freezing agents, 0.1 to 1 wt.-% anti-foaming agents, and 0.1 to 1 wt.-% colorants.

In one embodiment, the agrochemical composition is a suspension, preferably a suspension concentrate. The agrochemical suspension typically contains the agrochemical active ingredient in a concentration of 1 to 65 wt.-%, preferably 10 to 60 wt.-%, more preferably 20 to 50 wt.-%, most preferably 30 to 50 wt.-% based on the total weight of the agrochemical suspension.

The agrochemical suspension contains at least a portion of the agrochemical active as solid particles suspended in a continuous phase, which is preferably an aqueous continuous phase. Accordingly, the agrochemical suspension is preferably an aqueous agrochemical suspension containing at least 5 wt.-% of water, preferably at least 10 wt.-%, more preferably at least 15 wt.-%, most preferably at least 20 wt.-%, especially preferably at least 25 wt.-%, such as at least 30 wt.-%, in particular at least 40 wt.-%, each time based on the total weight of the suspension. The agrochemical composition may contain up to 95 wt.-% of water, preferably up to 80 wt.-%, more preferably up to 70 wt.-%, most preferably up to 60 wt.-% of water, such as up to 50 wt.-% of water, each time based on the total weight of the suspension.

The agrochemical active ingredient typically exhibits low water-solubility. The agrochemical active may have a water-solubility at 20° C. and pH of 7 of up to 10 g/L, preferably up to 5 g/L, more preferably up to 1 g/L, most preferably up to 0.5 g/L, in particular up to 0.1 g/L.

The agrochemical active ingredient is present in the form of suspended particles in the agrochemical suspension. The particles may be characterized by their size distribution, which can be determined by dynamic light scattering techniques. Suitable dynamic light scattering measurement units are inter alia produced under the trade name Malvern Mastersizer 3000.

The particles of the agrochemical active ingredient may be characterized by their median diameter, which is usually abbreviated as D50 value. The D50 value refers to a particular particle diameter, wherein half of the particle population by volume is smaller than this diameter. The D50 value is typically determined according to ISO 13320:2009. The particles may have an D50 value in the range of 0.05 μm to 25 μm, preferably in the range of 0.1 μm to 20 μm, more preferably in the range of 0.5 to less than 20 μm, most preferably in the range of 0.5 μm to 15 μm, especially preferably in the range of 0.5 μm to 10 μm. The particles typically have a D50 value of at least 0.75 μm, preferably at least 1 μm, and as upper limit preferably at most 3 μm or at most 2 μm.

The particles of the agrochemical active ingredient may further be characterized by their D90 value. The D90 value refers to a particular particle diameter, wherein 90% of the particle population by volume is smaller than this diameter. The D90 value is typically determined according to ISO 13320:2009. The particles may have a D90 value of less than 30 to 3 μm, in particular less than 20 μm or less than 15 μm, especially less than 10 μm or less than 8 μm or less than 6 μm or less than 5 μm.

The particles of the agrochemical active ingredient may also be characterized by their D10 value. The D10 value refers to a particular particle diameter, wherein 10% of the particle population by volume is smaller than this diameter. The D10 value is typically determined according to ISO 13320:2009. The particles may generally have a D10 value of less than 2 μm, e.g. in the range of 0.05 to <2 μm, in particular in the range of 0.1 to 1.5 μm or in the range of 0.1 to 1 μm.

Preferably, the particles have D50 value in the range of 0.5 to 10 μm, especially in the range of 0.5 to 3 μm or in the range of 0.75 to 2 μm and a D90 value in the range of 3 to less than 10 μm.

The suspended particles may be present in the form of crystalline or amorphous particles which are solid at 20° C.

Typically, at least 50 wt.-% of the agrochemical active ingredient may be present as solid particles based on the total weight of the agrochemical active ingredient in the agrochemical suspension, preferably at least 70 wt.-%, more preferably at least 90 wt.-%.

The agrochemical suspension may contain a further active ingredient, which may be selected from fungicides, insecticides, nematicides, herbicides, safeners, micronutrients, biopesticides, nitrification inhibitors, urease inhibitors, and/or growth regulators. The further active ingredient may be present in dissolved form or as suspended particles in the agrochemical suspension. The concentration of the further active ingredient is typically from 1 to 50 wt.-%, preferably from 10 to 25 wt.-% based on the total weight of the agrochemical suspension.

The agrochemical suspension may be prepared at any pH value. Preferably, agrochemical suspensions according to the invention have a pH below 9, more preferably from 4 to 8.

The agrochemical suspension typically contains a thickener. The term “thickener(s)” usually refers to inorganic clays (organically modified or unmodified), such as bentonites, attapulgite, hectorite and smectite clays, and silicates (e.g., colloidal hydrous magnesium silicate, colloidal hydrous aluminium silicate, colloidal hydrous aluminium magnesium silicate, hydrous amorphous silicon dioxide); and organic clays, such as polycarboxylates (e.g., poly(meth)acrylates and modified poly(meth)acrylates), polysaccharides (e.g., xanthan gum, agarose, rhamsan gum, pullulan, tragacanth gum, locust bean gum, guar gum, tara gum, Whelan cum, casein, dextrin, diutan gum, cellulose, ethylcellulose, hydroxyethylcellulose, methylhydroxypropylcellulose), polyvinyl ethers, polyvinyl pyrrolidone, polypropylene oxide-polyethylene ocide condensates, polyvinyl acetates, maleic anhydrides, polypropylene glycols, polyacrylonitrile block copolymers, proteins, and carbohydrates.

The invention also relates to the use of the graft polymer according to the present invention as a dispersant for agrochemical active ingredients in agrochemical compositions, such as in suspensions. It is understood that all embodiments regarding the agrochemical composition herein relate to both the inventive agrochemical composition and the inventive use of the graft polymer as a dispersant for agrochemical active ingredients in agrochemical compositions.

Solutions for seed treatment (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. These compositions give, after two-to-tenfold dilution, active substance concentrations of 0.01 to 60 wt.-%, preferably 0.1 to 40 wt.-%, in the ready-to-use preparations. Application can be carried out before or during sowing. Methods for applying the agrochemical composition on to plant propagation material, especially seeds include dressing, coating, pelleting, dusting, soaking and in-furrow application methods of the propagation material. Preferably, the agrochemical composition applied on to the plant propagation material by a method such that germination is not induced, e. g. by seed dressing, pelleting, coating and dusting.

The invention also relates to a method for controlling phytopathogenic fungi and/or undesired plant growth and/or undesired attack by insects or mites and/or for regulating the growth of plants, where the agrochemical composition is allowed to act on the phytopathogenic fungi, undesired plant growth or undesired insects or mites; and/or on the habitat of the phytopathogenic fungi, undesired plant growth or undesired insects or mites; and/or on the plants to be protected, and/or on the soil of the plants to be protected; and/or on the useful plants and/or their habitat.

In one embodiment, the method is for controlling phytopathogenic fungi. In another embodiment, the method is for controlling undesired plant growth. In another embodiment, the method is for controlling undesired attach by insects or mites. These methods typically comprise the treatment of the plant to be protected, its locus of growth, the phytopathogenic fungi and/or undesired plant growth and/or undesired attack by insects or mites with the agrochemical composition.

Suitable methods of treatment include inter alia soil treatment, seed treatment, in furrow application, and foliar application. Soil treatment methods include drenching the soil, drip irrigation (drip application onto the soil), dipping roots, tubers or bulbs, or soil injection. Seed treatment techniques include seed dressing, seed coating, seed dusting, seed soaking, and seed pelleting. In furrow applications typically include the steps of making a furrow in cultivated land, seeding the furrow with seeds, applying the pesticidally active compound to the furrow, and closing the furrow.

When employed in plant protection, the amounts of agrochemical active applied are, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

In treatment of plant propagation materials such as seeds, e. g., by dusting, coating or drenching seed, amounts of active substance of 0.1 to 1000 g, preferably 1 to 1000 g, more preferably from 1 to 100 g and most preferably from 5 to 100 g, per 100 kilogram of plant propagation material (preferably seeds) are generally required.

The invention also relates to a seed comprising the agrochemical composition of the invention in an amount of 0.1 g to 10 kg per 100 kg of seed.

Various types of oils, wetters, adjuvants, fertilizer, or micronutrients, and further pesticides (e.g., herbicides, insecticides, fungicides, growth regulators, safeners) may be added to the agrochemical composition as premix or, if appropriate not until immediately prior to use (tank mix). These agents can be admixed with the compositions according to the invention in a weight ratio of 1:100 to 100:1, preferably 1:10 to 10:1.

The user applies the agrochemical composition according to the invention usually from a predosage device, a knapsack sprayer, a spray tank, a spray plane or a spray drone, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2,000 liters, preferably 50 to 400 liters, of the ready-to-use spray liquor are applied per hectare of agricultural useful area.

The invention also relates to a method for combating or controlling invertebrate pests, which method comprises contacting the invertebrate pest or its food supply, habitat or breeding grounds with a pesticidally effective amount of the agrochemical composition. Moreover, the invention relates to a method for protecting growing plants from attack or infestation by invertebrate pests, which method comprises contacting a plant, or soil or water in which the plant is growing, with a pesticidally effective amount of the agrochemical composition. Furthermore, the invention relates to a method for treating or protecting an animal from infestation or infection by invertebrate pests, which method comprises bringing the animal in contact with a pesticidally effective amount of the agrochemical composition.

Invertebrate pests according to the present invention are typically arachnids, mollusca, or insects, in particular insects.

According to one embodiment, individual components of the composition according to the invention such as parts of a kit or parts of a binary or ternary mixture may be mixed by the user itself in a spray tank and further auxiliaries may be added, if appropriate.

In a further embodiment, either individual components of the composition according to the invention or partially premixed components may be mixed by the user in a spray tank and further auxiliaries and additives may be added, if appropriate.

In a further embodiment, either individual components of the composition according to the invention or partially premixed components can be applied jointly (e.g., after tank mix) or consecutively.

### Other Uses

Another subject matter of the present invention is the use of the graft polymers of the invention and/or obtained by or obtainable by a process of the invention and/or as detailed before, in certain compositions for other uses:

Hence, another subject matter of the present invention is the use of the graft polymers of the invention and/or obtained by or obtainable by a process of the invention and/or as detailed before in any of in this chapter before-mentioned applications, such as in cosmetic and personal care formulations, as crude oil emulsion breaker, in technical applications including in pigment dispersions for ink jet inks, in formulations for electro plating, in cementitious compositions, in agrochemical formulations as e.g. dispersants, crystal growth inhibitor and/or solubilizer, in lacquer and colorants formulations, textile and leather treatment products for use during or after production, formulations containing inorganic salts such as especially silver salts, mining, metal production and treatment including metal refining and metal quenching, purification of liquids such as waste water from industry, production or consumers, preferably in cleaning compositions, in particular cleaning compositions for improved oily and fatty stain removal, removal of solid dirt such as clay, anti-scale agents, and/or as dye transfer inhibitor.

Another subject-matter of the present invention is, therefore, also a cleaning composition, industrial and institutional cleaning product, or a formulation or product for any of the previously mentioned applications and application fields, each comprising at least one graft polymer as defined above or obtained by or obtainable by a process of the invention and/or as detailed herein.

Such inventive uses and inventive compositions/products encompass the use of the graft polymer as detailed herein and/or as obtainable from or obtained from the inventive process, such graft polymer resembling that as detailed above describing the polymer structure in any of its embodiments disclosed herein before, including any variations mentioned, and more specifically any of the preferred, more preferred etc. embodiments.

The graft polymers may also support the removal of various hydrophobic and hydrophilic soils, such as body soils, food and grease soil, particulate soil such clay or carbon black, grass soil, make-up, motor oil etc. from surfaces such as hard surfaces by the surfactants and thus improve the washing and cleaning performances of the formulations.

In one embodiment it is also preferred in the present invention that the cleaning composition comprises (besides at least one graft polymer as described above) additionally at least one enzyme, preferably selected from one or more optionally further comprising at least one enzyme, preferably selected from one or more lipases, hydrolases, amylases, proteases, cellulases, hemicellulases, phospholipases, esterases, pectinases, lactases, pectate lyases, cutinases, DNases, xylanases, oxicoreductases, dispersins, mannanases and peroxidases, and combinations of at least two of the foregoing types, preferably at least one enzyme being selected from lipases.

Another subject-matter of the present invention is, therefore, a cleaning composition such as an industrial and institutional (I&I) cleaning product, comprising at least one graft polymer as defined above, and in particular a cleaning composition for improved as dye transfer inhibition.

At least one graft polymer as described herein is present in said inventive cleaning compositions in an amount ranging from about 0.01% to about 20%, preferably 0.05 to 10%, more preferably from about 0.1% to 8%, even more preferably from about 0.2% to about 6%, and further more preferably from about 0.2% to about 4%, and most preferably in amounts of up to 2%, each in weight % in relation to the total weight of such composition or product; such cleaning composition may—and preferably does—further comprise a from about 1% to about 70% by weight of a surfactant system.

Even more preferably, the cleaning compositions of the present invention comprising at least one inventive graft polymer, and optionally further comprising at least one surfactant or a surfactant system, and may additionally comprise at least one enzyme selected from the list consisting of optionally further comprising at least one enzyme, preferably selected from one or more optionally further comprising at least one enzyme, preferably selected from one or more lipases, hydrolases, amylases, proteases, cellulases, hemicellulases, phospholipases, esterases, pectinases, lactases, pectate lyases, cutinases, DNases, xylanases, oxicoreductases, dispersins, mannanases and peroxidases, and combinations of at least two of the foregoing types, preferably selected from one or more lipases, hydrolases, amylases, proteases, cellulases, and combinations of at least two of the foregoing types, more preferably at least one enzyme being selected from lipases.

In another embodiment, the cleaning composition of the present invention is a hard surface cleaning composition that may be used for cleaning various surfaces such as hard wood, tile, ceramic, plastic, leather, metal, glass.

In one embodiment, the inventive graft polymers may be utilized in cleaning compositions comprising a surfactant system comprising C10-C15 alkyl benzene sulfonates (LAS) as the primary surfactant and one or more additional surfactants selected from non-ionic, cationic, amphoteric, zwitterionic or other anionic surfactants, or mixtures thereof.

In a further embodiment, the inventive graft polymers may be utilized in cleaning compositions, such as laundry detergents of any kind, and the like, comprising C8-C18 linear or branched alkyl ethersulfates with 1-5 ethoxy-units as the primary surfactant and one or more additional surfactants selected from non-ionic, cationic, amphoteric, zwitterionic or other anionic surfactants, or mixtures thereof.

In a further embodiment the inventive graft polymers may be utilized in cleaning compositions, such as laundry detergents of any kind, and the like, comprising C12-C18 alkyl ethoxylate surfactants with 5-10 ethoxy-units as the primary surfactant and one or more additional surfactants selected from anionic, cationic, amphoteric, zwitterionic or other non-ionic surfactants, or mixtures thereof.

In one embodiment of the present invention, the graft polymer is a component of a cleaning composition, that each additionally comprise at least one surfactant, preferably at least one anionic surfactant.

The cleaning compositions of the invention may be in any form, namely, in the form of a “liquid” composition including liquid-containing composition types such as paste, gel, emulsion, foam and mousse; a solid composition such as powder, granules, micro-capsules, beads, noodles, pearlised balls, agglomerates, tablets, granular compositions, sheets, pastilles, beads, fibrous articles, bars, flakes; or a mixture thereof; types delivered in single-, udal- or multi-compartment pouches or containers; single-phase or multi-phase unit dose; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a user or consumer; and other homogeneous, non-homogeneous or single-phase or multiphase cleaning product forms.

The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof.

Non-limiting examples of “liquids”/“liquid compositions” include light duty and heavy duty liquid detergent compositions, fabric enhancers, detergent gels commonly used for laundry, bleach and laundry additives. Gases, e.g., suspended bubbles, or solids, e.g. particles, may be included within the liquids.

Cleaning compositions such as fabric and home care products and formulations for industrial and institutional cleaning, more specifically such as laundry and manual dish wash detergents, are known to a person skilled in the art. Any composition etc. known to a person skilled in the art, in connection with the respective use, can be employed within the context of the present invention by including at least one inventive polymer, preferably at least one polymer in amounts suitable for expressing a certain property within such a composition, especially when such a composition is used in its area of use.

All such cleaning compositions, their ingredients including (adjunct) cleaning additives, their general compositions and more specific compositions are known, as for example illustrated in the publications 800542 and 800500 as published by Protegas, Liechtenstein, and also from WO 2022/136409 and WO 2022/136408, wherein in any of the before prior art documents the graft polymer within the general compositions and also each individualized specific cleaning composition disclosed in the beforementioned publications may be replaced partially or completely by the graft polymer of this present invention having the same function. In those beforementioned documents, also various types of formulations for cleaning compositions are disclosed; all such composition types—the general compositions and also each individualized specific cleaning composition—can be equally applied also to those cleaning compositions contemplated herein.

Hence, the present invention also encompasses any and all of such disclosed compositions of the before-mentioned prior art-disclosures but further comprising at least one of the inventive graft polymer in addition to or as a replacement for any already ins such prior art-composition contained polymer or any such compound, which can be replaced by such inventive graft polymer—such replacements known to a person of skill in the art—with the content of the inventive graft polymer being present in said formulations at a concentration of generally from 0.05 to 20 wt. %, preferably up to 15 wt. %, more preferably 0.1 to 10 weight %, even more preferably at a concentration of 0.5 to 5 weight %, and any lower limit in between 0.1 and 0.5 and including from 1, 1.5, 2, 2.5 or even 3, and any upper limit in between 5 and 10, and any range composed of any lower limit number and any upper limit number is encompassed as well.

### Definitions

As used herein, the articles “a” and “an” when used in a claim or an embodiment, are understood to mean one or more of what is claimed or described. As used herein, the terms “include(s)” and “including” are meant to be non-limiting, and thus encompass more than the specific item mentioned after those words.

The term “about” as used herein encompasses the exact number “X” mentioned as e.g. “about X %” etc., and small variations of X, including from minus 5 to plus 5% deviation from X (with X for this calculation set to 100%), preferably from minus 2 to plus 2%, more preferably from minus 1 to plus 1%, even more preferably from minus 0.5 to plus 0.5% and smaller variations. Of course, if the value X given itself is already “100%” (such as for purity etc.) then the term “about” clearly can and thus does only mean deviations thereof which are smaller than “100”.

The term “free of water” means that the composition contains no more than 5 wt.-% of water based on the total amount of solvent, in another embodiment no more than 1 wt.-% of water based on the total amount of solvent, in a further embodiment the solvent contains no water at all.

The compositions of the present disclosure can “comprise” (i.e. contain other ingredients), “consist essentially of” (comprise mainly or almost only the mentioned ingredients and other ingredients in only very minor amounts, mainly only as impurities), or “consist of” (i.e. contain only the mentioned ingredients and in addition may contain only impurities not avoidable in an technical environment, preferably only the ingredients) the components of the present disclosure.

Similarly, the terms “substantially free of . . . ” or “substantially free from . . . ” or “(containing/comprising) essentially no . . . ” may be used herein; this means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or even less than 0.1%, or even more less than 0.01%, or even 0%, by weight of the composition.

Generally, as used herein, the term “obtainable by” means that corresponding products do not necessarily have to be produced (i.e. obtained) by the corresponding method or process de-scribed in the respective specific context, but also products are comprised which exhibit all features of a product produced (obtained) by said corresponding method or process, wherein said products were actually not produced (obtained) by such method or process. However, the term “obtainable by” also comprises the more limiting term “obtained by”, i.e. products which were actually produced (obtained) by a method or process described in the respective specific context.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (C) unless otherwise indicated. Unless otherwise specified, all measurements herein are conducted at 20° C. and under the atmospheric pressure. In all embodiments of the present disclosure, all percentages are by weight of the total composition, unless specifically stated otherwise. All ratios are weight ratios, unless specifically stated otherwise.

Throughout this description, the term “inventive compound” may be used instead of the “inventive (graft) polymer(s)” and “(graft) polymer(s) of this (present) invention”, meaning those compounds being disclosed herein as invention, defined by their structure and/or their process to produce or obtainable by the process defined herein.

The definitions and their preferences given within the “Definition”-section are included as part of this invention as described herein.

The specific embodiments as described throughout this disclosure are encompassed by the present invention as part of this invention; the various further options being disclosed in this present specification as “optional”, “preferred”, “more preferred”, “even more preferred” or “most preferred” (or “preferably” etc.) options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently unless such independent selection is not possible by virtue of the nature of that feature or if such independent selection is explicitly excluded), with each and any and all such possible combinations being included as part of this invention as individual embodiments.

The phrase “cleaning composition” as used herein includes compositions and formulations designed for cleaning soiled material. Such compositions and formulations include those designed for cleaning soiled material or surfaces of any kind.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces.

The phrase “fabric care composition” is meant to include compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation.

The phrase “compositions for Fabric and Home Care” includes cleaning compositions including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, light duty liquid detergents compositions, heavy duty liquid detergent compositions, detergent gels commonly used for laundry, bleaching compositions, laundry additives, fabric enhancer compositions, and other suitable forms that may be apparent to one skilled in the art in view of the teachings herein. Such compositions may be used as a pre-laundering treatment, a post-laundering treatment, or may be added during the rinse or wash cycle of the laundering operation, preferably during the wash cycle of the laundering or dish washing operation. Typically, such compositions contain cleaning additives.

The specific embodiments as described throughout this disclosure are encompassed by the present invention as part of this invention; the various further options being disclosed in this present specification as “optional”, “preferred”, “more preferred”, “even more preferred” or “most preferred” options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently), with each and any and all such possible combinations being included as part of this invention as individual embodiments.

The following examples shall further illustrate the present invention without restricting the scope of the invention.

### EXAMPLE SECTION

The number average molecular weight (Mn), the weight average molecular weight (Mw) and the polydispersity Mw/Mn of the inventive graft polymers can be determined by gel permeation chromatography in dimethylacetamide. The mobile phase (eluent) to be used is dimethylacetamide comprising 0.5 wt % LiBr. The concentration of graft polymer in tetrahydrofuran is 4.0 mg per mL. After filtration (pore size 0.2 μm), 100 μL of this solution are to be injected into the GPC system. Four columns (heated to 60° C.) may be used for separation (PLgel precolumn, 3 PLgel MIXED-E column). The GPC system is operated at a flow rate of 1 mL per min. A DRI Agilent 1100 may be used as the detection system. Poly(ethylene glycol) (PEG) standards (PL) having a molecular weight Mn from 106 to 1 378 000 g/mol may be used for the calibration.

The molecular weights given are calculated weights unless “Mw” or “Mn” is stated, based on the total molar amounts of ingredients employed for the preparation reaction. As those reactions proceed basically to completeness, this is an acceptable way of calculation the molecular weights

### Synthesis of the Backbone and Inventive Polymers

The following backbone are prepared as backbone for inventive graft polymers.

$$A : 35 EO + 3 CL + 9 EO + 3 CL + 35 EO$$

$$B : 3 CL + 34 EO + 3 CL$$

$$C : 51 EO + 3 CL + 9 EO + 3 CL + 51 EO$$

$$D : 3 CL + 78 EO + 3 CL$$

$$E : 1.5 CL + 34 EO + 1.5 CL$$

$$F : 5 CL + 61 EO + 5 CL$$

$$G : 1.5 CL + 611 EO + 1.5 CL$$

$$H : 23 EO + 4 CL + neopentylglycol + 4 CL + 23 EO$$

$$I : {( 20 EO + 2 PO )}_{random} + 4 CL + neopentylglycol + 4 CL + {( 20 EO + 2 PO )}_{random}$$

$$J : 20 EO + 1 CL + neopentylglycol + 1 CL + 20 EO$$

$$K : {( 35 EO + 3 CL )}_{random} + 9 EO + {( 3 CL + 35 EO )}_{random}$$

### General Synthesis of Backbones A, C, H, I, and J:

Caprolactone is oligomerized before alkylene oxide polymerization yielding mixed random/block structures, and backbones are obtained by alkoxylation of polycaprolactones.

### General Synthesis of Backbones B, D, E, F and G:

Caprolactone is added after alkylene oxide polymerization yielding block structures polycaprolactone-polyalkylene oxide-polycaprolactone

### General Synthesis Concept of Backbone K:

Suitable starters are reacted with a premixed combination of alkylene oxides and caprolactone.

### Synthesis of Inventive Graft Polymer 1-21:

TABLE 1
Inventive graft polymers 1-21 are
synthesized based on backbone A-J.

Backbone

| molecular | |
|---|---|
| weight | Graft |

| Polymer | Type | g/mol | Wt % | Type | Wt % |
|---|---|---|---|---|---|
| Inv. 1 | A | 4168 | 65 | VAc | 35 |
| Inv. 2 | A | 4168 | 50 | VAc | 50 |
| Inv. 3 | C | 5590 | 65 | VAc | 35 |
| Inv. 4 | C | 5590 | 40 | VAc | 60 |
| Inv. 5 | D | 4165 | 65 | VAc | 35 |
| Inv. 6 | D | 4165 | 70 | VAc/VL | 25/5 |
| Inv. 7 | E | 1842 | 80 | VAc | 20 |
| Inv. 8 | F | 3842 | 50 | VAc/VP | 30/20 |
| Inv. 9 | F | 3842 | 50 | VAc | 50 |
| Inv. 10 | G | 3000 | 50 | VAc | 50 |
| Inv. 11 | G | 3000 | 65 | VAc/VP | 20/15 |
| Inv. 12 | H | 3040 | 60 | VAc | 40 |
| Inv. 13 | I | 3009 | 65 | VAc | 35 |
| Inv. 14 | I | 3009 | 65 | VAc/VP | 30/5 |
| Inv. 15 | I | 3009 | 65 | VAc/VP | 25/10 |
| Inv. 16 | I | 3009 | 65 | VAc/VP | 20/15 |
| Inv. 17 | J | 2092 | 65 | VAc/VL | 25/10 |
| Inv. 18 | F | 3842 | 50 | VAc*/VP | 30/20 |
| Inv. 19 | B | 2178 | 65 | VAc | 35 |
| Inv. 20 | K | 4241 | 35 | VAc | 65 |
| Inv. 21 | K | 4241 | 65 | VAc | 35 |

Note:
VAc = Vinyl acetate; VL = Vinyl laurate; VP = Vinyl pyrrolidone;
*partially hydrolyzed: 40 mol % hydrolysis based on the total amount of VAc.

### Example 1 (Inv. 1)

### Example 1 a: Polyethylene Glycol (Molecular Weight 400 g/Mol), Modified with 6 Moles Caprolactone

In a 4-neck vessel with thermometer, reflux condenser, nitrogen inlet, dropping funnel, and stirrer, 240.0 g polyethylene glycol (molecular weight 400 g/mol) and 0.75 g tin(II) ethylhexanoate were placed and heated to 100° C.

415.0 g epsilon-caprolactone was added within 15 minutes. The reaction mixture was heated to 160° C. and stirred for 14 hours at 160° C. under nitrogen. After cooling to room temperature, 645.0 g of an orange oil was obtained. 1H-NMR in MeOD indicated 99.5% conversion of caprolactone.

### Example 1 b (Backbone A): Polyethylene Glycol (Molecular Weight 400 g/Mol), Modified with 6 Moles Caprolactone and Ethoxylated with 70 Moles Ethylene Oxide

In a 2 l autoclave 271.2 g polyethylene glycol (molecular weight 400 g/mol), modified with 6 moles caprolactone (example 1a) and 2.1 g potassium tert. butoxide were placed and the mixture was heated to 80° C. The vessel was purged three times with nitrogen and the mixture was heated to 140° C. 770.9 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. After filtration 1041.0 g of a light brown solid was obtained. 1H-NMR in CDCl3 confirmed the expected structure.

### Example 1 c (Graft Polymer)

A polymerization vessel equipped with stirrer and reflux condenser was initially charged with Backbone A (455.00 g) under nitrogen atmosphere and heated to 90° C. Feed 1 (2.81 g of tert-Butyl peroxy-2-ethylhexanoate dissolved in 24.76 g of tripropylene glycol) and 10 min upon the start of Feed 1, Feed 2 (245.00 g of vinyl acetate) were started and dosed to the stirred vessel with a variable feed rate of Feed 1 (0:00 h to 00:10 h: 9.20 g/h and 00:10 h to 06:10 h: 4.34 g/h) and a constant feed rate of Feed 2 (00:10 h to 06:10 h: 40.8 g/h). Upon completion of Feed 1 and Feed 2, Feed 3 (1.79 g of tert-Butyl peroxy-2-ethylhexanoate dissolved in 15.72 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 745 g of a polymer solution.

### Example 2 (Inv. 2)

A polymerization vessel equipped with stirrer and reflux condenser was initially charged with Backbone A (450.00 g) under nitrogen atmosphere and heated to 90° C. Feed 1 (10.08 g of tert-Butyl peroxy-2-ethylhexanoate dissolved in 36.89 g of tripropylene glycol) and 10 min upon the start of Feed 1, Feed 2 (450.50 g of vinyl acetate) were started and dosed to the stirred vessel with a variable feed rate of Feed 1 (0:00 h to 00:10 h: 15.7 g/h and 00:10 h to 06:10 h: 7.39 g/h) and a constant feed rate of Feed 2 (00:10 h to 06:10 h: 75.0 g/h). Upon completion of Feed 1 and Feed 2, Feed 3 (3.19 g of tert-Butyl peroxy-2-ethylhexanoate dissolved in 11.66 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 961 g of a polymer solution.

### Example 3 (Inv. 3)

### Example 3 a (Backbone C): Polyethylene Glycol (Molecular Weight 400 g/Mol), Modified with 6 Moles Caprolactone and Ethoxylated with 102.2 Moles Ethylene Oxide

In a 2 l autoclave 192.9 g polyethylene glycol (molecular weight 400 g/mol), modified with 6 moles caprolactone (example 1a) and 2.0 g potassium tert. butoxide were placed and the mixture was heated to 80° C. The vessel was purged three times with nitrogen and the mixture was heated to 140° C. 801.8 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. After filtration 990.0 g of a light brown solid was obtained. 1H-NMR in CDCl3 confirmed the expected structure.

### Example 3 b (Graft Polymer)

A polymerization vessel equipped with stirrer and reflux condenser was initially charged with Backbone C (455.00 g) under nitrogen atmosphere and heated to 90° C. Feed 1 (2.81 g of tert-Butyl peroxy-2-ethylhexanoate dissolved in 24.76 g of tripropylene glycol) and 10 min upon the start of Feed 1, Feed 2 (245.00 g of vinyl acetate) were started and dosed to the stirred vessel with a variable feed rate of Feed 1 (0:00 h to 00:10 h: 9.20 g/h and 00:10 h to 06:10 h: 4.34 g/h) and a constant feed rate of Feed 2 (00:10 h to 06:10 h: 40.8 g/h). Upon completion of Feed 1 and Feed 2, Feed 3 (1.79 g of tert-Butyl peroxy-2-ethylhexanoate dissolved in 15.72 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 745 g of a polymer solution.

### Example 4 (Inv. 4)

A polymerization vessel equipped with stirrer and reflux condenser was initially charged with Backbone C (400.00 g) under nitrogen atmosphere and heated to 90° C. Feed 1 (7.24 g of tert-Butyl peroxy-2-ethylhexanoate dissolved in 31.90 g of tripropylene glycol) and 10 min upon the start of Feed 1, Feed 2 (600.00 g of vinyl acetate) were started and dosed to the stirred vessel with a variable feed rate of Feed 1 (0:00 h to 00:10 h: 13.1 g/h and 00:10 h to 06:10 h: 5.13 g/h) and a constant feed rate of Feed 2 (00:10 h to 06:10 h: 83.4 g/h). Upon completion of Feed 1 and Feed 2, Feed 3 (4.80 g of tert-Butyl peroxy-2-ethylhexanoate dissolved in 21.12 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 1065 g of a polymer solution.

### Example 5 (Inv. 5)

### Example 5 a: Polyethylene Glycol (Molecular Weight 1500 g/Mol), Ethoxylated with 44 Moles Ethylene Oxide

In a 2 l autoclave 599.9 g polyethylene glycol (molecular weight 1500 g/mol) and 2.7 g potassium tert. butoxide were placed and the mixture was heated to 80° C. The vessel was purged three times with nitrogen and the mixture was heated to 140° C. 754.2 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. After filtration 1350.0 g of a light brown solid was obtained. 1H-NMR in CDCl3 confirmed the expected structure.

### Example 5 b (Backbone D): Polyethylene Glycol (Molecular Weight 1500 g/Mol), Ethoxylated with 44 Moles Ethylene Oxide and Modified with 6 Moles Caprolactone

In a 4-neck vessel with thermometer, reflux condenser, nitrogen inlet, dropping funnel, and stirrer, 1044.1 g polyethylene glycol (molecular weight 1500 g/mol), ethoxylated with 44 moles ethylene oxide (example 5a) and 1.25 g tin(II) ethylhexanoate were placed and heated to 90° C.

205.5 g epsilon-caprolactone was added within 15 minutes. The reaction mixture was heated to 160° C. and stirred for 10 hours at 160° C. under nitrogen. After cooling to room temperature, 1236.0 g of an orange oil was obtained. 1H-NMR in CDCl3 indicated 98.8% conversion of caprolactone.

### Example 5 c (Graft Polymer)

A polymerization vessel equipped with stirrer and reflux condenser was initially charged with Backbone D (455.00 g) under nitrogen atmosphere and heated to 90° C. Feed 1 (2.81 g of tert-Butyl peroxy-2-ethylhexanoate dissolved in 24.76 g of tripropylene glycol) and 10 min upon the start of Feed 1, Feed 2 (245.00 g of vinyl acetate) were started and dosed to the stirred vessel with a variable feed rate of Feed 1 (0:00 h to 00:10 h: 9.20 g/h and 00:10 h to 06:10 h: 4.34 g/h) and a constant feed rate of Feed 2 (00:10 h to 06:10 h: 40.8 g/h). Upon completion of Feed 1 and Feed 2, Feed 3 (1.79 g of tert-Butyl peroxy-2-ethylhexanoate dissolved in 15.72 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 745 g of a polymer solution.

### Example 6 (Inv. 6)

A polymerization vessel equipped with stirrer and reflux condenser was initially charged with Backbone D (679.00 g) under nitrogen atmosphere and heated to 90° C. Feed 1 (10.87 g of tert-Butyl peroxy-2-ethylhexanoate dissolved in 39.76 g of tripropylene glycol) and 10 min upon the start of Feed 1, Feed 2 (a mixture of 242.50 g of vinyl acetate and 48.50 g of vinyl laurate) were started and dosed to the stirred vessel with a variable feed rate of Feed 1 (0:00 h to 00:10 h: 16.9 g/h and 00:10 h to 06:10 h: 7.97 g/h) and a constant feed rate of Feed 2 (00:10 h to 06:10 h: 48.5 g/h). Upon completion of Feed 1 and Feed 2, Feed 3 (3.43 g of tert-Butyl peroxy-2-ethylhexanoate dissolved in 12.56 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 1036 g of a polymer solution.

### Example 7 (Inv. 7)

### Example 7 a (Backbone E): Polyethylene Glycol (Molecular Weight 1500 g/Mol), Modified with 3 Moles Caprolactone

In a 4-neck vessel with thermometer, reflux condenser, nitrogen inlet, dropping funnel, and stirrer, 480.0 g polyethylene glycol (molecular weight 1500 g/mol), and 0.6 g tin(II) ethylhexanoate were placed and heated to 80° C.

109.6 g epsilon-caprolactone was added within 5 minutes. The reaction mixture was heated to 160° C. and stirred for 10 hours at 160° C. under nitrogen. After cooling to room temperature, 580.0 g of an orange oil was obtained. 1H-NMR in CDCl3 indicated 96.7% conversion of caprolactone

### Example 7 b (Graft Polymer)

A polymerization vessel equipped with stirrer and reflux condenser was initially charged with Backbone E (540.00 g) under nitrogen atmosphere and heated to 90° C. Feed 1 (7.56 g of tert-Butyl peroxy-2-ethylhexanoate dissolved in 27.67 g of tripropylene glycol) and 10 min upon the start of Feed 1, Feed 2 (135.00 g of vinyl acetate) were started and dosed to the stirred vessel with a variable feed rate of Feed 1 (0:00 h to 00:10 h: 11.8 g/h and 00:10 h to 06:10 h: 5.55 g/h) and a constant feed rate of Feed 2 (00:10 h to 06:10 h: 22.5 g/h). Upon completion of Feed 1 and Feed 2, Feed 3 (2.39 g of tert-Butyl peroxy-2-ethylhexanoate dissolved in 8.74 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 721 g of a polymer solution.

### Example 8 (Inv. 8)

### Example 8 a: Polyethylene Glycol (Molecular Weight 600 g/Mol), Ethoxylated with 47.2 Moles Ethylene Oxide

In a 2 l autoclave 222.5 g polyethylene glycol (molecular weight 600 g/mol) and 2.0 g potassium tert. butoxide were placed and the mixture was heated to 80° C. The vessel was purged three times with nitrogen and the mixture was heated to 130° C. 770.0 g ethylene oxide was added within 10 hours. To complete the reaction, the mixture was allowed to post-react for additional 5 hours at 140° C. The reaction mixture was stripped with nitrogen and volatile compounds were removed in vacuo at 80° C. After filtration 990.0 g of a light brown solid was obtained (hydroxy value. 45.8 mgKOH/g).

### Example 8 b (Backbone F): Polyethylene Glycol (Molecular Weight 600 g/Mol), Ethoxylated with 47.2 Moles Ethylene Oxide and Modified with 10 Moles Caprolactone

In a 4-neck vessel with thermometer, reflux condenser, nitrogen inlet, dropping funnel, and stirrer, 617.9 g polyethylene glycol (molecular weight 600 g/mol), ethoxylated with 47.2 moles ethylene oxide (example 8a) and 0.9 g tin(II) ethylhexanoate were placed and heated to 80° C. 288.8 g epsilon-caprolactone was added within 15 minutes. The reaction mixture was heated to 160° C. and stirred for 12 hours at 160° C. under nitrogen. After cooling to room temperature, 900.0 g of an orange oil was obtained. ¹H-NMR in CDCl3 indicated 99.0% conversion of caprolactone.

### Example 8 c (Graft Polymer)

A polymerization vessel equipped with stirrer and reflux condenser was initially charged with Backbone F (397.29 g) under nitrogen atmosphere and heated to 90° C. Feed 1 (3.16 g of tert-Butyl peroxy-2-ethylhexanoate dissolved in 35.56 g of propane-1,2-diol) and 10 min upon the start of Feed 1, Feed 2 (238.37 g of vinyl acetate) and Feed 3 (158.92 g of N-Vinylpyrrolidone) were started simultaneously and dosed to the stirred vessel with a variable feed rate of Feed 1 (0:00 h to 00:10 h: 12.9 g/h and 00:10 h to 06:10 h: 6.09 g/h) and a constant feed rate of Feed 2 (00:10 h to 06:10 h: 39.7 g/h) and Feed 3 (00:10 h to 06:10 h: 26.5 g/h). Upon completion of Feed 1, Feed 2 and Feed 3, Feed 4 (2.03 g of tert-Butyl peroxy-2-ethylhexanoate dissolved in 22.80 g of propane-1,2-diol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 721 g of a polymer solution.

### Example 9 (Inv. 9)

A polymerization vessel equipped with stirrer and reflux condenser was initially charged with Backbone F (50.00 g) under nitrogen atmosphere and heated to 90° C. Feed 1 (1.12 g of tert-Butyl peroxy-2-ethylhexanoate dissolved in 4.10 g of tripropylene glycol) and 10 min upon the start of Feed 1, Feed 2 (50.00 g of vinyl acetate) were started and dosed to the stirred vessel with a variable feed rate of Feed 1 (0:00 h to 00:10 h: 1.74 g/h and 00:10 h to 06:10 h: 0.82 g/h) and a constant feed rate of Feed 2 (00:10 h to 06:10 h: 8.33 g/h). Upon completion of Feed 1 and Feed 2, Feed 3 (0.35 g of tert-Butyl peroxy-2-ethylhexanoate dissolved in 1.30 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 107 g of a polymer solution

### Example 10 (Inv. 10)

### Example 10 a

polyethylene glycol (molecular weight 600 g/mol), ethoxylated with 47.2 moles ethylene oxide and modified with 3 moles caprolactone) (Backbone G) In a 4-neck vessel with thermometer, reflux condenser, nitrogen inlet, dropping funnel, and stirrer, 669.8 g polyethylene glycol (molecular weight 600 g/mol), ethoxylated with 47.2 moles ethylene oxide (example 8a) and 0.8 g tin(II) ethylhexanoate were placed and heated to 80° C.

85.6 g epsilon-caprolactone was added within 15 minutes. The reaction mixture was heated to 160° C. and stirred for 12 hours at 160° C. under nitrogen. After cooling to room temperature, 746.0 g of an orange solid was obtained. 1H-NMR in CDCl3 indicated 98.0% conversion of caprolactone.

### Example 10 b (Graft Polymer)

A polymerization vessel equipped with stirrer and reflux condenser was initially charged with Backbone G (75.00 g) under nitrogen atmosphere and heated to 90° C. Feed 1 (1.68 g of tert-Butyl peroxy-2-ethylhexanoate dissolved in 6.15 g of tripropylene glycol) and 10 min upon the start of Feed 1, Feed 2 (75.00 g of vinyl acetate) were started and dosed to the stirred vessel with a variable feed rate of Feed 1 (0:00 h to 00:10 h: 2.61 g/h and 00:10 h to 06:10 h: 1.23 g/h) and a constant feed rate of Feed 2 (00:10 h to 06:10 h: 12.50 g/h). Upon completion of Feed 1 and Feed 2, Feed 3 (0.53 g of tert-Butyl peroxy-2-ethylhexanoate dissolved in 1.94 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 160 g of a polymer solution

### Example 11 (Inv. 11)

A polymerization vessel equipped with stirrer and reflux condenser was initially charged with Backbone G (97.50 g) under nitrogen atmosphere and heated to 90° C. Feed 1 (0.60 g of tert-Butyl peroxy-2-ethylhexanoate dissolved in 6.92 g of propane-1,2-diol) and 10 min upon the start of Feed 1, Feed 2 (30.00 g of vinyl acetate) and Feed 3 (22.50 g of N-Vinylpyrrolidone) were started simultaneously and dosed to the stirred vessel with a variable feed rate of Feed 1 (0:00 h to 00:10 h: 2.51 g/h and 00:10 h to 06:10 h: 3.75 g/h) and a constant feed rate of Feed 2 (00:10 h to 06:10 h: 5.00 g/h) and Feed 3 (00:10 h to 06:10 h: 3.75 g/h). Upon completion of Feed 1, Feed 2 and Feed 3, Feed 4 (0.38 g of tert-Butyl peroxy-2-ethylhexanoate dissolved in 4.44 g of propane-1,2-diol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 162 g of polymer a solution.

### Example 12 (Inv. 12)

### Example 12 a: Neopentylglycol, Modified with 8 Moles Caprolactone

In a 4-neck vessel with thermometer, reflux condenser, nitrogen inlet, dropping funnel, and stirrer, 104.1 g neopentyl glycol and 1.0 g tin(II) ethylhexanoate were placed and heated to 140° C. 913.0 g epsilon-caprolactone was added within 15 minutes. The reaction mixture was heated to 160° C. to 205° C. and stirred for 4 hours at 160° C. under nitrogen. After cooling to room temperature, 971.0 g of an light yellow oil was obtained. 1H-NMR in CDCl3 indicated 99.0% conversion of caprolactone.

### Example 12 b: Neopentylglycol, Modified with 8 Moles Caprolactone and Ethoxylated with 46 Moles Ethylene Oxide) (Backbone H)

In a 2 l autoclave 356.1 g neopentylglycol, modified with 8 moles caprolactone (example 12 a) and 2.01 g potassium tert. butoxide were placed and the mixture was heated to 80° C. The vessel was purged three times with nitrogen and the mixture was heated to 140° C. 709.2 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. 1.1 g acetic acid was added. After filtration 1060.0 g of a light brown solid was obtained. 1H-NMR in CDCl3 confirmed the expected structure.

### Example 12 c (Graft Polymer)

A polymerization vessel equipped with stirrer and reflux condenser was initially charged with Backbone H (79.80 g) under nitrogen atmosphere and heated to 90° C. Feed 1 (1.49 g of tert-Butyl peroxy-2-ethylhexanoate dissolved in 13.17 g of tripropylene glycol) and 10 min upon the start of Feed 1, Feed 2 (53.20 g of vinyl acetate) were started and dosed to the stirred vessel with a variable feed rate of Feed 1 (0:00 h to 00:10 h: 4.89 g/h and 00:10 h to 06:10 h: 0.23 g/h) and a constant feed rate of Feed 2 (00:10 h to 06:10 h: 8.87 g/h). Upon completion of Feed 1 and Feed 2, Feed 3 (0.34 g of tert-Butyl peroxy-2-ethylhexanoate dissolved in 2.99 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 150 g of a polymer solution

### Example 13 (Inv. 13)

### Example 13 a: Neopentylglycol, Modified with 8 Moles Caprolactone and Alkoxylated with a Mixture of 40 Moles Ethylene Oxide and 4 Moles Propylene Oxide (Backbone I)

In a 2 l autoclave 300.0 g neopentylglycol, modified with 8 moles caprolactone (example 12 a) and 1.8 g potassium tert. butoxide were placed and the mixture was heated to 80° C. The vessel was purged three times with nitrogen and the mixture was heated to 140° C. A mixture of 519.6 g ethylene oxide and 68.5 g propylene oxide was added within 14 hours. To complete the reaction, the mixture was allowed to post-react for additional 5 hours at 140° C. The reaction mixture was stripped with nitrogen and volatile compounds were removed in vacuo at 80° C. 0.9 g acetic acid was added. After filtration 880.0 g of a light brown oil was obtained. 1H-NMR in CDCl3 confirmed the expected structure.

### Example 13 b (Graft Polymer)

A polymerization vessel equipped with stirrer and reflux condenser was initially charged with Backbone I (78.00 g) under nitrogen atmosphere and heated to 90° C. Feed 1 (1.35 g of tert-Butyl peroxy-2-ethylhexanoate dissolved in 11.88 g of tripropylene glycol) and 10 min upon the start of Feed 1, Feed 2 (42.00 g of vinyl acetate) were started and dosed to the stirred vessel with a variable feed rate of Feed 1 (0:00 h to 00:10 h: 4.41 g/h and 00:10 h to 06:10 h: 0.23 g/h) and a constant feed rate of Feed 2 (00:10 h to 06:10 h: 7.09 g/h). Upon completion of Feed 1 and Feed 2, Feed 3 (0.31 g of tert-Butyl peroxy-2-ethylhexanoate dissolved in 2.70 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 136 g of a polymer solution

### Example 14 (Inv. 14)

A polymerization vessel equipped with stirrer and reflux condenser was initially charged with Backbone I (97.50 g) under nitrogen atmosphere and heated to 90° C. Feed 1 (1.22 g of tert-Butyl peroxy-2-ethylhexanoate dissolved in 12.33 g of propane-1,2-diol) and 10 min upon the start of Feed 1, Feed 2 (45.00 g of vinyl acetate) and Feed 3 (7.50 g of N-Vinylpyrrolidone) were started simultaneously and dosed to the stirred vessel with a variable feed rate of Feed 1 (0:00 h to 00:10 h: 4.49 g/h and 00:10 h to 06:10 h: 1.25 g/h) and a constant feed rate of Feed 2 (00:10 h to 06:10 h: 7.50 g/h) and Feed 3 (00:10 h to 06:10 h: 1.25 g/h). Upon completion of Feed 1, Feed 2 and Feed 3, Feed 4 (0.38 g of tert-Butyl peroxy-2-ethylhexanoate dissolved in 3.80 g of propane-1,2-diol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 165 g of a polymer solution.

### Example 15 (Inv. 15)

A polymerization vessel equipped with stirrer and reflux condenser was initially charged with Backbone I (97.50 g) under nitrogen atmosphere and heated to 90° C. Feed 1 (1.22 g of tert-Butyl peroxy-2-ethylhexanoate dissolved in 12.33 g of propane-1,2-diol) and 10 min upon the start of Feed 1, Feed 2 (37.50 g of vinyl acetate) and Feed 3 (15.00 g of N-Vinylpyrrolidone) were started simultaneously and dosed to the stirred vessel with a variable feed rate of Feed 1 (0:00 h to 00:10 h: 4.49 g/h and 00:10 h to 06:10 h: 2.12 g/h) and a constant feed rate of Feed 2 (00:10 h to 06:10 h: 6.25 g/h) and Feed 3 (00:10 h to 06:10 h: 2.50 g/h). Upon completion of Feed 1, Feed 2 and Feed 3, Feed 4 (0.38 g of tert-Butyl peroxy-2-ethylhexanoate dissolved in 3.80 g of propane-1,2-diol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 167 g of a polymer solution.

### Example 16 (Inv. 16)

A polymerization vessel equipped with stirrer and reflux condenser was initially charged with Backbone I (97.50 g) under nitrogen atmosphere and heated to 90° C. Feed 1 (1.22 g of tert-Butyl peroxy-2-ethylhexanoate dissolved in 12.33 g of propane-1,2-diol) and 10 min upon the start of Feed 1, Feed 2 (30.00 g of vinyl acetate) and Feed 3 (22.50 g of N-Vinylpyrrolidone) were started simultaneously and dosed to the stirred vessel with a variable feed rate of Feed 1 (0:00 h to 00:10 h: 4.49 g/h and 00:10 h to 06:10 h: 2.12 g/h) and a constant feed rate of Feed 2 (00:10 h to 06:10 h: 5.00 g/h) and Feed 3 (00:10 h to 06:10 h: 3.75 g/h). Upon completion of Feed 1, Feed 2 and Feed 3, Feed 4 (0.38 g of tert-Butyl peroxy-2-ethylhexanoate dissolved in 3.80 g of propane-1,2-diol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 165 g of a polymer solution.

### Example 17 (Inv. 17)

### Example 17 a: Neopentylglycol, Modified with 2 Moles Caprolactone

In a 4-neck vessel with thermometer, reflux condenser, nitrogen inlet, dropping funnel, and stirrer, 156.2 g neopentyl glycol and 0.5 g tin(II) ethylhexanoate were placed and heated to 140° C. 342.4 g epsilon-caprolactone was added within 15 minutes. The reaction mixture was heated to 160° C. and stirred for 2 hours at 160° C. under nitrogen. After cooling to room temperature, 477.0 g of a light yellow oil was obtained. 1H-NMR in CDCl3 indicated 99.0% conversion of caprolactone.

### Example 17 b: Neopentylglycol, Modified with 2 Moles Caprolactone and Ethoxylated with 40 Moles Ethylene Oxide (Backbone J)

In a 2 l autoclave 149.6 g neopentylglycol, modified with 2 moles caprolactone (example 17 a) and 1.9 g potassium tert. butoxide were placed and the mixture was heated to 80° C. The vessel was purged three times with nitrogen and the mixture was heated to 140° C. 792.0 g ethylene oxide was added within 14 hours. To complete the reaction, the mixture was allowed to post-react for additional 5 hours at 140° C. The reaction mixture was stripped with nitrogen and volatile compounds were removed in vacuo at 80° C. 1.0 g acetic acid was added. After filtration 940.0 g of a light brown oil was obtained. 1H-NMR in CDCl3 confirmed the expected structure.

### Example 17 c (Graft Polymer)

A polymerization vessel equipped with stirrer and reflux condenser was initially charged with Backbone J (97.50 g) under nitrogen atmosphere and heated to 90° C. Feed 1 (1.68 g of tert-Butyl peroxy-2-ethylhexanoate dissolved in 6.15 g of tripropylene glycol) and 10 min upon the start of Feed 1, Feed 2 (37.50 g of vinyl acetate) and Feed 3 (15.00 g of Vinyl laurate) were started simultaneously and dosed to the stirred vessel with a variable feed rate of Feed 1 (0:00 h to 00:10 h: 2.61 g/h and 00:10 h to 06:10 h: 1.23 g/h) and a constant feed rate of Feed 2 (00:10 h to 06:10 h: 6.25 g/h) and Feed 3 (00:10 h to 06:10 h: 2.50 g/h). Upon completion of Feed 1, Feed 2 and Feed 3, Feed 4 (0.54 g of tert-Butyl peroxy-2-ethylhexanoate dissolved in 1.96 g of tripropylene glycol) was dosed within 0:56 h with constant feed rate at 90° C. The mixture was stirred for 1:00 h at 90° C. upon complete addition of the feed. The polymerization mixture was heated to 95° C. and a vacuum of 500 mbar was applied to remove the volatiles. The yield was 159 g of a polymer solution.

### Example 18 (Inv. 18)

A polymerization vessel equipped with stirrer and reflux condenser was initially charged with Example 8 c (110.00 g) under nitrogen atmosphere and heated to 80° C. Water (49.86 g) was added and Feed 1 (aqueous sodium hydroxide, 50%, 11.50 g) was started with a constant feed rate within 1:00 h. After the addition was completed, the mixture was stirred at 80° C. for 1 h to yield 250 g of a polymer solution.

### Example 19 (Inv. 19)

### Example 19 a: Polyethylene Glycol (Molecular Weight 1500 g/Mol), Modified with 6 Moles Caprolactone (Backbone B)

In a 4-neck vessel with thermometer, reflux condenser, nitrogen inlet, dropping funnel, and stirrer, 750.0 g polyethylene glycol (molecular weight 1500 g/mol), and 1.1 g tin(II) ethylhexanoate were placed and heated to 90° C.

342.4 g epsilon-caprolactone was added within 15 minutes. The reaction mixture was heated to 155° C. and stirred for 11 hours at 155° C. under nitrogen. After cooling to room temperature, 1100.0 g of an orange oil was obtained. 1H-NMR in CDCl3 indicated 97.5% conversion of caprolactone

### Example 19 b (Graft Polymer)

A polymerization vessel equipped with stirrer and reflux condenser was initially charged with Backbone B (480.0 g) under nitrogen atmosphere and heated to 90° C. Feed 1 (2.97 g of tert-Butyl peroxy-2-ethylhexanoate dissolved in 26.1 g of propane-1,2-diol) and 10 min upon the start of Feed 1, Feed 2 (258.5 g of vinyl acetate) were started simultaneously and dosed to the stirred vessel with a variable feed rate of Feed 1 (0:00 h to 00:10 h: 9.70 g/h and 00:10 h to 06:10 h: 4.58 g/h) and a constant feed rate of Feed 2 (00:10 h to 06:10 h: 43.08 g/h). Upon completion of Feed 1 and Feed 2, Feed 3 (1.88 g of tert-Butyl peroxy-2-ethylhexanoate dissolved in 16.6 g of propane-1,2-diol) was dosed within 0:56 h with constant feed rate at 90° C. The mixture was stirred for 1 h at 90° C. upon complete addition of the feed. The polymerization mixture was heated to 95° C. and a vacuum of 500 mbar was applied to remove the volatiles. The yield was 781 g of a polymer solution.

### Example 20 (Inv. 20)

### Example 20 a: Polyethylene Glycol (Molecular Weight 400 g/Mol), Modified with 6 Moles Caprolactone and 70 Moles Ethylene Oxide (Backbone K)

In a 2 l autoclave 150 g polyethylene glycol (molecular weight 400 g/mol), and 2.7 g potassium tert. butoxide were placed and the mixture was heated to 80° C. The vessel was purged three times with nitrogen and the mixture was heated to 140° C. A mixture of 977.5 g ethylene oxide and 217.1 g caprolactone was added within 15 hours. To complete the reaction, the mixture was allowed to post-react for additional 5 hours at 140° C. The reaction mixture was stripped with nitrogen and volatile compounds were removed in vacuo at 80° C. After filtration 1340.0 g of a light brown solid was obtained. 1H-NMR in CDCl3 confirmed the expected structure.

### Example 20 b (Graft Polymer)

A polymerization vessel equipped with stirrer and reflux condenser was initially charged with Backbone K (350.0 g) under nitrogen atmosphere and heated to 90° C. Feed 1 (4.02 g of tert-Butyl peroxy-2-ethylhexanoate dissolved in 33.0 g of propane-1,2-diol) and 10 min upon the start of Feed 1, Feed 2 (650.0 g of vinyl acetate) were started simultaneously and dosed to the stirred vessel with a variable feed rate of Feed 1 (0:00 h to 00:10 h: 12.4 g/h and 00:10 h to 06:10 h: 5.83 g/h) and a constant feed rate of Feed 2 (00:10 h to 06:10 h: 108.3 g/h). Upon completion of Feed 1 and Feed 2, Feed 3 (2.55 g of tert-Butyl peroxy-2-ethylhexanoate dissolved in 21.0 g of propane-1,2-diol) was dosed within 0:56 h with constant feed rate at 90° C. The mixture was stirred for 1 h at 90° C. upon complete addition of the feed. The polymerization mixture was heated to 95° C. and a vacuum of 500 mbar was applied to remove the volatiles. The yield was 1059 g of a polymer solution.

### Example 21 (Inv. 21)

A polymerization vessel equipped with stirrer and reflux condenser was initially charged with Backbone K (550.0 g) under nitrogen atmosphere and heated to 90° C. Feed 1 (3.40 g of tert-Butyl peroxy-2-ethylhexanoate dissolved in 30.0 g of propane-1,2-diol) and 10 min upon the start of Feed 1, Feed 2 (296.2 g of vinyl acetate) were started simultaneously and dosed to the stirred vessel with a variable feed rate of Feed 1 (0:00 h to 00:10 h: 11.1 g/h and 00:10 h to 06:10 h: 5.25 g/h) and a constant feed rate of Feed 2 (00:10 h to 06:10 h: 49.4 g/h). Upon completion of Feed 1 and Feed 2, Feed 3 (2.55 g of tert-Butyl peroxy-2-ethylhexanoate dissolved in 21.0 g of propane-1,2-diol) was dosed within 0:56 h with constant feed rate at 90° C. The mixture was stirred for 1 h at 90° C. upon complete addition of the feed. The polymerization mixture was heated to 95° C. and a vacuum of 500 mbar was applied to remove the volatiles. The yield was 899 g of a polymer solution.

### SYNTHESIS OF COMP. EX.

### Synthesis of Comp. Ex. I

The polymer was prepared as described in WO2021/160795, following “Procedure for comparative example 1: graft polymerization of vinyl acetate on polyethylene glycol)-(Comp. Ex. 1)” but with adjusted amounts of PEG (60 instead of 40) versus VAc (40% instead of 60).

### Synthesis of Comp. Ex. II

The polymer was prepared as described in US 2019/0390142 A1 Example 1K.

### Synthesis of Comp. Ex. III

The polymer was prepared as described in un-published patent application PCT/EP2022/072416 Example 44.

### Synthesis of Comp. Ex. IV

The polymer was prepared as described in un-published patent application PCT/EP2022/072402 Example 13.

### Synthesis of Comp. Ex. V

The polymer was prepared as described in un-published patent application PCT/EP2022/072402 Example 12.

### Synthesis of Comp. Ex. VI

The polymer was prepared as described in un-published patent application PCT/EP2022/072416 Example 18.

### Synthesis of Comp. Ex. VII

The polymer was prepared as described in un-published patent application PCT/EP2022/072416, Example 19. To reduce the viscosity of the polymer, 15 wt % Lutensol XL 100 (alcohol ethoxylate, BASF product) and 10 wt % demineralized water were added after the polymerization reaction.

### Synthesis of Comp. Ex. VIII: (Following the Disclosure of Unpublished Patent Application PCT/EP2022/065983, i.e. Now Published as WO 2022/263354)

Comp. Ex. VIII based on PEG ester backbone was synthesized via the following steps.

### Step 1: Oxidation of PEG

Polyalkylene oxides with two primary OH end groups (called “diol”) were oxidized to mixtures containing at least a polyalkylene oxide with two COOH end groups (called “diacid”) and a polyalkylene oxide with one primary OH and one COOH end group (called “monoacid”), and, optionally, also remaining polyalkylene oxide with two primary OH end groups. The mixtures were prepared as follows.

Platinum on charcoal (5.0 wt.-% Pt on C, water content: 59.7 wt.-%, 283 g, 29.2 mmol Pt) was suspended in a mixture of polyalkylene oxide comprising two primary OH end groups (details see table 1) and water (details see Table 2), heated to 52° C. and stirred at 800 rpm. Oxygen was passed through the stirred mixture (20 nL/h) via a glass tube, equipped with a glass frit and the temperature was allowed to rise to 60° C. Oxygen dosage and temperature were maintained for the period mentioned in table 1, the oxygen dosage was then stopped and the mixture was allowed to cool down to room temperature. Solids were separated from the liquid phase by filtration and the filter cake was washed with 500 mL of warm water. The washing water was mixed with the filtrate. Water was removed from the liquid mixture by distillation over a wiped film evaporator (overall height: 87.2 cm, diameter: 3.54 cm, wiped height: 43 cm, feed: 4.0 mL/min, 44° C., 1.8 kPa abs, 600 rpm) . . .

TABLE 2
Polymer backbone-
Oxidation of PEG

| Descriptor of oxidized PEG | A1 | A2 |
|---|---|---|
| Typ^{#1} and molecular average molecular weight M_{w} | EO, 600 | EO, 600 |
| [g/mol] of polyalkylene oxide | | |
| Number average of number of ether groups | 12 | 12 |
| Amount of polyalkylene oxide [g] | 1500 | 1750 |
| Amount of water [g] | 3500 | 4083 |
| Oxidation time [h] | 72 | 8 |
| Ratio of oxidized OH groups [%]^{#2} | >99^{#2} | 51^{#2} |
| Acid number [mg KOH/g] | 55 | 28 |
| Physical property | solid | solid |

Annotation to Table 2:
^{#1}EO = polyethylene oxide
^{#2}Calculated on basis of acid number of the reaction solution

### Step 2: Esterification

A mixture of polyalkylene oxides (see table 2) obtained by the oxidation of the diol (see table 1) and the esterification catalyst (see table 2) were mixed and heated for a period of time mentioned in Table 3 under vacuum at a pressure of 1 kPa abs at a temperature of 135° C.

TABLE 3
Esterification to PEG-Ester

| Polymer backbone descriptor | B1 |
|---|---|
| Educt | A1 (76.0 g) + A2 (1100 g) |
| Esterification catalyst ^{#1} | 0.83 wt.-%; TIB Kat 620^{#2} |
| Reaction time [h] | 72 |
| K-value^{#2} | 20.2 |

Annotation to Polymer backbone-Table 3:
^{#1} cat = Zn-octanoate
^{#2}K-value measures the relative viscosity of dilute polymer solutions and is a relative measure of the average molecular weight. As the average molecular weight of the polymer increases for a particular polymer, the K-value tends to also increase. The K-value is determined in a 3% by weight NaCl solution at 23° C. and a polymer concentration of 1% polymer according to the method of H. Fikentscher in “Cellulosechemie”, 1932, 13, 58.

### Step 3: Synthesis of Comparative Graft Polymer Comp. Ex. VIII

The polymer backbone B1 (350.0 g) is dosed in a vessel equipped with a stainless-steel anchor stirrer (and 2 other necks) and heated to 95° C. 1.00 g of a 14 wt % solution of t-butylperoxy-2-ethylhexanoate in tripropylene glycol was added within 1 min. Afterwards, the dosage of vinyl-acetate (350.0 g) was started and continued over 7.5 h with constant feed rate. At the same time the Initiator solution (50.0 g) t-butylperoxy-2-ethylhexanoate was dosed as a 14 wt % solution in tripropylene glycol with a constant feed rate within 8.5 h. For completion of the reaction, the mixture is stirred for another 180 minutes. Finally, volatile components were stripped for 90 minutes at 120° C. with nitrogen at a feed rate of 6 L N₂/h.

### Polymer Biodegradability

Polymer Biodegradation in wastewater was tested in triplicate using the OECD 301F manometric respirometry method. 30 mg/mL test substance is inoculated into wastewater taken from Mannheim Wastewater Treatment Plant and incubated in a closed flask at 25° C. for 28 days. The consumption of oxygen during this time is measured as the change in pressure inside the flask using an OxiTop C (WTW). Evolved CO₂ is absorbed using an NaOH solution. The amount of oxygen consumed by the microbial population during biodegradation of the test substance, after correction using a blank, is expressed as a % of the ThOD (Theoretical Oxygen Demand).

TABLE 4
biodegradation data of comparative and inventive
polymers at 28 day of the OECD 301F.

| | Backbone | | | Graft | | |
|---|---|---|---|---|---|---|
| Polymer | Type | Mn | Wt % | Type | Wt % | Biodeg (%) |
| Comp. Ex. I | PEG | 6000 | 60 | VAc | 40 | 28 |
| Comp. Ex. II | PEG | 6000 | 50 | VAc / VP | 30*/20 | 15 |
| Comp. Ex. III | PO-EO-PO | 2900 | 60 | VAc | 40 | 38 |
| | triblock | | | | | |
| | (40% EO) | | | | | |
| Comp. Ex. IV | PO-EO random | 4100 | 80 | VAc | 20 | 33 |
| | (60% EO) | | | | | |
| Comp. Ex. V | PO-EO random | 3000 | 60 | VAc | 40 | 34 |
| | (60% EO) | | | | | |
| Comp. | PO-EO-PO | 2900 | 80 | VAc | 20 | 50 |
| VI | triblock | | | | | |
| | (40% EO) | | | | | |
| Comp. Ex. | 100% EO | 6000 | 40 | VAc | 60 | 36 |
| VII | | | | | | |
| Comp. Ex. | PAG-Ester B1 | — | 50 | VAc | 50 | 61 |
| VIII | | | | | | |

| | Backbone | | | | | |
|---|---|---|---|---|---|---|
| | | Molecular | | | | |
| | | weight | | Graft | | |
| Polymer | Type | g/mol | Wt % | Type | Wt % | Biodeg (%) |
| Inv. 1 | A | 4168 | 65 | VAc | 35 | 70 |
| Inv. 2 | A | 4168 | 50 | VAc | 50 | 62 |
| Inv. 3 | C | 5590 | 65 | VAc | 35 | 67 |
| Inv. 4 | C | 5590 | 40 | VAc | 60 | 49 |
| Inv. 5 | D | 4165 | 65 | VAc | 35 | 54 |
| Inv. 6 | D | 4165 | 70 | VAc / VL | 25 / 5 | 45 |
| Inv. 7 | E | 1842 | 80 | VAc | 20 | 68 |
| Inv. 8 | F | 3842 | 50 | VAc / VP | 30 / 20 | 58 |
| Inv. 9 | F | 3842 | 50 | VAc | 50 | |
| Inv. 10 | G | 3000 | 50 | VAc | 50 | 51 |
| Inv. 11 | G | 3000 | 65 | VAc / VP | 20 / 15 | 58 |
| Inv. 12 | H | 3040 | 60 | VAc | 40 | 51 |
| Inv. 13 | I | 3009 | 65 | VAc | 35 | 75 |
| Inv. 14 | I | 3009 | 65 | VAc / VP | 30 / 5 | 66 |
| Inv. 15 | I | 3009 | 65 | VAc / VP | 25 / 10 | 67 |
| Inv. 16 | I | 3009 | 65 | VAc / VP | 20 / 15 | 62 |
| Inv. 17 | J | 2092 | 65 | VAc / Vlau | 25 / 10 | 57 |
| Inv. 18 | F | 3842 | 50 | VAc* / VP | 30 / 20 | |
| Inv. 19 | B | 2178 | 65 | VAc | 35 | 60 |
| Inv. 20 | K | 4241 | 35 | VAc | 65 | 38 |
| Inv. 21 | K | 4241 | 65 | VAc | 35 | 51 |

(date for Inv. 1 to 21: repetition from table 1 for better comparison)

As shown in Table 4, inventive graft polymers show at least comparable percentage of biodegradation at 28 day of the OECD 301F test.

Stability of Inventive Graft Polymer 5 (Inv. 5) Vs Comp. Ex. VIII

Aqueous solutions of the inventive graft polymer 5 (Inv. 5) and comparative polymer 1 (9 wt %) were prepared and the mixtures were stored at 54° C. for two weeks.

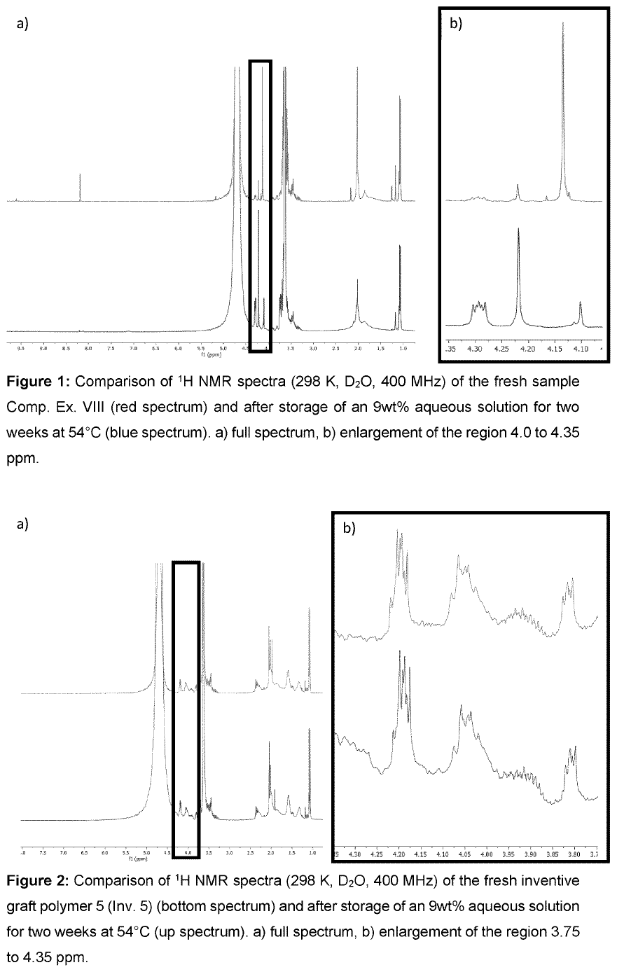

A brown precipitate was formed during storage of the Comp. Ex. VIII. Recorded 1H NMR (298 K, D2O, 400 MHz) spectra of the precipitate and the solution showed no differences. The comparison of the 1H NMR spectra of the fresh and the stored sample of comparative graft polymer showed significant rearrangements of the 1H NMR shifts in the regions of 4.0 to 4.35 ppm (typical for PEG-Ester bonds) and 1.8 to 2.2 ppm (typical for bound/non bound acetate) as shown in FIG. 1.

The comparison of 1H NMR spectra (298 K, D₂O, 400 MHz) of the fresh and the stored samples of inventive graft polymer (Inv. 5) showed no significant rearrangements in the spectra as shown in FIG. 2.

The results clearly demonstrate better hydrolysis instability from inventive polymers.

### Agrochemical Formulations

All references to fully demineralized water refer to water which was fully demineralized and additionally purified by ion exchange, having a pH value of about 5.5.

### Preparation

Suspension concentrates were prepared by grinding 40 wt.-% of solids (w.s.) active ingredient, 5% w.s. dispersant, 0.3% w.s. Agnique DFM 111 S (silicon emulsion defoamer) with fully demineralized water in a disperser “DAS 200”, Lau GmbH with glass balls (diameter: 2 or 3 mm) such that the dispersed pesticide particles reached a particle size distribution characterized by a D90 of ≤10 μm and a D50≤3 μm and a D10≤1 μm. Particle analysis was done according to method (I). Storage stability was assessed as described in method (II). Blooming and suspensibility were determined according to method (III) and (IV). The specific components and experimental results are shown in the tables below.

### Method (I): Particle Size Analysis According to CIPAC MT 187

Approximately 1.0 mL of the sample (suspension) was slightly shaken into 9 mL of fully demineralized water. This diluted sample was added dropwise to a Malvern Master Sizer Dispersing Unit (Hydro MV) until a laser shadowing of 6% (+/−1.5%) was reached. Within the dispersing unit, the sample was diluted in 120 mL of fully demineralized water and pumped through the measuring cell of the Malvern Mastersizer 3000 (Malvern Pananalytical GmbH, Germany) that used a 632.8 nm laser (4 mW He—Ne) for analysis. The sample and the fully demineralized water used for the dilution were at room temperature. Particle size distribution, including D10, D50 and D90 values, was calculated using the Fraunhofer model as known in the art. See, e.g., ISO 13320-1:1999 (E).

### Method (II): Accelerated Storage Test According to CIPAC MT 46.3

About 10 ml of the sample (suspension) were placed in a 40 mL Penicillin glass bottle fitted with screw cap and polyethylene inserts and kept in a temperature-controlled cabinet at the specified temperatures (+/−2° C.) for the defined period of time. In the swing tests indicated as “−10/+40° C.” below, the temperature was switched between −10° C. and 40° C. every 12 h. After the defined period of time, the bottle was removed from the oven and allowed to reach room temperature before further analysis.

### Method (III): Blooming

95 mL of CIPAC water D were filled into a 100 mL measuring cylinder. Then 4 drops of the suspension concentrate were added and the distribution was evaluated: 1: homogeneous, 3: cylinder completely filled, but not completely homogeneous (<20%), 5: SC does not distribute, remains either at the top or at the bottom, 2 & 4 is accordingly in between.

### Method (IV): Suspensibility According to CIPAC MT 161

The filled measuring cylinder from Method Ill was taken and more suspension concentrate was added until the cylinder comprised 5 g thereof. Subsequently, the cylinder content was homogenized by ten times 180° inversion, and allowed to stand for 30 min. Next, the top nine-tenths of the content were removed and the remaining tenth was then dried (ca. 50° C./500 mbar), assayed gravimetrically, and the suspensibility was calculated according to the following method:

$$1 - ( wt . solids / wt . water in sample composition ) = \% wt . by solids \qquad Calculation 1$$

$$[ ( Starting sample weight ) \times ( value of calculation 1 , as decimal ) ] = grams of dispersible solids \qquad Calculation 2$$

$$( 1 - ( \frac{weight of filled cylinder ( g ) - weight of empty cylinder ( g )}{( value of Calculation 2 ) - ( 0.1 \times value of Calculation 2 )} ) ) \times 100 = Suspensibility ( \% ) \qquad Calculation 3$$

### Azoxystrobin

### Comparable Examples

5% w.s. dispersant

| | | μm |
|---|---|---|
| Comp. Ex. II | | |
| start | D10 | 0.63 |
| | D50 | 1.39 |
| | D90 | 3.29 |
| rt, 14 d | D10 | 0.59 |
| | D50 | 1.16 |
| | D90 | 2.28 |
| −10/+40° C., 14 d | D10 | 1.09 |
| | D50 | 50.1 |
| | D90 | 221 |
| 54° C., 14 d | D10 | 0.71 |
| | D50 | 1.83 |
| | D90 | 4.62 |
| Comp. Ex. VII | | |
| start | D10 | 0.65 |
| | D50 | 1.39 |
| | D90 | 2.90 |
| rt, 14 d | D10 | 0.64 |
| | D50 | 1.35 |
| | D90 | 2.83 |
| −10/+40° C., 14 d | D10 | 0.66 |
| | D50 | 1.5 |
| | D90 | 3.07 |
| 54° C., 14 d | D10 | 0.64 |
| | D50 | 1.43 |
| | D90 | 3.03 |
| Comp. Ex. V | | |
| start | D10 | 0.66 |
| | D50 | 1.31 |
| | D90 | 2.67 |
| rt, 14 d | D10 | 0.67 |
| | D50 | 1.34 |
| | D90 | 2.69 |
| −10/+40° C., 14 d | D10 | 0.66 |
| | D50 | 1.44 |
| | D90 | 3.29 |
| 54° C., 14 d | D10 | 0.74 |
| | D50 | 2.43 |
| | D90 | 7.01 |
| Comp. Ex. VI | | |
| start | D10 | no data - thickened |
| | D50 | no data - thickened |
| | D90 | no data - thickened |
| rt, 14 d | D10 | no data - thickened |
| | D50 | no data - thickened |
| | D90 | no data - thickened |
| −10/+40° C., 14 d | D10 | no data - thickened |
| | D50 | no data - thickened |
| | D90 | no data - thickened |
| 54° C., 14 d | D10 | no data - thickened |
| | D50 | no data - thickened |
| | D90 | no data - thickened |
| Comp. Ex. VIII | | |
| start | D10 | 0.59 |
| | D50 | 1.37 |
| | D90 | 3.28 |
| rt, 14 d | D10 | 0.57 |
| | D50 | 1.33 |
| | D90 | 3.09 |
| −10/+40° C., 14 d | D10 | 0.63 |
| | D50 | 1.69 |
| | D90 | 3.64 |
| 54° C., 14 d | D10 | 0.58 |
| | D50 | 1.33 |
| | D90 | 2.93 |

| | 5% w.s. dispersant |
|---|---|
| Comp. Ex. II | |
| start | |
| Blooming | 1.5 |
| Suspensibility after 30 min | 99.6 |
| rt, 14 d | |
| Blooming | 2 |
| Suspensibility after 30 min | 100.4 |
| −10/+40° C., 14 d | |
| Blooming | 3 |
| Suspensibility after 30 min | 28.8 |
| 54° C., 14 d | |
| Blooming | 2.5 |
| Suspensibility after 30 min | 100.8 |
| Comp. Ex. VII | |
| start | |
| Blooming | 1 |
| Suspensibility after 30 min | 99.6 |
| rt, 14 d | |
| Blooming | 2 |
| Suspensibility after 30 min | 99.5 |
| −10/+40° C., 14 d | |
| Blooming | 2.5 |
| Suspensibility after 30 min | 100.1 |
| 54° C., 14 d | |
| Blooming | 3 |
| Suspensibility after 30 min | 99.8 |
| Comp. Ex. V | |
| start | |
| Blooming | 1.5 |
| Suspensibility after 30 min | 99.7 |
| rt, 14 d | |
| Blooming | 1.5 |
| Suspensibility after 30 min | 99.9 |
| −10/+40° C., 14 d | |
| Blooming | 1.5 |
| Suspensibility after 30 min | 100.0 |
| 54° C., 14 d | |
| Blooming | 1.5 |
| Suspensibility after 30 min | 99.8 |
| Comp. Ex. VI | |
| start | |
| Blooming | no data - thickened |
| Suspensibility after 30 min | no data - thickened |
| rt, 14 d | |
| Blooming | no data - thickened |
| Suspensibility after 30 min | no data - thickened |
| −10/+40° C., 14 d | |
| Blooming | no data - thickened |
| Suspensibility after 30 min | no data - thickened |
| 54° C., 14 d | |
| Blooming | no data - thickened |
| Suspensibility after 30 min | no data - thickened |
| Comp. Ex. VIII | |
| start | |
| Blooming | 1.5 |
| Suspensibility after 30 min | 100.7 |
| rt, 14 d | |
| Blooming | 1.5 |
| Suspensibility after 30 min | 99.6 |
| −10/+40° C., 14 d | |
| Blooming | 2 |
| Suspensibility after 30 min | 99.1 |
| 54° C., 14 d | |
| Blooming | 2 |
| Suspensibility after 30 min | 100.2 |

Terbuthylazin

5% w.s. dispersant

| | | μm |
|---|---|---|
| Comp. Ex. II | | |
| start | D10 | no data - thickened |
| | D50 | no data - thickened |
| | D90 | no data - thickened |
| rt, 14 d | D10 | no data - thickened |
| | D50 | no data - thickened |
| | D90 | no data - thickened |
| −10/+40° C., 14 d | D10 | no data - thickened |
| | D50 | no data - thickened |
| | D90 | no data - thickened |
| 54° C., 14 d | D10 | no data - thickened |
| | D50 | no data - thickened |
| | D90 | no data - thickened |
| Comp. Ex. VII | | |
| start | D10 | 0.8 |
| | D50 | 1.88 |
| | D90 | 1.47 |
| rt, 14 d | D10 | 0.82 |
| | D50 | 1.91 |
| | D90 | 4.23 |
| −10/+40° C., 14 d | D10 | 0.94 |
| | D50 | 2.84 |
| | D90 | 7.7 |
| 54° C., 14 d | D10 | 0.88 |
| | D50 | 2.08 |
| | D90 | 4.71 |
| Comp. Ex. VIII | | |
| start | D10 | 0.78 |
| | D50 | 1.82 |
| | D90 | 4.89 |
| rt, 14 d | D10 | 0.78 |
| | D50 | 1.79 |
| | D90 | 4.5 |
| 54° C., 14 d | D10 | 0.82 |
| | D50 | 1.88 |
| | D90 | 4.53 |

| | |
|---|---|
| Comp. Ex. II | |
| start | |
| Blooming | no data - thickened |
| Suspensibility after 30 min | no data - thickened |
| rt, 14 d | |
| Blooming | no data - thickened |
| Suspensibility after 30 min | no data - thickened |
| −10/+40° C., 14 d | |
| Blooming | no data - thickened |
| Suspensibility after 30 min | no data - thickened |
| 54° C., 14 d | |
| Blooming | no data - thickened |
| Suspensibility after 30 min | no data - thickened |
| Comp. Ex. VII | |
| start | |
| Blooming | 3 |
| Suspensibility after 30 min | 100.1 |
| rt, 14 d | |
| Blooming | 2.5 |
| Suspensibility after 30 min | 100.0 |
| −10/+40° C., 14 d | |
| Blooming | 4 |
| Suspensibility after 30 min | 100.0 |
| 54° C., 14 d | |
| Blooming | 3 |
| Suspensibility after 30 min | 99.8 |
| Comp. Ex. VIII | |
| start | |
| Blooming | 1.5 |
| Suspensibility after 30 min | 100.4 |
| rt, 14 d | |
| Blooming | 1.5 |
| Suspensibility after 30 min | 100.4 |
| 54° C., 14 d | |
| Blooming | 1 |
| Suspensibility after 30 min | 99.2 |

Diflufenican

5% w.s. dispersant

| | | μm |
|---|---|---|
| Comp. Ex. II | | |
| start | D10 | no data - thickened |
| | D50 | no data - thickened |
| | D90 | no data - thickened |
| rt, 14 d | D10 | no data - thickened |
| | D50 | no data - thickened |
| | D90 | no data - thickened |
| −10/+40° C., 14 d | D10 | no data - thickened |
| | D50 | no data - thickened |
| | D90 | no data - thickened |
| 54° C., 14 d | D10 | no data - thickened |
| | D50 | no data - thickened |
| | D90 | no data - thickened |
| Comp. Ex. VII | | |
| start | D10 | 0.84 |
| | D50 | 2.19 |
| | D90 | 5.15 |
| rt, 14 d | D10 | 0.91 |
| | D50 | 2.99 |
| | D90 | 7.37 |
| Comp. Ex. VII | | |
| start | D10 | 0.78 |
| | D50 | 2.00 |
| | D90 | 5.33 |
| rt, 14 d | D10 | 0.75 |
| | D50 | 1.89 |
| | D90 | 4.50 |
| −10/+40° C., 14 d | D10 | 0.8 |
| | D50 | 2.37 |
| | D90 | 5.81 |
| 54° C., 14 d | D10 | 0.77 |
| | D50 | 2.15 |
| | D90 | 4.84 |

| | |
|---|---|
| Comp. Ex. II | |
| start | |
| Blooming | no data - thickened |
| Suspensibility after 30 min | no data - thickened |
| rt, 14 d | |
| Blooming | no data - thickened |
| Suspensibility after 30 min | no data - thickened |
| −10/+40° C., 14 d | |
| Blooming | no data - thickened |
| Suspensibility after 30 min | no data - thickened |
| 54° C., 14 d | |
| Blooming | no data - thickened |
| Suspensibility after 30 min | no data - thickened |
| Comp. Ex. VII | |
| start | |
| Blooming | 2.5 |
| Suspensibility after 30 min | 100.6 |
| rt, 14 d | |
| Blooming | 2.5 |
| Suspensibility after 30 min | 99.0 |
| Comp. Ex. VIII | |
| start | |
| Blooming | 1 |
| Suspensibility after 30 min | 98.8 |
| rt, 14 d | |
| Blooming | 1 |
| Suspensibility after 30 min | 98.2 |
| −10/+40° C., 14 d | |
| Blooming | 1 |
| Suspensibility after 30 min | 93.8 |
| 54° C., 14 d | |
| Blooming | 1 |
| Suspensibility after 30 min | 97.9 |

Mefentrifluconazol

5% w.s. dispersant

| | | μm |
|---|---|---|
| Comp. Ex. VII | | |
| start | D10 | 1.04 |
| | D50 | 3.38 |
| | D90 | 6.25 |
| rt, 14 d | D10 | 1.03 |
| | D50 | 3.47 |
| | D90 | 6.48 |
| −10/+40° C., 14 d | D10 | 1.01 |
| | D50 | 3.63 |
| | D90 | 6.88 |
| 54° C., 14 d | D10 | 1.04 |
| | D50 | 3.8 |
| | D90 | 7.3 |
| Comp. Ex. VIII | | |
| start | D10 | 0.65 |
| | D50 | 1.48 |
| | D90 | 3.86 |
| rt, 14 d | D10 | 0.64 |
| | D50 | 1.42 |
| | D90 | 3.27 |
| −10/+40° C., 14 d | D10 | 0.76 |
| | D50 | 2.08 |
| | D90 | 4.87 |
| 54° C., 14 d | D10 | 0.70 |
| | D50 | 1.52 |
| | D90 | 3.30 |

| | |
|---|---|
| Comp. Ex. VII | |
| start | |
| Blooming | 2.5 |
| Suspensibility after 30 min | 99.5 |
| rt, 14 d | |
| Blooming | 3 |
| Suspensibility after 30 min | 99.1 |
| −10/+40° C., 14 d | |
| Blooming | 3.5 |
| Suspensibility after 30 min | 98.1 |
| 54° C., 14 d | |
| Blooming | 2 |
| Suspensibility after 30 min | 97.0 |
| Comp. Ex. VIII | |
| start | |
| Blooming | 1 |
| Suspensibility after 30 min | 99.9 |
| rt, 14 d | |
| Blooming | 1 |
| Suspensibility after 30 min | 99.5 |
| −10/+40° C., 14 d | |
| Blooming | 1 |
| Suspensibility after 30 min | 97.0 |
| 54° C., 14 d | |
| Blooming | 1 |
| Suspensibility after 30 min | 99.6 |

Samples

5% w.s. dispersant

μm

Azoxystrobin

| | | |
|---|---|---|
| Inv. 20 | | |
| start | D10 | 0.76 |
| | D50 | 1.64 |
| | D90 | 3.55 |
| rt, 14 d | D10 | 0.76 |
| | D50 | 1.63 |
| | D90 | 3.55 |
| −10/+40° C., 14 d | D10 | 0.73 |
| | D50 | 1.66 |
| | D90 | 3.48 |
| 54° C., 14 d | D10 | 0.72 |
| | D50 | 1.67 |
| | D90 | 3.61 |
| Inv. 21 | | |
| start | D10 | 0.58 |
| | D50 | 1.26 |
| | D90 | 2.73 |
| rt, 14 d | D10 | 0.57 |
| | D50 | 1.26 |
| | D90 | 2.7 |
| −10/+40° C., 14 d | D10 | 0.62 |
| | D50 | 1.68 |
| | D90 | 3.46 |
| 54° C., 14 d | D10 | 0.59 |
| | D50 | 1.31 |
| | D90 | 2.83 |
| Inv. 19 | | |
| start | D10 | 0.56 |
| | D50 | 1.32 |
| | D90 | 2.99 |
| rt, 14 d | D10 | 0.57 |
| | D50 | 1.28 |
| | D90 | 2.84 |
| −10/+40° C., 14 d | D10 | 0.62 |
| | D50 | 1.44 |
| | D90 | 2.98 |
| 54° C., 14 d | D10 | 0.60 |
| | D50 | 1.37 |
| | D90 | 3.2 |
| INV. 3 | | |
| start | D10 | 0.62 |
| | D50 | 1.43 |
| | D90 | 3.33 |
| rt, 14 d | D10 | 0.55 |
| | D50 | 1.25 |
| | D90 | 2.87 |
| −10/+40° C., 14 d | D10 | 0.70 |
| | D50 | 2.02 |
| | D90 | 4.67 |
| 54° C., 14 d | D10 | 0.52 |
| | D50 | 1.07 |
| | D90 | 2.19 |
| Inv. 1 | | |
| start | D10 | 0.61 |
| | D50 | 1.37 |
| | D90 | 3.22 |
| rt, 14 d | D10 | 0.53 |
| | D50 | 1.12 |
| | D90 | 2.21 |
| 54° C., 14 d | D10 | 0.56 |
| | D50 | 1.18 |
| | D90 | 2.45 |
| Inv. 5 | | |
| start | D10 | 0.61 |
| | D50 | 1.36 |
| | D90 | 3.10 |
| rt, 14 d | D10 | 0.61 |
| | D50 | 1.34 |
| | D90 | 3.01 |
| 54° C., 14 d | D10 | 0.60 |
| | D50 | 1.32 |
| | D90 | 2.86 |
| Inv. 4 | | |
| start | D10 | 0.64 |
| | D50 | 1.40 |
| | D90 | 3.18 |
| rt, 14 d | D10 | 0.58 |
| | D50 | 1.31 |
| | D90 | 3.03 |
| −10/+40° C., 14 d | D10 | 0.65 |
| | D50 | 1.4 |
| | D90 | 2.87 |
| 54° C., 14 d | D10 | 0.61 |
| | D50 | 1.32 |
| | D90 | 2.72 |
| Inv. 6 | | |
| start | D10 | 0.65 |
| | D50 | 1.41 |
| | D90 | 3.03 |
| rt, 14 d | D10 | 0.65 |
| | D50 | 1.42 |
| | D90 | 3.02 |
| 54° C., 14 d | D10 | 0.64 |
| | D50 | 1.42 |
| | D90 | 3.04 |
| Inv. 2 | | |
| start | D10 | 0.72 |
| | D50 | 1.65 |
| | D90 | 3.36 |
| rt, 14 d | D10 | 0.67 |
| | D50 | 1.49 |
| | D90 | 3.15 |
| 54° C., 14 d | D10 | 0.75 |
| | D50 | 2.76 |
| | D90 | 6.98 |
| Inv. 7 | | |
| start | D10 | 0.61 |
| | D50 | 1.48 |
| | D90 | 3.48 |
| rt, 14 d | D10 | 0.59 |
| | D50 | 1.51 |
| | D90 | 3.32 |
| 54° C., 14 d | D10 | 0.64 |
| | D50 | 1.38 |
| | D90 | 2.95 |
| Inv. 8 | | |
| start | D10 | 0.64 |
| | D50 | 1.43 |
| | D90 | 3.06 |
| rt, 14 d | D10 | 0.64 |
| | D50 | 1.39 |
| | D90 | 2.98 |
| −10/+40° C., 14 d | D10 | 0.72 |
| | D50 | 1.83 |
| | D90 | 4.11 |
| 54° C., 14 d | D10 | 0.69 |
| | D50 | 1.49 |
| | D90 | 3.16 |
| Inv. 9 | | |
| start | D10 | 0.61 |
| | D50 | 1.33 |
| | D90 | 2.92 |
| rt, 14 d | D10 | 0.67 |
| | D50 | 1.38 |
| | D90 | 2.89 |
| −10/+40° C., 14 d | D10 | 0.68 |
| | D50 | 1.43 |
| | D90 | 2.91 |
| 54° C., 14 d | D10 | 0.67 |
| | D50 | 1.43 |
| | D90 | 2.96 |
| Inv. 10 | | |
| start | D10 | 0.63 |
| | D50 | 1.33 |
| | D90 | 2.89 |
| rt, 14 d | D10 | 0.64 |
| | D50 | 1.34 |
| | D90 | 2.88 |
| 54° C., 14 d | D10 | 0.67 |
| | D50 | 1.43 |
| | D90 | 3.09 |
| Inv. 11 | | |
| start | D10 | 0.71 |
| | D50 | 1.53 |
| | D90 | 3.39 |
| Inv. 13 | | |
| start | D10 | 0.74 |
| | D50 | 1.66 |
| | D90 | 3.36 |
| rt, 14 d | D10 | 0.74 |
| | D50 | 1.67 |
| | D90 | 3.39 |
| 54° C., 14 d | D10 | 0.87 |
| | D50 | 3.25 |
| | D90 | 7.47 |
| Inv. 12 | | |
| start | D10 | 0.67 |
| | D50 | 1.47 |
| | D90 | 3.00 |
| rt, 14 d | D10 | 0.69 |
| | D50 | 1.63 |
| | D90 | 3.3 |
| 54° C., 14 d | D10 | 0.78 |
| | D50 | 2.87 |
| | D90 | 6.44 |
| Inv. 14 | | |
| start | D10 | 0.74 |
| | D50 | 1.78 |
| | D90 | 3.64 |
| rt, 14 d | D10 | 0.73 |
| | D50 | 1.86 |
| | D90 | 3.58 |
| 54° C., 14 d | D10 | 0.81 |
| | D50 | 2.77 |
| | D90 | 6.16 |
| Inv. 15 | | |
| start | D10 | 0.73 |
| | D50 | 1.75 |
| | D90 | 3.50 |
| rt, 14 d | D10 | 0.73 |
| | D50 | 1.75 |
| | D90 | 3.55 |
| 54° C., 14 d | D10 | 0.83 |
| | D50 | 2.97 |
| | D90 | 6.69 |
| Inv. 16 | | |
| start | D10 | 0.73 |
| | D50 | 1.65 |
| | D90 | 3.37 |
| rt, 14 d | D10 | 0.73 |
| | D50 | 1.71 |
| | D90 | 3.47 |
| 54° C., 14 d | D10 | 0.77 |
| | D50 | 2.17 |
| | D90 | 5.88 |
| Inv. 17 | | |
| start | D10 | 0.69 |
| | D50 | 1.48 |
| | D90 | 3.40 |
| rt, 14 d | D10 | 0.70 |
| | D50 | 1.54 |
| | D90 | 3.75 |

Terbuthylazin

| | | |
|---|---|---|
| Inv. 21 | | |
| start | D10 | 0.84 |
| | D50 | 1.88 |
| | D90 | 4.38 |
| rt, 14 d | D10 | 0.87 |
| | D50 | 1.97 |
| | D90 | 4.46 |
| 54° C., 14 d | D10 | 0.94 |
| | D50 | 2.73 |
| | D90 | 7.32 |
| Inv. 19 | | |
| start | D10 | 0.98 |
| | D50 | 2.52 |
| | D90 | 5.70 |
| rt, 14 d | D10 | 1.01 |
| | D50 | 2.77 |
| | D90 | 6.26 |
| INV. 3 | | |
| start | D10 | 0.76 |
| | D50 | 1.70 |
| | D90 | 4.10 |
| rt, 14 d | D10 | 0.78 |
| | D50 | 1.76 |
| | D90 | 4.5 |
| 54° C., 14 d | D10 | 0.79 |
| | D50 | 1.84 |
| | D90 | 4.49 |
| INV. 1 | | |
| start | D10 | 0.80 |
| | D50 | 1.79 |
| | D90 | 4.17 |
| rt, 14 d | D10 | 0.85 |
| | D50 | 1.96 |
| | D90 | 5.55 |
| 54° C., 14 d | D10 | 0.88 |
| | D50 | 2.32 |
| | D90 | 5.75 |
| INV. 5 | | |
| start | D10 | 0.81 |
| | D50 | 1.80 |
| | D90 | 3.99 |
| rt, 14 d | D10 | 0.85 |
| | D50 | 1.87 |
| | D90 | 4.27 |
| 54° C., 14 d | D10 | 0.911 |
| | D50 | 2.09 |
| | D90 | 4.96 |
| INV. 4 | | |
| start | D10 | 0.86 |
| | D50 | 2.04 |
| | D90 | 4.58 |
| rt, 14 d | D10 | 0.84 |
| | D50 | 2.02 |
| | D90 | 4.58 |
| −10/+40° C., 14 d | D10 | 0.88 |
| | D50 | 2.25 |
| | D90 | 5.44 |
| 54° C., 14 d | D10 | 0.89 |
| | D50 | 2.26 |
| | D90 | 5.97 |
| INV. 6 | | |
| start | D10 | 0.79 |
| | D50 | 1.76 |
| | D90 | 3.96 |
| rt, 14 d | D10 | 0.84 |
| | D50 | 1.9 |
| | D90 | 4.74 |
| 54° C., 14 d | D10 | 0.90 |
| | D50 | 2.04 |
| | D90 | 4.94 |
| INV. 2 | | |
| start | D10 | 0.76 |
| | D50 | 1.68 |
| | D90 | 3.76 |
| rt, 14 d | D10 | 0.78 |
| | D50 | 1.74 |
| | D90 | 4.19 |
| INV. 7 | | |
| start | D10 | 0.81 |
| | D50 | 1.74 |
| | D90 | 3.78 |
| rt, 14 d | D10 | 0.70 |
| | D50 | 1.61 |
| | D90 | 10.3 |
| 54° C., 14 d | D10 | 0.873 |
| | D50 | 2.23 |
| | D90 | 5.59 |

Diflufenican

| | | |
|---|---|---|
| Inv. 21 | | |
| start | D10 | 0.77 |
| | D50 | 1.95 |
| | D90 | 4.74 |
| rt, 14 d | D10 | 0.75 |
| | D50 | 1.94 |
| | D90 | 4.5 |
| 54° C., 14 d | D10 | 0.83 |
| | D50 | 2.43 |
| | D90 | 5.75 |
| Inv. 19 | | |
| start | D10 | 0.8 |
| | D50 | 2.03 |
| | D90 | 4.46 |
| rt, 14 d | D10 | 0.80 |
| | D50 | 2.15 |
| | D90 | 5.11 |
| −10/+40° C., 14 d | D10 | 0.82 |
| | D50 | 2.31 |
| | D90 | 5.1 |
| 54° C., 14 d | D10 | 0.82 |
| | D50 | 2.24 |
| | D90 | 6.19 |
| INV. 3 | | |
| start | D10 | 0.78 |
| | D50 | 2.01 |
| | D90 | 5.14 |
| rt, 14 d | D10 | 0.74 |
| | D50 | 1.88 |
| | D90 | 4.41 |
| 54° C., 14 d | D10 | 0.79 |
| | D50 | 2.29 |
| | D90 | 5.17 |
| INV. 1 | | |
| start | D10 | 0.78 |
| | D50 | 1.99 |
| | D90 | 5.06 |
| rt, 14 d | D10 | 0.74 |
| | D50 | 1.88 |
| | D90 | 4.36 |
| 54° C., 14 d | D10 | 0.80 |
| | D50 | 2.29 |
| | D90 | 5.16 |
| INV. 5 | | |
| start | D10 | 0.79 |
| | D50 | 2.01 |
| | D90 | 4.76 |
| rt, 14 d | D10 | 0.77 |
| | D50 | 2.03 |
| | D90 | 4.53 |
| −10/+40° C., 14 d | D10 | 0.84 |
| | D50 | 2.5 |
| | D90 | 5.76 |
| 54° C., 14 d | D10 | 0.84 |
| | D50 | 2.41 |
| | D90 | 5.6 |
| INV. 4 | | |
| start | D10 | 0.82 |
| | D50 | 2.07 |
| | D90 | 5.05 |
| rt, 14 d | D10 | 0.77 |
| | D50 | 1.95 |
| | D90 | 4.49 |
| −10/+40° C., 14 d | D10 | 0.77 |
| | D50 | 2.04 |
| | D90 | 4.54 |
| 54° C., 14 d | D10 | 0.78 |
| | D50 | 2.2 |
| | D90 | 5.03 |
| INV. 6 | | |
| start | D10 | 0.8 |
| | D50 | 2.06 |
| | D90 | 4.93 |
| −10/+40° C., 14 d | D10 | 0.91 |
| | D50 | 2.89 |
| | D90 | 9.52 |
| INV. 2 | | |
| start | D10 | 0.76 |
| | D50 | 1.93 |
| | D90 | 5.12 |
| −10/+40° C., 14 d | D10 | 0.82 |
| | D50 | 2.64 |
| | D90 | 7.19 |
| 54° C., 14 d | D10 | 0.75 |
| | D50 | 2.05 |
| | D90 | 4.73 |
| INV. 7 | | |
| start | D10 | 0.79 |
| | D50 | 1.95 |
| | D90 | 4.87 |
| 54° C., 14 d | D10 | 0.73 |
| | D50 | 2 |
| | D90 | 4.5 |
| INV. 12 | | |
| start | D10 | 0.96 |
| | D50 | 2.92 |
| | D90 | 7.08 |
| −10/+40° C., 14 d | D10 | 1.04 |
| | D50 | 3.63 |
| | D90 | 8.18 |

Mefentrifluconazol

| | | |
|---|---|---|
| Inv. 21 | | |
| start | D10 | 0.88 |
| | D50 | 2.63 |
| | D90 | 5.09 |
| rt, 14 d | D10 | 0.83 |
| | D50 | 2.43 |
| | D90 | 4.78 |
| 54° C., 14 d | D10 | 1.02 |
| | D50 | 3.69 |
| | D90 | 7.18 |
| Inv. 19 | | |
| start | D10 | 0.68 |
| | D50 | 1.86 |
| | D90 | 4.46 |
| rt, 14 d | D10 | 0.69 |
| | D50 | 1.85 |
| | D90 | 4.45 |
| −10/+40° C., 14 d | D10 | 1.07 |
| | D50 | 4.01 |
| | D90 | 7.88 |
| INV. 3 | | |
| start | D10 | 0.79 |
| | D50 | 2.04 |
| | D90 | 3.96 |
| rt, 14 d | D10 | 0.78 |
| | D50 | 1.83 |
| | D90 | 3.66 |
| 54° C., 14 d | D10 | 0.83 |
| | D50 | 2.5 |
| | D90 | 4.94 |
| INV. 1 | | |
| start | D10 | 0.8 |
| | D50 | 2.27 |
| | D90 | 4.37 |
| rt, 14 d | D10 | 0.80 |
| | D50 | 2.28 |
| | D90 | 4.46 |
| 54° C., 14 d | D10 | 0.99 |
| | D50 | 3.48 |
| | D90 | 6.77 |
| INV. 5 | | |
| start | D10 | 0.85 |
| | D50 | 2.35 |
| | D90 | 4.62 |
| rt, 14 d | D10 | 0.84 |
| | D50 | 2.37 |
| | D90 | 4.68 |
| −10/+40° C., 14 d | D10 | 0.95 |
| | D50 | 3.01 |
| | D90 | 6.27 |
| 54° C., 14 d | D10 | 0.99 |
| | D50 | 3.22 |
| | D90 | 6.41 |

— not redispergible

Suspensibility and Blooming:

5% w.s. dispersant

a) 40% w.s. Azoxystrobin

| | |
|---|---|
| Inv. 20 | |
| start | |
| Blooming | 1 |
| Suspensibility after 30 min | 100.1 |
| rt, 14 d | |
| Blooming | 1 |
| Suspensibility after 30 min | 100.5 |
| −10/+40° C., 14 d | |
| Blooming | 1.5 |
| Suspensibility after 30 min | 98.8 |
| 54° C., 14 d | |
| Blooming | 2 |
| Suspensibility after 30 min | 100.5 |
| Inv. 21 | |
| start | |
| Blooming | 2 |
| Suspensibility after 30 min | 100.3 |
| rt, 14 d | |
| Blooming | 2 |
| Suspensibility after 30 min | 100.1 |
| −10/+40° C., 14 d | |
| Blooming | 2 |
| Suspensibility after 30 min | 98.8 |
| 54° C., 14 d | |
| Blooming | 2 |
| Suspensibility after 30 min | 99.5 |
| Inv. 19 | |
| start | |
| Blooming | 1.5 |
| Suspensibility after 30 min | 101.3 |
| rt, 14 d | |
| Blooming | 1.5 |
| Suspensibility after 30 min | 100.1 |
| −10/+40° C., 14 d | |
| Blooming | 2 |
| Suspensibility after 30 min | 99.6 |
| 54° C., 14 d | |
| Blooming | 2 |
| Suspensibility after 30 min | 99.4 |
| INV. 3 | |
| start | |
| Blooming | 2 |
| Suspensibility after 30 min | 99.7 |
| rt, 14 d | |
| Blooming | 2 |
| Suspensibility after 30 min | 100.4 |
| −10/+40° C., 14 d | |
| Blooming | 2.5 |
| Suspensibility after 30 min | 97.8 |
| 54° C., 14 d | |
| Blooming | 2.5 |
| Suspensibility after 30 min | 100.5 |
| INV. 1 | |
| start | |
| Blooming | 1.5 |
| Suspensibility after 30 min | 100.5 |
| rt, 14 d | |
| Blooming | 2 |
| Suspensibility after 30 min | 100.5 |
| −10/+40° C., 14 d | |
| Blooming | 2.5 |
| Suspensibility after 30 min | 85.8 |
| 54° C., 14 d | |
| Blooming | 2.5 |
| Suspensibility after 30 min | 100.5 |
| INV. 5 | |
| start | |
| Blooming | 2 |
| Suspensibility after 30 min | 99.7 |
| rt, 14 d | |
| Blooming | 1.5 |
| Suspensibility after 30 min | 100.2 |
| −10/+40° C., 14 d | |
| Blooming | 2.5 |
| Suspensibility after 30 min | 88.2 |
| 54° C., 14 d | |
| Blooming | 2.5 |
| Suspensibility after 30 min | 99.8 |
| INV. 4 | |
| start | |
| Blooming | 2 |
| Suspensibility after 30 min | 99.5 |
| rt, 14 d | |
| Blooming | 2 |
| Suspensibility after 30 min | 100.4 |
| −10/+40° C., 14 d | |
| Blooming | 2.5 |
| Suspensibility after 30 min | 97.0 |
| 54° C., 14 d | |
| Blooming | 2.5 |
| Suspensibility after 30 min | 99.5 |
| INV. 6 | |
| start | |
| Blooming | 2.5 |
| Suspensibility after 30 min | 99.4 |
| rt, 14 d | |
| Blooming | 2.5 |
| Suspensibility after 30 min | 99.5 |
| 54° C., 14 d | |
| Blooming | 3 |
| Suspensibility after 30 min | 99.6 |
| INV. 2 | |
| start | |
| Blooming | 2 |
| Suspensibility after 30 min | 101.0 |
| rt, 14 d | |
| Blooming | 2.5 |
| Suspensibility after 30 min | 99.9 |
| −10/+40° C., 14 d | |
| Blooming | 3 |
| Suspensibility after 30 min | 73.2 |
| 54° C., 14 d | |
| Blooming | 2.5 |
| Suspensibility after 30 min | 95.0 |
| INV. 7 | |
| start | |
| Blooming | 1 |
| Suspensibility after 30 min | 102.0 |
| rt, 14 d | |
| Blooming | 2 |
| Suspensibility after 30 min | 102.3 |
| 54° C., 14 d | |
| Blooming | 2 |
| Suspensibility after 30 min | 102.1 |
| INV. 8 | |
| start | |
| Blooming | 1.5 |
| Suspensibility after 30 min | 101.8 |
| rt, 14 d | |
| Blooming | 2 |
| Suspensibility after 30 min | 100.3 |
| −10/+40° C., 14 d | |
| Blooming | 2.5 |
| Suspensibility after 30 min | 96.3 |
| 54° C., 14 d | |
| Blooming | 2.5 |
| Suspensibility after 30 min | 101.5 |
| INV. 9 | |
| start | |
| Blooming | 1 |
| Suspensibility after 30 min | 100.8 |
| rt, 14 d | |
| Blooming | 1 |
| Suspensibility after 30 min | 100.2 |
| −10/+40° C., 14 d | |
| Blooming | 1.5 |
| Suspensibility after 30 min | 100.1 |
| 54° C., 14 d | |
| Blooming | 1.5 |
| Suspensibility after 30 min | 100.4 |
| INV. 10 | |
| start | |
| Blooming | 1 |
| Suspensibility after 30 min | 99.7 |
| rt, 14 d | |
| Blooming | 1 |
| Suspensibility after 30 min | 99.4 |
| 54° C., 14 d | |
| Blooming | 1.5 |
| Suspensibility after 30 min | 100.3 |
| INV. 11 | |
| start | |
| Blooming | 1 |
| Suspensibility after 30 min | 100.1 |
| INV. 13 | |
| start | |
| Blooming | 1 |
| Suspensibility after 30 min | 100.1 |
| rt, 14 d | |
| Blooming | 1 |
| Suspensibility after 30 min | 100.1 |
| 54° C., 14 d | |
| Blooming | 2 |
| Suspensibility after 30 min | 85.5 |
| INV. 12 | |
| start | |
| Blooming | 1 |
| Suspensibility after 30 min | 92.8 |
| rt, 14 d | |
| Blooming | 1.5 |
| Suspensibility after 30 min | 100.3 |
| −10/+40° C., 14 d | |
| Blooming | 2.5 |
| Suspensibility after 30 min | 81.3 |
| 54° C., 14 d | |
| Blooming | 2.5 |
| Suspensibility after 30 min | 98.2 |
| INV. 14 | |
| start | |
| Blooming | 1 |
| Suspensibility after 30 min | 99.5 |
| rt, 14 d | |
| Blooming | 1 |
| Suspensibility after 30 min | 100.4 |
| 54° C., 14 d | |
| Blooming | 3 |
| Suspensibility after 30 min | 97.3 |
| INV. 15 | |
| start | |
| Blooming | 1 |
| Suspensibility after 30 min | 100.2 |
| rt, 14 d | |
| Blooming | 1 |
| Suspensibility after 30 min | 99.7 |
| 54° C., 14 d | |
| Blooming | 3 |
| Suspensibility after 30 min | 98.9 |
| INV. 16 | |
| start | |
| Blooming | 1 |
| Suspensibility after 30 min | 100.0 |
| rt, 14 d | |
| Blooming | 1 |
| Suspensibility after 30 min | 100.2 |
| 54° C., 14 d | |
| Blooming | 2 |
| Suspensibility after 30 min | 100.2 |
| INV. 17 | |
| start | |
| Blooming | 1 |
| Suspensibility after 30 min | 100.0 |
| rt, 14 d | |
| Blooming | 1 |
| Suspensibility after 30 min | 100.3 |

b) 40% w.s. Terbuthylazin

| | |
|---|---|
| Inv. 21 | |
| start | |
| Blooming | 3 |
| Suspensibility after 30 min | 99.2 |
| rt, 14 d | |
| Blooming | 3.5 |
| Suspensibility after 30 min | 98.2 |
| 54° C., 14 d | |
| Blooming | 3.5 |
| Suspensibility after 30 min | 97.2 |
| Inv. 19 | |
| start | |
| Blooming | 3.5 |
| Suspensibility after 30 min | 99.3 |
| rt, 14 d | |
| Blooming | 3.5 |
| Suspensibility after 30 min | 97.2 |
| −10/+40° C., 14 d | |
| Blooming | 3 |
| Suspensibility after 30 min | 64.9 |
| INV. 3 | |
| start | |
| Blooming | 3 |
| Suspensibility after 30 min | 99.5 |
| rt, 14 d | |
| Blooming | 3 |
| Suspensibility after 30 min | 99.5 |
| 54° C., 14 d | |
| Blooming | 3 |
| Suspensibility after 30 min | 98.5 |
| INV. 1 | |
| start | |
| Blooming | 3.5 |
| Suspensibility after 30 min | 99.4 |
| rt, 14 d | |
| Blooming | 3.5 |
| Suspensibility after 30 min | 98.6 |
| 54° C., 14 d | |
| Blooming | 3 |
| Suspensibility after 30 min | 97.7 |
| INV. 5 | |
| start | |
| Blooming | 4 |
| Suspensibility after 30 min | 99.2 |
| rt, 14 d | |
| Blooming | 3.5 |
| Suspensibility after 30 min | 98.8 |
| 54° C., 14 d | |
| Blooming | 3 |
| Suspensibility after 30 min | 98.9 |
| INV. 4 | |
| start | |
| Blooming | 1.5 |
| Suspensibility after 30 min | 98.7 |
| rt, 14 d | |
| Blooming | 1.5 |
| Suspensibility after 30 min | 98.2 |
| −10/+40° C., 14 d | |
| Blooming | 2.5 |
| Suspensibility after 30 min | 97.0 |
| 54° C., 14 d | |
| Blooming | 3.5 |
| Suspensibility after 30 min | 98.0 |
| INV. 6 | |
| start | |
| Blooming | 2 |
| Suspensibility after 30 min | 99.8 |
| rt, 14 d | |
| Blooming | 2 |
| Suspensibility after 30 min | 99.5 |
| 54° C., 14 d | |
| Blooming | 1.5 |
| Suspensibility after 30 min | 99.0 |
| INV. 2 | |
| start | |
| Blooming | 2 |
| Suspensibility after 30 min | 100.3 |
| rt, 14 d | |
| Blooming | 2 |
| Suspensibility after 30 min | 99.6 |
| 54° C., 14 d | |
| Blooming | 1.5 |
| Suspensibility after 30 min | 96.8 |
| INV. 7 | |
| start | |
| Blooming | 2 |
| Suspensibility after 30 min | 100.5 |
| rt, 14 d | |
| Blooming | 2 |
| Suspensibility after 30 min | 99.4 |
| 54° C., 14 d | |
| Blooming | 1.5 |
| Suspensibility after 30 min | 99.6 |

c) 40% w.s. Difluefenicon

| | |
|---|---|
| Inv. 21 | |
| start | |
| Blooming | 1.5 |
| Suspensibility after 30 min | 97.8 |
| rt, 14 d | |
| Blooming | 1.5 |
| Suspensibility after 30 min | 97.3 |
| −10/+40° C., 14 d | |
| Blooming | 2.5 |
| Suspensibility after 30 min | 64.4 |
| 54° C., 14 d | |
| Blooming | 2.5 |
| Suspensibility after 30 min | 96.4 |
| Inv. 19 | |
| start | |
| Blooming | 1 |
| Suspensibility after 30 min | 98.4 |
| rt, 14 d | |
| Blooming | 1.5 |
| Suspensibility after 30 min | 97.6 |
| −10/+40° C., 14 d | |
| Blooming | 1.5 |
| Suspensibility after 30 min | 97.4 |
| 54° C., 14 d | |
| Blooming | 2 |
| Suspensibility after 30 min | 96.8 |
| INV. 3 | |
| start | |
| Blooming | 1.5 |
| Suspensibility after 30 min | 97.9 |
| rt, 14 d | |
| Blooming | 1.5 |
| Suspensibility after 30 min | 98.9 |
| −10/+40° C., 14 d | |
| Blooming | 1.5 |
| Suspensibility after 30 min | 63.7 |
| 54° C., 14 d | |
| Blooming | 1 |
| Suspensibility after 30 min | 97.4 |
| INV. 1 | |
| start | |
| Blooming | 1.5 |
| Suspensibility after 30 min | 98.2 |
| rt, 14 d | |
| Blooming | 1.5 |
| Suspensibility after 30 min | 98.3 |
| −10/+40° C., 14 d | |
| Blooming | 1.5 |
| Suspensibility after 30 min | 63.4 |
| 54° C., 14 d | |
| Blooming | 1.5 |
| Suspensibility after 30 min | 97.8 |
| INV. 5 | |
| start | |
| Blooming | 1.5 |
| Suspensibility after 30 min | 97.9 |
| rt, 14 d | |
| Blooming | 2 |
| Suspensibility after 30 min | 97.2 |
| −10/+40° C., 14 d | |
| Blooming | 2 |
| Suspensibility after 30 min | 96.9 |
| 54° C., 14 d | |
| Blooming | 2 |
| Suspensibility after 30 min | 96.7 |
| INV. 4 | |
| start | |
| Blooming | 1 |
| Suspensibility after 30 min | 98.2 |
| rt, 14 d | |
| Blooming | 1 |
| Suspensibility after 30 min | 98.2 |
| −10/+40° C., 14 d | |
| Blooming | 1.5 |
| Suspensibility after 30 min | 97.3 |
| 54° C., 14 d | |
| Blooming | 1 |
| Suspensibility after 30 min | 97.3 |
| INV. 6 | |
| start | |
| Blooming | 1.5 |
| Suspensibility after 30 min | 98.8 |
| −10/+40° C., 14 d | |
| Blooming | 2.5 |
| Suspensibility after 30 min | 70.7 |
| INV. 2 | |
| start | |
| Blooming | 1.5 |
| Suspensibility after 30 min | 100.3 |
| −10/+40° C., 14 d | |
| Blooming | 2.5 |
| Suspensibility after 30 min | 89.8 |
| 54° C., 14 d | |
| Blooming | 2 |
| Suspensibility after 30 min | 99.9 |
| INV. 7 | |
| start | |
| Blooming | 1.5 |
| Suspensibility after 30 min | 100.1 |
| 54° C., 14 d | |
| Blooming | 2 |
| Suspensibility after 30 min | 99.8 |
| EMU111012-0239 | |
| INV. 12 | |
| start | |
| Blooming | 1 |
| Suspensibility after 30 min | 94.4 |
| −10/+40° C., 14 d | |
| Blooming | 1 |
| Suspensibility after 30 min | 88.2 |

d) 40% w.s. Mefentrifluconazol

| | |
|---|---|
| Inv. 21 | |
| start | |
| Blooming | 2 |
| Suspensibility after 30 min | 99.5 |
| rt, 14 d | |
| Blooming | 1.5 |
| Suspensibility after 30 min | 99.0 |
| −10/+40° C., 14 d | |
| Blooming | 1.5 |
| Suspensibility after 30 min | 74.8 |
| 54° C., 14 d | |
| Blooming | 1.5 |
| Suspensibility after 30 min | 93.2 |
| Inv. 19 | |
| start | |
| Blooming | 1.5 |
| Suspensibility after 30 min | 99.6 |
| rt, 14 d | |
| Blooming | 1.5 |
| Suspensibility after 30 min | 100.2 |
| −10/+40° C., 14 d | |
| Blooming | 1 |
| Suspensibility after 30 min | 99.5 |
| INV. 3 | |
| start | |
| Blooming | 1 |
| Suspensibility after 30 min | 99.4 |
| rt, 14 d | |
| Blooming | 1.5 |
| Suspensibility after 30 min | 99.2 |
| −10/+40° C., 14 d | |
| Blooming | 1.5 |
| Suspensibility after 30 min | 76.7 |
| 54° C., 14 d | |
| Blooming | 1.5 |
| Suspensibility after 30 min | 98.5 |
| INV. 1 | |
| start | |
| Blooming | 1 |
| Suspensibility after 30 min | 99.6 |
| rt, 14 d | |
| Blooming | 1.5 |
| Suspensibility after 30 min | 99.5 |
| −10/+40° C., 14 d | |
| Blooming | 1.5 |
| Suspensibility after 30 min | 82.1 |
| 54° C., 14 d | |
| Blooming | 1.5 |
| Suspensibility after 30 min | 97.1 |
| INV. 5 | |
| start | |
| Blooming | 1 |
| Suspensibility after 30 min | 99.2 |
| rt, 14 d | |
| Blooming | 1.5 |
| Suspensibility after 30 min | 98.7 |
| −10/+40° C., 14 d | |
| Blooming | 2 |
| Suspensibility after 30 min | 90.6 |
| 54° C., 14 d | |
| Blooming | 3 |
| Suspensibility after 30 min | 91.3 |

— not redispergible

1. A graft polymer comprising:
(A) 20 to 95% of a polymer backbone as a graft base,
which comprises at least one sub-unit (a1) and at least one sub-unit (a2), wherein
(a1) is a unit comprising, moieties derived from at least one alkylene oxide monomer and/or at least one polyalkylene oxide-polymer having two hydroxy-end-groups, the alkylene oxide monomer selected from the group consisting of C2- to C10-alkylene oxides,
(a2) is a unit comprising, moieties derived from at least one lactone and/or at least one hydroxy acid, such sub-unit (a2) being a moiety derived from a single lactone and/or hydroxy-acid or being oligo-or-polymeric units consisting of at least one type of lactone and/or at least one type of hydroxy acid,
wherein the polymer backbone is
a) obtained
(A1) by co-polymerization of at least one sub-unit (a1) and at least one sub-unit (a2);
(A2) by first oligo-/polymerizing sub-unit(s) (a2) and then polymerizing the product with sub-unit(s) (a1);
(A3) By first oligo or polymerizing sub-unit(s) (a1) and then co-polymerizing the product with sub-unit(s) (a2); or
(A4) by first providing an oligo- or polymeric sub-unit (a1) which bears an end-cap on one side, which is thereafter reacted as starter-block with at least one sub-unit (a2), wherein the sub-unit (a1) may be different to that or those in the starter block or may be arranged in a different order compared to those in the starter block, to attach to the non-end capped side of the starter block a new block comprising moieties from the sub-units employed for the (co-)polymerization, thereby obtaining a di-block-structure of [end-cap]-[sub-unit(s) (a1)]-[sub-unit(s) (a2)], or [end-cap]-[sub-unit(s) (a1)]-[random-{sub-unit(s) (a2)-sub unit(s) (a1)}];
wherein in case more than one sub-unit (a1) and/or more than one sub-unit (a2) are present already in an employed oligomer or polymer, those sub-units can be arranged in any order within such employed oligomer or polymer, and
wherein in case more than one sub-unit (a1) and/or more than one sub-unit (a2) are present for the polymerization, those sub-units and the optional oligomer/polymers if employed) can be arranged in any order within the obtained backbone;
and wherein in case of (A1), (A2) and (A3) the use of a starter molecule is optional;
or b) selected from the group consisting of:
(A1) a backbone consisting of a randomly arranged order of monomeric, oligomeric and/or polymeric (a1)-sub-units and monomeric, oligomeric and/or polymeric (a2)-sub-units, with more than one sub-unit (a1) and/or more than one sub-unit (a2) being present;
(A2) a backbone consisting of oligo- or polymerized sub-units (a2) as an inner block and two outer blocks of oligomeric and/or polymeric (a1)-sub-units, defined as “-[block of (a1)]-[block of (a2)]-[block of (a1)]”;
(A3) a backbone consisting of an inner block of oligomeric and/or polymeric (a1)-sub-units and two outer blocks of oligo- or polymeric sub-units (a2), in the form of at least a tri-block-polymer defined as “-[block of (a2)]-[block of (a1)]-[block of (a2)]-”; and
(A4) a backbone consisting of
a first block with
(i) on one end an end-cap, such end-cap being a C1 to C18 attached to said first block via an ether-function; and
(ii) an oligo- or polymeric sub-unit (a1); and
a second block which is attached to said first block at the opposite end of said first block, which is “opposite” in relation to the end-cap on said first block) via an ether or ester-function, said second block being composed of at least one sub-unit (a2) and optionally at least one sub-unit (a1), wherein the optional sub-unit(s) (a1) in said second block may be different to that or those in the first block or may be arranged in a different order compared to those in the first block, and the order of the sub-unit(s) (A1) and (a2) may be also in any order, including random structure,
such di-block-structure having as an idealized structure in case of using only sub-unit(s) (a2) for the second block: [end-cap]-[sub-unit(s) (a1)]-[sub-unit(s) (a2)]
or in case of using sub-unit(s) (a1) and (a2) for the second block:
[end-cap]-[sub-unit(s) (a1)]-[random-{sub-unit(s) (a2)-sub unit(s) (a1)}];
and wherein in case of (A1), (A2) and (A3) the use of a starter molecule is optional; and
(B) 5 to 80% to of polymeric sidechains (B) grafted onto the polymer backbone (A), wherein said polymeric sidechains (B) are obtained by (co-)polymerization of at least one vinyl ester monomer (B1), optionally a nitrogen-containing monomer (B2), and optionally further monomer(s) (B3), and optionally further monomers,
with all percentages as weight percent in relation to the total weight of the graft polymer.

2. (canceled)

3. The graft polymer according to claim 1, wherein the monomers are:
(B1) at least one vinyl ester, selected from the group consisting of vinyl acetate, vinyl propionate, vinyl laurate, vinyl valerate, vinyl pivalate, vinyl neodecanoate, vinyl decanoate and vinyl benzoate;
optionally (B2) at least one nitrogen-containing monomer being selected from the group consisting of vinyllactames, vinyl imidazoles, 1-vinyltriazole, 4-vinylpyridine, 4-vinylpyridine-N-oxide, 2-vinylpyridine, 1-vinyloxazolidinone, N-vinylformamide, N-vinylacetamide, N-vinyl-N-methylacetamide, and acrylamides such as acrylamide, methacrylamide, N-alkyl-substituted acrylamides, N,N′-di alkyl (meth) acrylamide; and mono- and dialkylamino-alkyl-(meth)acrylates;
optionally
(B3) at least one further monomer; and
optionally at least one further monomer, being different from those before, such other monomer being present only in an amount of less than 2% of the total amount of monomers employed for obtaining the polymeric sidechains (B).

4. The graft polymer according to claim 1, wherein if (B2) is present the amount of
(B) is from 10 to 60%, being based on the total WEIGHT OF THE GRAFT POLYMER, with (B1) in weight percent being based on the total WEIGHT OF THE GRAFT POLYMER is from 9 to 55%;
(B2) in weight percent being based on the total WEIGHT OF THE GRAFT POLYMER is from 1 to 41%
or
wherein—if (B2) is not present—the amount of
(B) is from 5 to 60%; with
(B1) in weight percent being based on the total WEIGHT OF THE GRAFT POLYMER is the total amount of (B) minus the total amount of (B3),
(B2) is 0%,
and further provided that in all cases before
(B3) is from 0 to 10% of the amount of (B1), and not more than the amount of (B2).

5. (canceled)

6. The graft polymer according to claim 1,
wherein
(A) the polyalkoxylate-ester backbone comprises moieties derived from
(i) alkylene oxides (AO) comprising at least one of ethylene oxide (EO), propylene oxide (PO), and butylene oxide (BO),
with the AO in an amount of from 40 to 99 wt %, each based on the total weight of the backbone,
the amount of EO being of from 0 to 100 wt. %, based on total AO,
the PO and/or BO, in a total amount of each from 0 to 100 wt. %, each based on the total weight of AO, with the total amount of PO and BO adding up to 100 wt. % for the sum of PO and BO,
with the total amount of AO adding up to 100 wt. %; and
(ii) lactone/hydroxy acid monomer in an amount of from 1 and up to 60 wt. %, each based on the total weight of the backbone;
with the total weight of the sum of sub-units (a1) and sub-units (a2) in the backbone (A) adding up to 100 wt %.

7. (canceled)

8. (canceled)

9. The graft polymer according to claim 1, wherein
(B) the monomers are:
(B1) at least one vinyl ester, selected from the group consisting of vinyl acetate, vinyl propionate and vinyl laurate, in amounts of from 70 to 100% by weight of the total weight of monomers that are grafted onto the backbone (A), and
(B2) optionally at least one nitrogen-containing monomer in amounts of from 0 to 30% by weight of the total amount of monomers that are grafted onto the backbone (A),
with the vinyl ester monomer(s) (B1) optionally being partially or fully hydrolyzed after polymerization.

10. The graft polymer according to claim 1, wherein essentially no other monomers (B2) or (B3) are employed, or wherein monomer (B1) and (B2) are present and no other monomers are employed.

11. (canceled)

12. (canceled)

13. The graft polymer according to claim 1, wherein at least one of i), ii) and iii) is fulfilled:
i) the polymer backbones (A1), (A2) and (A3) may bear as the end-groups two hydroxy-groups or may be capped with C1 to C22-alkyl groups, such end-group being attached using standard means after final preparation of the backbone whereas for (A4) such end-cap is done on the oligo or polymeric sub-unit (a1) prior to the polycondensation employing sub-unit(s) (a2);
ii) the graft polymer has a polydispersity (PDI) Mw/Mn of at most 10, wherein Mw is the weight average molecular weight and Mn is the number average molecular weight; and
iii) the biodegradability of the graft polymer is at least 35% within 28 days, when tested under OECD 301F.

14. A process for obtaining a graft polymer according to claim 1, comprising the step of polymerizing at least one vinyl ester monomer (B1), optionally at least one nitrogen-containing monomer (B2), and optionally further monomer(s) (B3) and further optionally including further monomer(s) as impurities within (B1), (B2) and/or (B3) is/are polymerized in the presence of at least one polymer backbone (A), wherein the polymeric sidechains (B) are obtained by radical polymerization.

15. The process according to claim 14, comprising the polymerization of at least one vinyl ester monomer (B1), optionally at least one nitrogen-containing monomer (B2), optionally further monomer(s) (B3), in the presence of at least one polymer backbone (A), a free radical-forming initiator (C) and, optionally, up to 50% by weight, based on the sum of components (A), (B), and (C), of at least one solvent (D), at a mean polymerization temperature at which the initiator (C) has a decomposition half-life of from 40 to 500 min, in such a way that the fraction of unconverted graft monomers (B1), optional (B2) and optional (B3) and initiator (C) in the reaction mixture is constantly kept in a quantitative deficiency relative to the polymer backbone (A).

16. The process according to claim 14, wherein essentially no other monomer (B3) is employed, or wherein essentially no other monomers (B2) nor (B3) are employed.

17. (canceled)

18. The process according to claim 14, wherein the at least one vinyl ester-monomer (B1)-derived moiety is partially or fully hydrolyzed.

19. The process according to claim 14, wherein the process comprises at least one further process step selected from the group consisting of i) to iv):
i) Post-polymerisation; ii) Purification; iii) Concentration; and iv) Drying.

20. (canceled)

21. The process according to claim 14, wherein the amount of water during the polymerisation is at most 10 wt. % based on total weight of graft polymer (at the end of the polymerization) or based on total weight of (A) and (B) (at the start of the polymerization).

22. An agrochemical composition comprising at least one graft polymer according to claim 1;
wherein the agrochemical active ingredient is selected from the group consisting of pesticides, herbicides, fungicides, and insecticides; and/or
wherein the agrochemical active ingredient is selected from the group consisting of azoxystrobin, fluxapyroxad, fludioxonil, prothioconazole, chlorothalonil, diflufenican, metyltetraprole, mefentrifluconazole, tebuconazole, atrazine, indaziflam, saflufenacil, pyroxasulfone, glufosinate, cinmethylin, terbuthylazine, and metribuzin; and/or
wherein the weight ratio of the active agrochemical ingredient to the graft polymer in the agrochemical composition is in the range of 1:1 to 30:1; and/or
wherein the agrochemical composition is selected from the group consisting of a suspension, an emulsifiable concentrate, a wettable powder, a wettable dust, or a granule, in particular a suspension such as a suspension concentrate, a suspo-emulsion and a dispersible concentrate.

23. (canceled)

24. (canceled)

25. (canceled)

26. (canceled)

27. (canceled)

28. A method of using at least one graft polymer according to claim 1, the method comprising using the at least one graft polymer in an agrochemical composition or in a composition, that is a fabric and home care product, cleaning composition, industrial and institutional cleaning product,
optionally further comprising at least one enzyme,
wherein the at least one graft polymer is present in an amount ranging from about 0.01% to about 20% in relation to the total weight of such composition or product in relation to the total weight of such composition or product, and such product or composition further comprising from about 1% to about 70% by weight of a surfactant system.

29. A composition that is a fabric and home care product, cleaning composition, industrial and institutional cleaning product, each containing at least one graft polymer according to claim 1,
optionally further comprising at least one enzyme,
wherein the at least one graft polymer is present in an amount ranging from about 0.01% to about 20% in relation to the total weight of such composition or product in relation to the total weight of such composition or product, and such product or composition further comprising from about 1% to about 70% by weight of a surfactant system.

30. The graft polymer according to claim 1, wherein the at least one lactone and/or hydroxy acid is selected from the group consisting of i) and ii), with
i) lactone(s), starting with α-lactone followed by β-lactone, γ-lactone and so on; and
ii) hydroxy acid(s), which may be derived from any lactone by hydrolyzation.

31. The graft polymer according to claim 1, wherein the at least one nitrogen-containing monomer is selected from the group consisting of N-vinyllactam, N-vinylpyrrolidone, N-vinylpiperidone, and N-vinylcaprolactam.

32. The process according to claim 14, wherein at least 10 weight percent of the total amount of vinyl ester monomer (B1) is selected from the group consisting of vinyl acetate, vinyl propionate, and vinyl laurate.

33. The agrochemical composition comprising at least one graft polymer according to claim 1, wherein the agrochemical active ingredient is selected from the group consisting of herbicides, fungicides, and insecticides.
